(19) United States
(12) Patent Application Publication
(10) Pub. No.: US 2026/0308784 A1
(43) Pub. Date: Oct. 8, 2026

(54) MATERIALS, PANELS AND USES THEREOF

(71) Applicant: B.G. NEGEV TECHNOLOGIES AND APPLICATIONS LTD., AT BEN-GURION UNIVERSITY, Beer Sheva (IL)

(72) Inventors: Menashe SHALOM, Beer Sheva (IL); Michael VOLOKH, Beer Sheva (IL); Venugopala Rao BATTULA, Beer Sheva (IL); Gabriel MARK, Beer Sheva (IL)

(73) Assignee: B.G. NEGEV TECHNOLOGIES AND APPLICATIONS LTD., AT BEN-GURION UNIVERSITY, Beer Sheva (IL)

(21) Appl. No.: 19/572,154

(22) Filed: Mar. 19, 2026

Related U.S. Application Data
(63) Continuation-in-part of application No. PCT/IL2024/050941, filed on Sep. 19, 2024.
(60) Provisional application No. 63/539,337, filed on Sep. 20, 2023.
(60) Provisional application No. 63/642,796, filed on May 5, 2024.
(60) Provisional application No. 63/821,598, filed on Jun. 11, 2025.

(51) Int. Cl. C25B 11/077; C02F 1/461; C02F 101/30; C25B 1/04; C25B 1/30; C25B 3/21; C25B 3/23; C25B 11/049; C25B 11/067

(52) U.S. Cl. CPC C25B 11/077; C02F 1/46114; C25B 1/04; C25B 1/30; C25B 3/21; C25B 3/23; C25B 11/049; C25B 11/067; C02F 2001/46142; C02F 2101/30

(57) ABSTRACT

The present disclosure relates to a catalytic panel comprising at least one catalytic material and at least one substrate, wherein the at least one catalytic material is directly associated with the substrate, to particulate matter comprising a catalytic material, uses thereof and method of using them.

### CROSS-REFERENCE TO RELATED APPLICATIONS

This application is a continuation-in-part of International Patent Application No. PCT/IL2024/050941, filed on Sep. 19, 2024, which claims priority to U.S. Application No. 63/539,337, filed Sep. 20, 2023 and U.S. Application No. 63/642,796, filed May 5, 2024. This application also claims priority to U.S. Application No. 63/821,598, filed Jun. 11, 2025. The entire contents of these applications are incorporated herein by reference in their entirety.

### TECHNOLOGICAL FIELD

The present disclosure relates to materials, panels uses thereof and method making use thereof.

### BACKGROUND ART

References considered to be relevant as background to the presently disclosed subject matter are listed below:

Photocatalysis is an attractive enabler of the efficient execution of different important environmental (e.g., production of hydrogen and C-based fuels) and organic reactions utilizing solar energy [1]-[5].

Acknowledgement of the above references herein is not to be inferred as meaning that these are in any way relevant to the patentability of the presently disclosed subject matter.

### BACKGROUND

[1]X. Lang, X. Chen, J. Zhao, Chem. Soc. Rev. 2014, 43, 473-486.
[2]Y. Bai, L. Wilbraham, B. J. Slater, M. A. Zwijnenburg, R. S. Sprick, A. I. Cooper, J. Am. Chem. Soc. 2019, 141, 9063-9071.
[3]A. Savateev, I. Ghosh, B. KSnig, M. Antonietti, Angew. Chem. Int. Ed. 2018, 57, 15936-15947.
[4]J. Xiao, X. Liu, L. Pan, C. Shi, X. Zhang, J.-J. Zou, ACS Catal. 2020, 10, 12256-12283.
[5]K. S. Lakhi, D.-H. Park, K. Al-Bahily, W. Cha, B. Viswanathan, J.-H. Choy, A. Vinu, Chem. Soc. Rev. 2017, 46, 72-101.

### GENERAL DESCRIPTION

In accordance with some aspects, the present disclosure provides a catalytic panel comprising at least one catalytic material and at least one substrate, wherein the at least one catalytic material is directly associated with the substrate.

In accordance with some other aspects, the present disclosure provides a catalytic panel comprising at least one catalytic material and at least one substrate, wherein the at least one catalytic material is polymeric carbon nitride (CN) or modified CN (C-to-N ratio, heteroatom incorporation, functional groups modification, or metal incorporation), and the substrate is glass and wherein the CN is directly attached on at least one surface of the glass.

In accordance with some other aspects, the present disclosure provides a catalytic panel comprising at least one catalytic material and at least one substrate, wherein the at least one catalytic material is polymeric carbon nitride (CN) or modified CN, and the substrate is glass and wherein the CN is directly attached on at least one surface of the glass.

In accordance with some further aspects, the present disclosure provides a catalytic panel comprising at least one catalytic material and at least one substrate, wherein the at least one catalytic material is WO₃ and the substrate is glass and wherein said WO₃ is directly attached on at least one surface of the glass.

In accordance with yet some aspects, the present disclosure provides a catalytic panel comprising at least one catalytic material and at least one substrate, wherein the at least one catalytic material is polymeric CN and the substrate is a thermoplastic polymer and wherein the CN is at least partially embedded within the thermoplastic polymer.

In accordance with yet some other aspects, the present disclosure provides a catalytic panel comprising at least one catalytic material and at least one substrate, wherein the at least one catalytic material is WO₃ and the substrate is a thermoplastic polymer and wherein the WO₃ is at least partially embedded within the thermoplastic polymer.

In accordance with yet some other aspects, the present disclosure provides a catalytic panel as described herein for use in a photocatalytic reaction or electrocatalytic reaction.

In accordance with yet some other aspects, the present disclosure provides a catalytic panel as described herein for use in a method of production of hydrogen peroxide (H₂O₂).

In accordance with yet some other aspects, the present disclosure provides a catalytic panel as described herein for use in a method of oxidizing at least one organic compound.

In accordance with yet some other aspects, the present disclosure provides a catalytic panel as described herein for use in a method of oxidizing at least one biomass derived product.

In accordance with yet some other aspects, the present disclosure provides a catalytic panel as described herein for use in a method of degrading a water pollutant.

In accordance with yet some other aspects, the present disclosure provides a catalytic panel as described herein for use in a method of oxidizing a hydroxyl-containing compound.

In accordance with yet some other aspects, the present disclosure provides a catalytic panel as described herein for use in a method of oxidizing a hydroxyl-containing compound and of reducing oxygen.

In accordance with yet some other aspects, the present disclosure provides a catalytic panel as described herein for use as an electrode.

In accordance with yet some other aspects, the present disclosure provides an electrode comprising a catalytic panel, wherein the catalytic panel comprises at least one catalytic material and at least one substrate, wherein the substrate is a conductive substrate and wherein the at least one catalytic material is directly associated with the substrate.

In accordance with yet some other aspects, the present disclosure provides a particulate matter for use in a method of producing hydrogen, the particulate matter comprises at least one catalytic material.

In accordance with yet some other aspects, the present disclosure provides a photoreactor comprises at least one photocatalytic panel or particulate matter as described herein.

In accordance with yet some other aspects, the present disclosure provides a method for producing hydrogen peroxide, the method comprising exposing a panel to a light source, wherein the panel comprises at least one catalytic material and at least one substrate, and wherein the catalytic material is directly associated to the substrate, to thereby produce hydrogen peroxide.

In accordance with yet some other aspects, the present disclosure provides a method for producing hydrogen peroxide, the method comprising exposing a panel to a light source, wherein the panel comprises at least one catalytic material and at least one substrate, wherein the at least one substrate is at least one polymer and wherein the catalytic material is at least partially embedded within the polymer, to thereby produce hydrogen peroxide.

In accordance with yet some other aspects, the present disclosure provides a method for producing hydrogen peroxide, the method comprising exposing a powder to a light source, wherein the powder comprises at least one catalytic material, wherein the catalytic material is configured to oxidize a hydroxyl-containing compound and reduce oxygen to thereby produce hydrogen peroxide.

In accordance with yet some other aspects, the present disclosure provides a method for oxidizing at least one biomass-derived product, the method comprising exposing a panel to a light source, wherein the panel comprises at least one catalytic material and at least one substrate, and wherein the catalytic material is directly associated to the substrate, to thereby oxidizing at least one biomass-derived product.

In accordance with yet some other aspects, the present disclosure provides a method for water purification, the method comprises exposing a panel to a light source, wherein the panel comprises at least one catalytic material and at least one substrate, and wherein the catalytic material is directly associated to the substrate, to thereby allow water purification

In accordance with yet some other aspects, the present disclosure provides a method for producing hydrogen, the method comprises exposing a panel to a light source, wherein the panel comprises at least one catalytic material and at least one substrate, and wherein the catalytic material is directly associated to the substrate, to thereby produce hydrogen.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to better understand the subject matter that is disclosed herein and to exemplify how it may be carried out in practice, embodiments will now be described, by way of non-limiting examples only, with reference to the accompanying drawings, in which:

FIGS. 1A-1B are schematic synthesis processes of binder-free carbon nitride (CN) panels showing FIG. 1A “sandwich” method using melamine-cyanuric acid (MCA) supramolecular aggregates powder as the precursor, FIG. 1B doctor-blade assisted “sandwich” method.

FIG. 2 is digital image of the obtained 10×10 cm² CN_{MCA} panel.

FIGS. 3A-3G are digital images of the obtained 6.7×6.7 cm² CN and modified CN films over various substrates; FIG. 3A-3E on glass substrate: FIG. 3A—CN_{D}, FIG. 3B—CN_{Mel-CA}, FIG. 3C—CN_{MCAB(0.05)}, FIG. 3D—CN_{MCAB(0.05)-500}, and FIG. 3E—CN_{MCAB(0.1)}; FIGS. 3F-3G on Aluminum (Al) foil: FIG. 3F—CN_{MCA}, and FIG. 3G—CN_{M}, D dicyananmide precursor, Mel melem.

FIG. 4A-4C relate to structural and optical characterization of CN panels on different substrates showing FIG. 4A FTIR spectra of CN panels on glass, FIG. 4B on Al foil (all spectra are vertically offset for clarity), and FIG. 4C UV—vis absorbance (as 100%—% transmittance—% reflectance) spectra of CN panels.

FIGS. 5A-5I relate to thickness characterization of CN panels, FIGS. 5A-5D cross-sectional SEM images of FIGS. 5A—clean glass (MCA-0), FIG. 5B glass with 1 layer of MCA (MCA-1), FIG. 5C glass with 2 layers of MCA (MCA-2), FIG. 5D glass with 3 layers of MCA (MCA-3), FIG. 5E is a schematic synthesis process of binder-free CN panels, where the grey lines represent the doctor-bladed precursor layer and after calcination the resulting CN is shown in thick orange line, the thin yellow line represents thin CN from the powder sublimation only, FIGS. 5F-5I are cross-sectional SEM images of FIG. 5F—CN_{MCA}, FIGS. 5G—CN_{MCA-D1}, FIG. 5H—CN_{MCA-D}, and FIG. 5I—CN_{MCA-D3}.

FIGS. 6A-6E are digital photos of 6.7×6.7 cm⁻² CN panels on glass substrate; FIG. 6A clean glass, FIG. 6B-6D CN panels prepared by “sandwich” method and FIG. 6B—CN_{MCA}; FIG. 6C—CN_{MCA(1:1.5)}, FIG. 6D CN_{M} melamine as a precursor, FIG. 6E CN_{MCA-D}.

FIG. 7A-7H relate to morphological and structural analyses of CN panels, FIGS. 7A-7B are top-view scanning electron microscopy (SEM) images of CN_{MCA} and CN_{MCA-D}, respectively, FIGS. 7C-7D cross-sectional SEM images of CN_{MCA} and CN_{MCA-D}, respectively, FIG. 7E-7F top-view SEM images of CN_{M}, and CN_{MCA(1:1.5)}, respectively, FIG. 7G X-ray diffraction (XRD) of all CN panels over glass and a clean glass substrate as reference, and FIG. 7H Fourier-transform infrared (FTIR) spectra of all CN panels; the XRD patterns and FTIR spectra are vertically offset for clarity.

FIG. 8A-8E are FTIR spectra of CN powders (MCA), CN panels (CN_{MCA}), and a bare glass substrate showing the interaction between the synthesized CN and the glass. FIG. 8A CN_{MCA} powder which is CN powder synthesized under identical conditions (precursor, temperature and heat profile, environment) but without being first deposited on a glass substrate and CN_{MCA} panel which is the analog panel (CN grown on glass using the described method) where a cyano group appears ca. 2200 cm⁻¹; inset shows the digital images of the powder and the panel, FIG. 8B magnification of the spectra at wavenumbers ca. 810 cm⁻¹, FIG. 8C-8E glass, glass after scratching CN_{MCA}, and CN_{MCA} powder alone as a reference at three different IR regions.

FIGS. 9A-9B are structural and morphological characterization of a CN_{MCA-D} panel showing FIG. 9A FTIR spectra of a CN_{MCA-D} panel, scratched powder, outer layer (i.e., outside the doctor-bladed area, deposition on glass), and bottom layer (i.e., the part of the panel from which the top layer was scratched off), FIG. 9B top-view SEM image of CN_{MCA-D} panel at the interface between the CN_{MCA-D} layer (left side of the SEM image, obtained from doctor-bladed side of MCA precursor) and the outer layer (right side of the SEM image, where no doctor-blading took place).

FIG. 10 is X-ray photoelectron spectroscopy (XPS) survey scan of all CN panels showing that the CN_{MCA} and CN_{MCA(1:1.5)} panels also exhibit Na A (Na Auger line) and Na 1s peaks, which correspond to sodium from the glass since a lower thickness of CN films covers the glass substrate relative to the doctor-bladed sample or the CN_{M} where 2 g melamine powder were used in the ‘sandwich’.

FIGS. 11A-11B are high-resolution XPS deconvoluted spectra of CN_{MCA} and CN_{MCA-D} showing FIG. 11A C is signals and FIG. 11B N is signals; red circles represent the experimental measurement data points; the fitted curve is shown as a thin black line; the colored filled peaks represent the deconvoluted fits of individual chemical species indicated in the legend.

FIGS. 12A-12B are high-resolution XPS deconvoluted spectra of CN_{M} and CN_{MCA(1:1.5)} showing FIG. 12A C is signal and FIG. 12B N 1s signal; red circles represent the experimental measurement; thin black line is the fitted curve; colored filled peaks represent the deconvoluted fits of individual chemical species indicated in the legend.

FIGS. 13A-13C relate to optical characterization of different CN panels showing FIG. 13A UV—vis diffuse reflectance spectra of CN panels, FIG. 13B UV-vis absorption spectra (shown in units of absorbance percent), and FIG. 13C Tauc plots of CN panels assuming a direct band gap for the estimation of the optical band gap, Ex, utilizing the Kubelka-Munk function, F(R).

FIGS. 14A-14D relate to charge separation and valence band energy characterizations of CN_{MCA} and CN_{MCA-D} panels showing FIG. 14A photoluminescence (PL) spectra of CN_{MCA-D} and CN_{MCA} (excitation wavelength: λₑₓ=380 nm), FIGS. 14B-14C ultraviolet photoelectron spectroscopy (UPS) of CN_{MCA-D} and CN_{MCA}, respectively, showing extrapolated values of 19.8 and 4.55 eV for CN_{MCA-D} and 19.8 and 4.36 eV for CN_{MCA}. FIG. 14D band energy diagram based on an optical band gap estimation; y-axis shown presented using the normal hydrogen electrode (NHE) scale.

FIGS. 15A-15D relate to WO₃ panels, FIG. 15A is a digital image of the obtained WO₃ panels, FIG. 15B is a XPS survey scan spectra, FIG. 15C is a high-resolution W 4f, FIG. 15D is a high-resolution O is spectra of WO_{3-D} obtained after 5 min sonication of pristine WO_{3-D}.

FIG. 16 is a schematic diagram of the experimental setup: the reactant solution is continuously pumped from a solvent reservoir (1) using a peristaltic pump through the inlet (2) and, after flowing in the photoreactor over the photocatalyst panel (yellow), flows out through the outlet (3) back into the solvent reservoir (4). The solvent reservoir is equipped with a rubber septum (5) for gas purging and liquid sampling. The films perform reduction (via electrons, e⁻) and oxidation (via holes, h⁺) reactions. As examples 5-(hydroxymethyl) furfural (HMF) oxidation to 2,5-diformylfuran (DFF), water reduction to hydrogen (hydrogen evolution reaction, HER), and oxygen reduction to hydrogen peroxide (H₂O₂; pxygen reduction reaction, ORR).

FIGS. 17A-17B relate to a fabrication of the flow reactor, FIG. 17A is a schematic diagram of the fabrication of the flow reactor, the CN panel (2) is placed on a base (1), followed by covering with the middle part (3); on the right, a magnified view of (3) shows the inner volume (approximately-25 mL) with solution inlet and outlet; a glass (4) is placed on (3), and covered using the top part (5); the final reactor assembly step is closing and tightening using screws, FIG. 17B shows continuous-flow photoreactor setup used for H₂O₂ production.

FIGS. 18A-18D relate to production of H₂O₂ using different CN panels, FIG. 18A shows performance comparison between different CN panels in photoreactor at 2 and 4 h; reaction conditions: 6.7×6.7 cm² CN panel, 80 mL of 20% vol. EtOH in H₂O, 100 W LED light irradiation (2680 W m⁻²), flow rate ~1 mL min⁻¹, FIG. 18B shows comparison of H₂O₂ formation rate over CN_{MCA-D} as a panel (flow) and as a powder (batch), FIG. 18C shows comparison of H₂O₂ activity with the recent state-of-the-art metal-free g-C₃N₄ (graphitic C₃N₄) based photocatalysts (see also Table 2), and FIG. 18D shows control experiments.

FIGS. 19A-19B relate to LED spectrum, FIG. 19A shows white LED spectrum (measured at the illuminated panel's distance), and FIG. 19B shows normalized absorbance of CN_{MCA-D} (left y-axis) and the normalized irradiation spectra (righty-axis) of the illumination source—the white LED.

FIG. 20 is UV—vis spectral evolution of salicylic acid during H₂O₂ production experiment.

FIGS. 21A-21B are SEM images of CN_{MCA-D} panel after performing H₂O₂ production reaction for 4 h, FIG. 21A 40 μm scale bar and FIG. 21B4 Om scale bar, the insets show the digital images of the CN_{MCA-D} panel after a 4 h reaction.

FIGS. 22A-22B relate to structural and optical characterization of the fresh CN_{MCA-D} panel and after 4 h of H₂O₂ production showing FIG. 22A is a FTIR spectra and FIG. 22B is an UV—vis spectra.

FIGS. 23A-23E relate to H₂O₂ production using CN_{MCA}-ax panels of different thicknesses showing FIG. 23A shows a schematic representation of CN panels with varying thickness (CN_{MCA-D}, where x=1, 2, or 3): the total CN film thickness increases from 29 μm for one precursor doctor-bladed layer (CN_{MCA-D1}), to 37 M of two layers (labelled as CN_{MCA-D}), to 68 μm of three layers (CN_{MCA-D3}); FIG. 23B shows produced H₂O₂ concentration vs. thickness of the CN panels; FIG. 23C shows UV—vis diffuse reflectance spectra, FIG. 23D shows transmittance spectra, and FIG. 23E shows UV—vis absorption spectra-calculated as 100%—transmittance—% reflectance—of all CN panels.

FIG. 24 shows depiction of suggested H₂O₂ formation mechanism in the presence of ethanol.

FIG. 25 is UV—vis spectra recorded during H₂O₂ production reaction probing for 1,5-dihydroxynaphthalene (1,5-DHN), which reacts with singlet oxygen to form Juglone.

FIGS. 26A-26C relate to HMF photocatalytic oxidation, FIG. 26A is a general scheme for photocatalytic HMF oxidation using a CN_{MCA-D} panel, FIG. 26B shows HMF photooxidation at different times; reaction conditions: 6.7×6.7 cm² CN_{MCA-D} panel, 80 mL of 5 mM HMF in H₂O, 100 W LED light irradiation (2680 W m⁻², as shown above), flow rate-1 mL min⁻¹, FIG. 26C shows comparison of HMF conversion rate with the recent state-of-the-art photocatalysts.

FIG. 27 shows H₂O₂ production in parallel with HMF oxidation over time.

FIGS. 28A-28B are high-performance liquid chromatography diode-array detection (HPLC-DAD) profiles of continuous-flow HMF photooxidation reaction using CN_{MCA-D} panel measured at regular intervals; monitoring at λ=288 nm (FIG. 28A) and λ=210 nm (FIG. 28B), detected substances include unreacted HMF and the products DFF, Maleic acid, formic acid (HCOOH) and 2,5-furandicarboxylic acid (also known as 5-formylfuroic acid, FFCA).

FIGS. 29A-29B are HPLC-DAD profiles of DFF photooxidation in presence of H₂O₂(aq) using CN_{MCA-D} powder measured after 4 h reaction at λ=210 nm (FIG. 29A) and λ=288 nm (FIG. 29B); reaction conditions: 5 mg CN_{MCA-D} powder, 5 mL of 1 mM DFF in H₂O, 100 μL of aqueous H₂O₂ solution (30% wt.), 100 W LED light irradiation (2680 W m²).

FIGS. 30A-30B are SEM images of a CN_{MCA-D} panel after 24 h of HMF oxidation reaction, a scale bar of 40 μm (FIG. 30A) and a scale bar of 20 μm (FIG. 30B).

FIGS. 31A-31C relate to characterization of a CN_{MCA-D} panel before and after 24 h of HMF oxidation reaction; FIG. 31A is XRD patterns, FIG. 31B is FTR, and FIG. 31C is UV—vis spectra; the XRD patterns and FTIR spectra are vertically offset for clarity.

FIGS. 32A-32D relate to HMF photooxidation, FIGS. 32A and 32B are HPLC-DAD profiles of HMF photooxidation in presence and absence of NaN₃ and 1,4-benzoquinone (p-BQ) CN_{MCA-D} powder measured after 2 h at λ=288 nm (FIG. 32A) and at λ=210 nm (FIG. 32B); reaction conditions: 5 mg CN_{MCA-D} powder, 5 mL of 1 mM DFF in H₂O, 10 mM NaN₃ or p-BQ (30% wt.), 100 W LED light irradiation (2680 W m⁻²), FIG. 32C is a UV—vis spectra recorded during HMF photooxidation reaction probing for 1,5-DHN; reaction conditions: 5 mg CN_{MCA-D} powder, 5 mL of 1 mM DFF in H₂O, 1 mM DHN, 100 W LED light irradiation (2680 W m⁻²), FIG. 32D is a photograph showing diluted aliquots (1 mL), taken at regular 15 min intervals, for UV-vis absorbance measurement and H₂O₂ test papers measuring the corresponding solutions during HMF photooxidation reaction probing for 1,5-DHN.

FIG. 33 shows proposed mechanism for HMF photooxidation over CN_{MCA-D}.

FIGS. 34A-34D relate to the analysis of 9-(2-carboxyphenyl)-6-(diethylamino)-N,N-diethyl-3H-xanthen-3-iminium chloride, abbreviated as rhodamine B (RhB) degradation, FIG. 34A is a schematic diagram of a continuous-flow RhB degradation experiment continuously measuring absorbance via UV—vis spectrometry; the RhB solution is continuously pumped out from the solvent reservoir using a peristaltic pump through the photoreactor, the monitored UV cuvette, and back to the reservoir, FIG. 34B is an in-line UV—vis spectral change of the RhB dye reactant during the photodegradation experiment; reaction conditions: 6.7×6.7 cm² CN panel, 80 mL of 1 M RhB(aq) solution, 100 W LED light irradiation, flow rate ~1 mL min⁻¹, FIG. 34C shows RhB degradation over time, and FIG. 34D shows pseudo-first-order kinetics approximation for RhB degradation over a CN_{MCA-D} panel; kap=7.9×10 min⁻¹.

FIGS. 35A-35C relate to H₂ production, FIG. 35A shows a reaction setup for H₂ production; reaction conditions: 6.7×6.7 cm² CN_{MCA} panel, 25 mL of 20% vol. of EtOH in DI water, 100 W white LED irradiation, 20 μL of 8% wt. of chloroplatinic acid (elemental composition estimation using EDS shows ~3.7% wt. of Pt on the panel after initial photo deposition). FIG. 35B is a digital photo of a CN_{MCA} panel after H₂ production reaction, and FIG. 35C is a SEM image of a CN_{MCA} panel after H₂ production reaction.

FIGS. 36A and 36B are a schematic diagram of the proposed H₂O₂-mediated co-catalyst free H₂ and HCOOH production over a photocatalyst in comparison with the traditional approach, which requires a Pt cocatalyst to be deposited before the reaction takes place (FIG. 36A) and over CN_{MCA} photocatalyst powders or panels in comparison with the traditional approach where a Pt co-catalyst is deposited before the reaction takes place (FIG. 36B).

FIGS. 37A-37B relate to CN powders, FIG. 37A is a XRD spectra and FIG. 37B is a FTR spectra of CN powders.

FIGS. 38A-38C relates to surface characterization of CN_{MCA}, FIG. 38A is a XPS survey scan, FIG. 38B is a high-resolution C 1s, and FIG. 38C is a high-resolution N 1s spectra of CN. FIGS. 39A-39B relate to optical characterization of CN_{MCA} photocatalyst powders, FIG. 39A shows diffuse reflectance ultraviolet-visible spectrum DR-UV—vis and FIG. 39B is a Tauc plot of CN.

FIG. 40 is a XRD spectrum of bulk WO₃.

FIGS. 41A-41B relate to bulk WO₃, FIG. 41A is a DR-UV—vis spectrum of Bulk WO₃ and FIG. 41B shows Tauc plot of Bulk WO₃.

FIG. 42 is a XRD spectrum of WO₃ NPs.

FIGS. 43A-43C relate to WO₃ NPs, FIG. 43A is a XPS survey scan of WO₃ NPs, FIG. 43B is a high-resolution W4f of WO₃ NPs, and FIG. 43C is a high-resolution O1s spectra of WO₃ NPs.

FIGS. 44A and 44B relate to WO₃ NPs, FIG. 44A is a DR-UV—vis of WO₃ NPs and FIG. 44B is a Tauc plot of WO₃ NPs.

FIGS. 45A and 45B relate to visible-light driven co-catalyst free H₂ production over CN and WO₃ photocatalysts showing the comparison of H₂(g) production rate after 4 h under different conditions and the inset shows the H₂ production after 24 h; reaction conditions: 20 mg of the catalyst, 5 mL of solution (described in the figure legend; best Pt-free CN after 4 hours in 20 vol % MeOH in 0.1 M NaOH(aq), static air, 40° C., 100 W LED light irradiation (2680 W m⁻²)).

FIGS. 46A and 46B are UV—vis spectra showing the formation of H₂O₂; reaction conditions: 20 mg of WO₃ NPs photocatalyst, 5 mL of 20 vol. % EtOH, 40° C., static air, 100 W LED light irradiation (2680 W m⁻²).

FIGS. 47A and 47B relate to WO₃ NPs, FIG. 47A shows gas chromatography (GC) spectra of the gaseous products measured at different times using CN photocatalyst and FIG. 47B shows WO₃ NPs as the photocatalyst.

FIG. 48 shows control experiments in the dark; reaction conditions: 200 μL of HCHO (37% vol.) and 200 μL of H₂O₂ (30% wt.), 4.6 mL of water/0.1 M NaOH, static air. 1 mL of HCHO (37% wt.); for water 25° C. is used, for 0.1 M NaOH reactions at two temperatures are shown: 25° C. and 40° C.

FIGS. 49A-49H relate to spectroscopic analysis of the chemical reaction during H₂O₂ and HCHO formation and the ensuing chemical reaction between H₂O₂ and HCHO in neutral and basic environments showing FIGS. 49A-49B UV—vis absorption spectral change of individual HCHO and H₂O₂ in pure water, FIGS. 49C-49D UV—vis absorption spectral change of HCHO and H₂O₂, respectively, in 0.1 M NaOH for 1 h, FIGS. 49E-49F UV—vis absorption spectral change of H₂O₂ and HCHO mixture in pure water and 0.1 M NaOH for 1 h, FIG. 49G the FTIR spectra of HCHO in pure water and FIG. 49H the FTIR spectra of mixture of H₂O₂ and HCHO in pure water.

FIGS. 50A-50F relate to H₂ production FIG. 50A shows a proposed mechanistic path for H₂O₂-mediated H₂ production from MeOH oxidation over WO₃ and FIG. 50B shows comparison of H₂ yields obtained under different conditions; reaction conditions: 20 mg of CN photocatalyst, 1 mL of MeOH or HCHO (37% vol. in water) or HCOOH (98% purity), 4 mL of 0.1 M NaOH, 20 mg CN, static air, 100 W LED light irradiation (2680 W m⁻²), proposed mechanistic path for H₂O₂-mediated H₂ production from MeOH oxidation over WO₃ (FIG. 50C), comparison of H₂ yields obtained under different conditions. Reaction conditions: 20 mg of CN photocatalyst, 5 mL 0.08 M NaOH aqueous solution, 20% vol of which is the reactant: (i) MeOH, (ii) HCHO (added as 1 mL of 37% wt in water; 10-15% MeOH stabilizer), or (iii) HCOOH, 20 mg CN, static air, 40° C., 100 W white LED irradiation, ((7.9 f 0.9)×103 W m⁻²). Cycle experiments (FIG. 50D) for 6 days (24 h per cycle) (FIG. 50E) and for 10 days (48 h per cycle), (FIG. 50F), reaction conditions: 20 mg of CN photocatalyst, 5 mL of 20% vol of MeOH in 0.2 M NaOH, 20 mg CN, static air, 40° C., 100 W white LED irradiation. In each cycle, after 24 h illumination, the solution was degassed, and the air was refilled before the subsequent 24 h illumination, The indicated pH values of the reaction mixture (including the catalyst) were recorded after each cycle.

FIGS. 51A-51B are UV—vis absorption spectra of reaction mixture treated with Nash reagent showing the formation of HCHO, FIG. 51A CN photocatalyst and FIG. 51B WO₃ NPs as the photocatalysts; reaction conditions: 20 mg of photocatalyst, 5 mL of 20 vol. % MeOH in pure water, 40° C., static air, 100 W LED light irradiation (2680 W m⁻²).

FIG. 52 is HPLC-PDA spectrum at λ=210 nm, showing reference formate retention time (detecting formic acid).

FIGS. 53A-53C is HPLC-PDA spectra obtained for MeOH oxidation experiments, FIG. 53A After 4 h illumination using CN (blue), WO₃ NPs (pink) as the photocatalysts, FIG. 53B at λ=210 nm showing the synthesis of formic acid after 0 and 4 h, FIG. 53C HPLC HCOOH calibration curves (20% vol. MeOH in 0.08 M NaOH).

FIG. 54 shows comparison of H₂ yields obtained under different conditions after 24 h.

FIGS. 55A-55C relate to scaling experiment FIG. 55A shows scaling experiment; reaction conditions: 200 mg of the catalyst, 100 mL of 0.1 M NaOH (20 vol % of MeOH), static air, 100 W LED light irradiation (2680 W m⁻²), FIGS. 55B and 55C are cycle experiments using CN photocatalyst; reaction conditions: 20 mg of catalyst, 5 mL of 0.1 M NaOH (20 vol % of MeOH), static air. FIG. 55B 24 h reaction (4 h per cycle) and FIG. 55C shows 6 days reaction (24 h per cycle) with 0.08 M NaOH, After each cycle (indicated by vertical dashed lines) the air reservoir was replenished.

FIG. 56 shows schematic representation of a plastic panel preparation process; an high-density polyethylene (HDPE) source (here, in the form of beads) is melted at 220° C. in an alumina template (demonstrated, size of 6.7×6.7 cm²), then the photocatalyst powder (as a representative example, CN) is spread and lightly pressed into the molten HDPE, and left to cool down to room temperature under ambient conditions; inset: scanning electron microscopy (SEM) image of the CN/HDPE panel (CN is artificially highlighted with a light-yellow hue).

FIGS. 57A-57B show HER batch reactor setups: digital photos of FIG. 57A ‘standard’ photocatalytic experiment with CN powder in a reaction vessel of deionized water (DI)+10% vol. EtOH as a hole scavenger illuminated through a water jacket for temperature control, and constantly stirred for continuous dispersion of the power photocatalyst, FIG. 57B showing the plastic photocatalyst panel implementation: HDPE plastic waste as the source material is melted and covered with CN powder using the demonstrated method to get the CN photocatalyst panel, which is applied for photocatalysis as a panel in the reaction vessel similarly to the powder photocatalyst analog without requiring stirring.

FIGS. 58A-58D are digital photographs of different photocatalytic HDPE panels; FIG. 58A Bi₂O₃/HDPE, FIG. 58B WO₃/HDPE, FIG. 58C TiO₂/HDPE, and FIG. 58D ZnO/HDPE.

FIGS. 59A-59D. Digital photographs of CN photocatalyst on different plastic supports, FIG. 59A Polypropylene (PP), melted at 200° C., FIG. 59B Ethylene vinyl-acetate (EVA), melted using a commercial hot glue gun (−100° C.), FIG. 59C Poly(methyl methacrylate) (PMMA), melted at 180° C., FIG. 59D Low-density Polyethylene (LDPE), melted at 180° C.

FIGS. 60A-60J are SEM images of FIGS. 60A-60D HDPE after melting and cooling down, FIGS. 60E-60H CN/HDPE panel, and FIGS. 60I-60J cross-sectional view of CN/HDPE panel.

FIGS. 61A-61D relate to CN/HDPE panel, FIG. 61A is a focused ion beam (FIB)-assisted cross-section SEM image. FIGS. 61B-61C are energy-dispersive X-ray spectroscopy (EDS) mapping of the cross-sectional CN/HDPE panel image, FIG. 61B carbon, and FIG. 61C nitrogen, FIG. 61D is a SEM image of the area from which the FIB cross-section was taken, highlighted in orange.

FIG. 62A-62C relate to CN/HDPE panel, FIG. 62A a top-view SEM image of the panel, FIG. 62B carbon EDS elemental map, FIG. 62C nitrogen EDS elemental map.

FIGS. 63A-63D relate to structural and optical characterization of CN-2-Cl-mlm photocatalyst showing FIG. 63A FTIR spectra of CN-2-Cl-mlm powder, the prepared HDPE panel (after heat treatment, before photocatalyst deposition), and CN-2-Cl-mlm/HDPE panel; FIG. 63B XRD pattern of HDPE and CN-2-Cl-mlm/HDPE panel, FIG. 63C diffuse reflectance UV—vis (proportional to absorption) spectra of CN-2-Cl-mlm powder and CN-2-Cl-mlm/HDPE panel; FIG. 63D photocatalytic ORR (H₂O₂ production) action spectrum with CN-2-Cl-mlm/HDPE panel: left y-axis is the DR-UV—vis while the right y-axis is the photocatalytically produced H₂O₂.

FIGS. 64A-64E are high-resolution X-ray photoelectron spectroscopy (XPS) spectra showing FIG. 64A C 1s of pure HDPE after melting and natural cooling down back to room temperature, FIG. 64B C Is of CN-2-Cl-mlm/HDPE panel, FIG. 64C N 1s of CN-2-Cl-mlm/HDPE panel, FIG. 64D C is of CN-2-Cl-mlm powder, and FIG. 64E N 1s of CN-2-Cl-mlm powder.

FIGS. 65A-65B show schematic representation of flow and batch photocatalytic processes; FIG. 65A oxygen reduction reaction (ORR) in a flow reactor configuration, 25 cm² panel with a 100 mL reservoir of 02 saturated 10% EtOH in DI, at a flow rate of 1 mL min⁻¹, FIG. 65B hydrogen evolution reaction (HER) in a batch configuration, 4.0 cm² panel (with Pt nanoparticles photo-deposited prior to reaction) with 10 mL of 10% EtOH in DI and 18.5 mL headspace washed with 99.999% argon gas.

FIGS. 66A-66I relate to oxygen reduction reaction (ORR) and H₂ production, FIG. 66A is a schematic representation of energy diagram of oxygen reduction reaction (ORR) over a CN photocatalyst, FIG. 66B 3 subsequent cycles of ORR—each of a 6-hour duration-performing ORR over a CN-2-Cl-mlm/HDPE panel; the first 4 h cycle is performed in pure DI, followed by three subsequent 6 h cycles in the presence of 10% v/v EtOH (in DI), serving as the hole scavenger, FIG. 66C is a schematic representation of energy diagram of photocatalytic HER in a batch reaction over a Pt@CN-2-Cl-mhnM/HDPE panel, FIG. 66D shows stability test for HER with 3 cycles of 4 hours each—a total 12 hours of photocatalytic reaction: a preliminary 4 h cycle is performed in pure DI, followed by three subsequent 4 h cycles in the presence of 10% vol. EtOH (in DI), serving as the hole scavenger, with detected and quantified produced H₂, FIG. 66E shows the long term (7 days) photocatalytic H₂ production using a 4×1 cm² CN-2-Cl-mlm/HDPE panel (2.5% wt. Pt as co-catalyst) in a batch reactor with a 20 mL of 10% EtOH in DI, FIG. 66F shows HER measured with a CN|HDPE panel retained its initial photocatalytic rate for 21 weeks, with an average rate of 4.67 mmol h⁻¹ m⁻², which is a significant step towards implementing green hydrogen production on an industrial scale, FIG. 66G HER measurements with a CNHDPE waste panel, which is made from actual waste, shows good stability going for 6 weeks with an average rate of 5.83 mmol h⁻¹ m⁻², FIG. 66H is an image of the photocatalytic reactor setup, FIG. 66I is an image of the photocatalytic reactor under illumination.

FIG. 67 shows long-term H₂O₂ production (ORR) using a 5×5 cm² CN-2-Cl-mlm/HDPE panel, in a flow reactor configuration with a 100 mL of 1 M D-Glucose in DI reservoir, and a 25 cm² cell, under 100 W white LED illumination and oxygen atmosphere.

FIG. 68 shows H₂O₂ production (ORR) using a 5×5 cm² CN-2-Cl-mlm/HDPE panel, in a flow reactor configuration with a 100 mL of 0.36 M of 4-methoxy benzyl alcohol in DI reservoir, and a 25 cm² cell, under 100 W white LED illumination and oxygen atmosphere.

FIGS. 69A-69D relate to H₂ production, FIG. 69A shows a batch reaction setup for the use of a CN film over glass: a CN_{MCA-D} panel, FIG. 69B shows CN/HDPE panel FIG. 69C shows a batch reaction setup used for large-scale H₂ production from 20 vol % MeOH in 100 mL of 0.1 M NaOH using a CN/HDPE photocatalyst panel, FIG. 69D shows CN/HDPE panel after 24 h reaction.

FIGS. 70A-70B relate to CN panel electrode, FIG. 70A shows CN_{MCA-D} panel over fluorine-doped tin oxide coated glass substrate (FTO), FIG. 70B shows schematic of the experimental setup used for electrochemical (EC) (panel is anode) and photoelectrochemical (PEC) (panel is photoanode) methanol oxidation experiments.

FIGS. 71A-71F relate to CN panel electrode, FIG. 71A is a LSV curve of CN_{MCA-D} panel electrode in presence of 30 vol. % MeOH aqueous solution, FIG. 71B is a chronoamperometry curve of CN_{MCA-D} panel electrode recorded at 1.23 V vs. RHE in presence of 30 vol. % MeOH aqueous solution for 1 h, FIG. 71C is a UV—vis absorption spectra of electrochemically produced HCHO with Nash reagent, FIG. 71D is a photocurrent response and FIG. 71E is a chronoamperometry curve of CN_{MCA-D} panel electrode recorded at 1.23 V vs. RHE in presence of 30 vol. % MeOH aqueous solution and FIG. 71F UV—vis absorption spectra of photoelectrochemically produced HCHO with Nash reagent.

FIGS. 72A-72D, FIG. 72A is HPLC HCOOH calibration curve (20% vol. MeOH in 0.2 M NaOH), and FIG. 72B HCOOH yields obtained in cycle experiments for 10 days (48 h per cycle). Reaction conditions: 20 mg of CN photocatalyst, 5 mL of 20% vol. of MeOH in 0.2 M NaOH, 20 mg CN, static air, 40° C., 100 W white LED irradiation. After each 48 h cycle, 10 μL of the filtered reaction mixture was diluted to 1 mL using 0.05 M H₂SO₄ solution and injected into the HPLC instrument. FIG. 72C DRUV—vis and FIG. 72D FTIR spectra of CN powder before and after 10 day photocatalytic recyclability tests.

FIGS. 73A and 73B show photocatalytic reaction, FIG. 73A shows a photocatalytic setup used for photocatalytic experiments comprising a quartz reaction tube, a double-walled jacket connected to a chiller offering temperature control (the inside is also filled with water to allow good heat transport) and an illumination source at a fixed position, FIG. 73B 100 W white LED irradiance spectrum used for photocatalytic experiments (measured with an optical fiber, connected to a spectrometer, placed instead of the quartz tube; the coolant water within the jacket's double wall was filled with water, but the vessel itself was empty to allow measurement; The average of three separate measurements gave (7.9}0.9)×103 W m⁻², integrated over a 30-00 nm range; the irradiance spectrum of a single measurement, closest to the average value is shown (7.01×103 W m⁻²), the source onset in the visible range is ca. 400 nm.

FIGS. 74A and 74B show reaction mechanisms for ORR, MeOH oxidation, and H2 and HCOOH production pathways as simulated at PBE-D3 DFT, FIG. 74A ORR (green) and MeOH oxidation (purple) mechanisms on WO₃(001) interface. The MeOH oxidation encompasses CH3OH adsorption followed by two water-mediated proton transfers to the nearby surface oxygen, resulting in the formation of a water molecule that desorbs along with HCHO to form a surface oxygen vacancy (Ov). ORR consists of O2 adsorption followed by two subsequent proton-coupled electron transfer (PCET) steps leading to the formation and desorption of H₂O₂. The transparent red sphere represents an oxygen vacancy resulting from methanol oxidation. The surface vacancy replenishment along with its energy is also illustrated, FIG. 74B Solution-phase homogeneous reaction mechanism for H2 production as proposed by Wieland and Wingler18 (blue) and the Cannizaro pathway (red).

FIGS. 75A and 75B show reaction energetics for the ORR, methanol oxidation, and H2 and HCOOH production pathways, FIG. 75A ORR and methanol oxidation energetics on WO₃(001) with reaction path illustrations as computed with DFT-PBE. MeOH oxidation is feasible because CH3OH adsorption and subsequent steps are exothermic. The 02 adsorption on the oxygen vacancy surface (*Ov) formed during methanol oxidation is slightly exothermic, making ORR feasible, FIG. 75B Reaction energetics for H2 and HCOOH production from H2O2 and HCHO and the competing Cannizaro mechanism.

FIG. 76 1H-NMR spectrum for product analysis of MeOH photooxidation in an alkaline medium using CN photocatalysts.

FIGS. 77A-77C relate to process contributions associated with the ten tool for reduction and assessment of chemicals and other environmental impacts (TRACI) impact categories to produce 1 g of (a) CN, (b) CN/Pt, and (c) the relative impact assessment for synthesizing 1 g of CN and 1 g of CN/Pt. In FIG. 77A, the primary contributors to environmental impacts are electricity and nitrogen. In contrast, FIG. 77B highlights that the majority of the impact of the CN/Pt synthesis stems from electricity and the production of hexachloroplatinic acid (H2PtCl6), the platinum precursor used for incorporating Pt into CN. FIG. 77C Further emphasizes the additional impact contributions associated with incorporating platinum in CN/Pt. The environmental impact of CN across all categories is, on average, ~3% that of CN/Pt. In the figure, OD=ozone depletion, GWP=global warming potential, PS=photochemical smog, AD=acidification, EU=eutrophication, CA=carcinogenics, NC=noncarcinogenics, RE=respiratory effects, EC=ecotoxicity, FF=fossil fuel depletion.

FIGS. 78A-78D relate to oxygen reduction reaction (ORR) and concurrent oxidation, FIG. 73A shows ORR and concurrent p-anisyl alcohol oxidation was measured again over 5 photocatalytic cycles of 24 hours each, this time with a lower initial concentration of 0.010 M p-anisyl alcohol, only washing with water between cycles, and retaining the initial rates of H₂O₂ production over 5 cycles, exhibiting an average rate of 2.38 mmol h⁻¹ m⁻², supporting the nonlinear behavior in the previous measurement, stemming from consumption of H₂O₂ as an oxidizing agent, and in the presence of higher oxidant concentrations, FIG. 78B shows the good conversion yields for p-anisyl alcohol to p-anisaldehyde in these 5 cycles correspond to an average selectivity of 72.6% towards p-anisaldehyde, with high stability, retaining its initial reactivity after 120 hours, FIG. 78C demonstrates the high stability and versatility of the system, the same panel was utilized, after only washing with DI water, for photocatalytic ORR and concurrent glucose oxidation for 5 additional 24-hour cycles this time with a fresh initial concentration of 0.100 M D-glucose, FIG. 78D shows that this reaction exhibited average H₂O₂ production rates of 1.20 mmol h⁻¹ m⁻², during these additional 120 hours, while on the oxidation side, showing high activity, with an average of 7.32 mmol h⁻¹ m⁻² D-gluconic acid production rate.

### DETAILED DESCRIPTION OF EMBODIMENTS

The present disclosure is directed to catalytic materials and catalytic panels with tunable structural and physical properties that can be used in a wide range of applications, including sustainable energy production and environmental remediation.

A key aspect of this disclosure is a universal approach of binder-free catalyst panels, which exhibit enhanced stability and performance in various catalytic reactions.

The novel binder-free panel enable the association of various catalytic materials, including inter alia, polymeric carbon nitrides, metal oxides and metal sulfides onto and/or within different supports, including, such as glass, doped glass, metals, metal oxides, doped metal oxides or different plastic materials.

As demonstrated below, these binder-free catalytic panels have been successfully integrated into photoreactors, such as continuous-flow reactors, for a variety of applications. These applications include hydrogen peroxide and hydrogen production, water purification, decontamination, and organic transformations. Specifically, the catalytic panels have been proven highly effective in the production of hydrogen and hydrogen peroxide, oxidation of biomass-derived compounds (for example 5-hydroxymethylfurfural), and water purification.

An additional key aspect of this disclosure pertains to catalytic materials in the form of particulate matter, such as powders. These materials were unexpectedly successful in indirectly producing hydrogen gas. As demonstrated below, the unique activity of these catalytic materials is attributed to their ability to couple hydrogen peroxide (H₂O₂) production with the oxidation of a hydroxyl-containing compound. The produced H₂O₂ spontaneously reacts with the oxidation product of the hydroxyl-containing compound to generate hydrogen (H₂). Notably, these materials can be used either in powder form or integrated into the panels, as described herein.

This indirect method of hydrogen production is particularly significant for materials that are unable to directly reduce water to hydrogen gas as it offers a novel pathway for hydrogen generation. This property enhances the versatility and potential impact of such materials in energy production and other industrial processes, where efficient and scalable hydrogen generation is critical.

Taken together, the panels and materials described herein offer a versatile platform for various catalytic processes.

Hence, in accordance with some aspects, the present disclosure is directed to a binder free catalytic panel that comprises a catalytic material and a substrate material. In other words, the disclosure is directed to catalytic panel that comprises a catalytic material and a substrate material, wherein the catalytic panel is binder free.

In the following text, when referring to the catalytic panel it is to be understood as also referring to a catalytic material, a catalytic composite material, a catalytic particulate matter, a catalytic powder, uses, methods, and processes, disclosed herein. Thus, whenever providing a feature with reference to the catalytic panel, it is to be understood as defining the same feature with respect to the catalytic material, a catalytic composite material, a catalytic particulate matter, a catalytic powder, uses, methods, and processes, mutatis mutandis.

As shown herein, the catalytic material can be used as is (for example, in powder form) or can be attached/deposited/associated or formed on or within a substrate. In cases where the catalytic material is associated with the substrate as described herein, this association occurs without the use of binding agents (binders), meaning that the association is achieved without addition of a binder. Typically, these binders are used to hold the catalytic material together or affix it to a substrate.

It was suggested that the absence of binders may enhance catalytic activity by increasing the number of active sites available for reactions and improving the overall stability of the panel, as well as enhancing light management, thereby allowing for more efficient energy use in processes like photocatalysis. Additionally, it was proposed that when the catalytic material is held by physical interactions within the substrate (for example, when the substrate is a polymer), the absence of binders reduces unwanted chemical reactions during the catalytic process (e.g. photocatalytic reactions), compared to situations where a binder is present at the catalytic sites. Furthermore, it was suggested that the lack of binders prolongs the attachment of the catalytic material and diminishes or prevents the leaching of the photocatalytic material.

Binder as used herein refers to a substance that is generally used to hold together or attach catalytic materials to a substrate, ensuring stability and uniformity as well as maintaining mechanical strength, improving adhesion, or maintaining the integrity of the material during catalytic reactions.

Non-limiting examples of binders include binders comprising ferfluoro groups, for example, Nafion or SiO₂ binders.

In some examples, the panel is binder-free.

In some examples, the panel is essentially free of a binder.

In the configuration described herein, i.e., in the binder-free panel, the catalytic material is in direct contact with the substrate (e.g., directly integrated) without the use of any binders or adhesives. Thus, the panel, in accordance with the present disclosure, is self-supporting, meaning there is no need for any binder to provide support, such as structural support and/or mechanical support.

Hence, in accordance with some aspects, the present disclosure provides a panel comprising at least one catalytic material and at least one substrate, wherein the catalytic material is directly associated to the substrate.

The term panel as used herein refers to a flat or slightly curved, typically thin material or structure used as a platform in various applications.

In some examples, the panel is a catalytic panel.

The term catalytic panel as used herein refers to a panel that facilitates reactions by providing an active surface for the reactions to occur, often accelerating the rate of reactions without being consumed in the process.

In some examples, the panel is a photocatalytic panel. In some other examples, the panel is an electrophotocatalytic panel.

The term associated (or association) as used herein refers to the presence or connection of the catalytic material on at least part of the substrate or within at least part of the substrate.

The term directly associated, as used herein, indicates that the catalytic material is in direct contact with the substrate, without the need for intermediary layers such as adhesives, binders, or other agents. In this configuration, the catalytic material adheres or integrates with the substrate either through a physical process (e.g., partial melting, deposition/attachment) or a chemical interaction, forming a stable interaction that enhances the material's performance. It was suggested that this direct attachment can improve the efficiency of the catalytic reactions by maximizing the exposure of the active catalytic surface to reactants. Furthermore, since there is no binder present that could be prone to chemical attack, the overall stability of the system is improved, leading to longer lasting and more reliable catalytic performance.

The association may be in some examples by a process in which the catalytic material is applied onto the substrate or within the substrate.

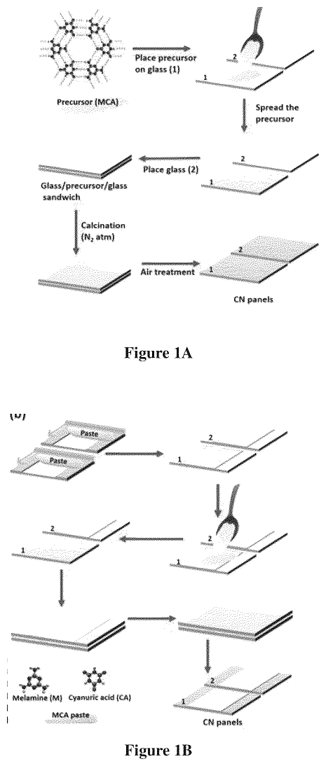

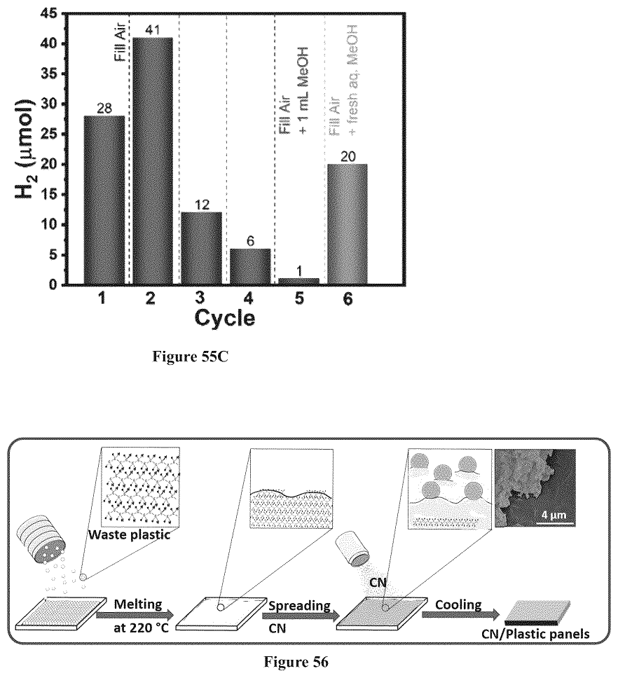

The method may be for example a process described herein, for example, a process that is schematically shown in FIG. 1A and denoted herein as “sandwich” or as schematically shown in FIG. 1B and denoted herein as “doctor-blade assisted “sandwich” or alternatively as the process that is schematically shown in FIG. 56. It should be noted that the process schematically shown in FIG. 56 may be applicable to substrate material that is or comprises a polymer as further described herein.

In some examples, the association between the catalytic material and the substrate is by chemical bond. In some examples, the chemical bond may be Van der Waals forces or covalent bonding. In some examples, the association between the catalytic material and the substrate is by physical embedding.

As described herein the substrate material is characterized by having at least one surface on which the catalytic material is attached to or embedded within. The surface may be described in accordance with some examples as an outer layer of the substrate, e.g. an outermost part of the substrate where the catalytic material is either attached (on the surface) or embedded (within the substrate).

In some examples, the at least one catalytic material is at least partially associated on the substrate material. It should be noted that in this configuration, the catalytic material is attached to the surface of the substrate without significant penetration or incorporation into the substrate's internal structure.

In some examples, the at least one catalytic material is at least partially (minimum) embedded within the substrate material. It should be noted that in this configuration, the catalytic material is integrated within the substrate, often involving partial or complete enclosure by the substrate material. In other words, the catalytic material may have exposed regions for interaction.

The association between the catalytic material and the substrate may include various forms of association.

In some examples, the at least one catalytic material is homogeneously associated with the substrate material. The term homogeneously associated should be noted as if the catalytic material is uniformly distributed across the surface of the substrate, ensuring that all regions of the substrate have an equal amount of the catalyst.

In some examples, the at least one catalytic material is heterogeneously associated with the substrate material. The term heterogeneously associated should be noted as if the catalytic material is not uniformly distributed across the substrate. In such cases, the non-uniformity can be due to varying thicknesses, localized clusters, or regions with different concentrations of the catalytic material.

In some examples, the at least one catalytic material is associated with the substrate material in layers. The term layered associated should be noted as if multiple layers of catalytic material (identical or different materials) are applied to the substrate, either in a stacked or stratified manner.

In some examples, the at least one catalytic material is associated with the substrate material in a patterned association. The term patterned associated should be understood as an association that involves selective association of the catalytic material in specific shapes or designs on the substrate.

In some examples, the at least one catalytic material is associated with the substrate material in a gradient association. The term gradient associated should be understood as if the concentration or composition of the catalytic material changes gradually across the substrate. This association may form a gradient of reactivity, with certain areas more active than others.

In some examples, the at least one catalytic material is associated with the substrate material in a porous association. The term porous associated should be understood as if the catalytic material forms a porous layer on the substrate, allowing for increased surface area and enhanced interaction with reactants. As noted herein, the pores can be on the nanoscale or microscale, depending on the desired application.

In some examples, the at least one catalytic material is associated with the substrate material in a multiphase association. The term multiphase associated should be understood as if the catalytic material consists of more than one phase (e.g., solid-solid or solid-liquid), which may include particles embedded in the substrate or different catalytic materials distributed in various phases.

The thickness of the catalytic material can be defined as uniform, variable, multilayered, or porous, depending on the application.

In some examples, the catalytic material may have a thickness of at least about 0.3 μm, at times at least about 0.5 μm, at times at least about 0.7 μm, at times at least about 1. μm, at times at least about 2 μm, at times at least about 3 μm, at times at least about 4 μm at times at least about 5 μm, at times at least about 7, at times at least about 10 μm, at times at least about 30 μm, at times at least about 50 μm, at times at least about 70 μm, at times at least about 100 μm, at times at least about 150 μm, at times at least about 200 μm, at times at least about 250 μm, at times at least about 300 μm, at times at least about 350 μm, at times at least about 400 μm, at times at least about 450 μm, at times at least about 480 μm.

In some examples, the catalytic material may have a thickness of about 0.3 μm, at times about 0.5 μm, at times about 0.7 μm, at times about 1 μm, at times about 2 μm, at times about 3 μm, at times about 4 μm, at times about 5 μm, at times about 6 μm, at times about 7 μm, at times about 8 μm, at times about 9 μm, at times about 10 μm, at times about 15 μm, at times about 20 μm, at times about 25 μm, at times about 30 μm, at times about 35 μm, at times about 40 μm, at times about 45 μm, at times about 50 μm, at times about 60 μm, at times about 70 μm, at times about 80 μm, at times about 90 μm, at times about 100 μm, at times about 120 μm, at times about 150 μm, at times about 170 μm, at times about 200 μm, at times about 230 μm, at times about 250 μm, at times about 270 μm, at times about 300 μm, at times about 320 μm, at times about 350 μm, at times about 370 μm, at times about 400 μm, at times about 420 μm, at times about 450 μm, at times about 480 μm.

In some examples, the catalytic material may have a thickness of between about 0.3 μm to about 500 μm, at times between about 0.3 μm to about 450 μm, at times between about 0.3 μm to about 400 μm, at times between about 0.3 μm to about 350 μm, at times between about 0.3 μm to about 300 μm, at times between about 0.3 μm to about 250 μm, at times between about 0.3 μm to about 200 μm, at times between about 0.3 μm to about 150 μm, at times between about 0.3 μm to about 100 μm, at times between about 0.3 μm to about 70 μm, at times between about 0.3 μm to about 60 μm, at times between about 0.3 μm to about 50 μm, at times between about 0.3 μm to about 40 μm, at times between about 0.3 μm to about 20 μm, at times between about 0.3 μm to about 10 μm, at times between about 0.3 μm to about 2 μm.

In some examples, the catalytic material may have a thickness of between about 0.7 μm to about 500 μm, at times between about 1 μm to about 500 μm, at times between about 5 μm to about 500 μm, at times between about 10 μm to about 500 μm, at times between about 20 μm to about 500 μm, at times between about 50 μm to about 500 μm, at times between about 70 μm to about 500 μm, at times between about 100 μm to about 500 μm, at times between about 120 μm to about 500 μm, at times between about 150 μm to about 500 μm, at times between about 170 μm to about 500 μm, at times between about 200 μm to about 500 μm, at times between about 250 μm to about 500 m, at times between about 300 μm to about 500 μm.

In some examples, the catalytic material may have a thickness of between about 0.3 μm to about 100 μm, at times between about 0.7 μm to about 80 μm, at times between about 1 μm to about 70 μm, at times between about 1 μm to about 50 μm, at times between about 1 μm to about 40 μm.

It was suggested that the thickness of the catalytic material ensures sufficient light absorption, charge transport, and reactivity while maintaining mechanical stability.

The catalytic material as used herein refers to a substance that facilitates or accelerates a chemical reaction.

The present disclosure is not limited to a specific catalytic material and, as demonstrated in the examples below, may encompass various materials.

In some examples, the catalytic material is a photocatalytic material and/or a photo-electrocatalytic material.

The term photocatalytic material refers to a substance that facilitates a reaction upon exposure to light (absorption of light), usually from visible or ultraviolet light sources. In general, when photocatalytic material absorbs photons, it generates electron-hole pairs, which can participate in redox reactions.

The term photo-elecocatalytic material refers to a substance that utilizes light and electrical current to facilitate chemical reactions. In general, these materials have the ability to absorb photons (light) and use the resulting excited electrons and holes to participate in redox reactions. Simultaneously, an applied electrical bias helps drive the reaction forward, either by enhancing charge separation or by directly participating in electron transfer processes.

In some examples, the catalytic material is a semiconductor material.

The catalytic material is characterized in accordance with some examples by an optical bandgap (E_{g}) of at least about 0.8 eV, at times at least about 1.8 eV, with certain embodiments having a bandgap ranging from 0.8 to 5 eV. The bandgap is an important factor in determining the material's ability to absorb light and drive catalytic reactions. Materials with a bandgap in this range are well suited for visible light-driven applications as further described herein below.

In some examples, the catalytic material is at least one of a carbon-based material, a metal and/or metal-containing material, a SiC, a covalent organic framework material (COFs), a metal-organic framework material (MOFs), a polyoxometalate material (POMs), a nanoparticle, or any combination thereof.

In some examples, the catalytic material is a carbon-based material.

In some examples, the carbon-based material is one or more of a polymeric CN, a modified CN, graphene, graphene oxide, reduced graphene oxide, graphite, carbon or inorganic nanotube, a carbon dot, a nitrogen-doped carbon or any combination thereof.

In some examples, the catalytic material is a polymeric CN (CₓN_{y}), which may contain a variable amount of H and O atoms.

The term polymeric CN as used herein refers to a class of polymeric materials composed primarily of carbon (C) and nitrogen (N) atoms arranged in a covalently bonded network.

The polymeric CN may form various structures.

In some examples, the polymeric CN is characterized by a stoichiometric ratio CₓN_{y} between x/y=0.5 to 2 with a varying amount of O and H elements (that is CₓHOₚH_{q}).

In some examples, the polymeric CN is characterized by having one or more of a melon structure, a graphitic structure, a C₃N₄ structure, a potassium poly(heptazine imide) (PHI) structure, triazine-based CN (TGCN) structure, polytrmazine imide (PTI) structure, heptazine-based CN (HPCN) melem oligomers, C₃N₅ structure, an amorphous structure, a porous structure, a heteroatom-doped (one or more of O, S, B, S, P, Cl, Br, I) structure, a metal-doped (one or more of Ti, Ni, Co, Mn, Cu, Bi, Sb, Sn, Feₓ Zn, V, W, Mo, As, In, Ce, Y, Eu, La, Cr, Zr, Al, alkaline and alkaline-earth elements) structure, or any combination thereof.

In some examples, the polymeric CN is CN incorporated with salts.

In some examples, the polymeric CN comprises triazine rings (C₃N₃), heptazine units (C₆N₇) or any combination thereof.

In some examples, the polymeric CN is triazine-based polymeric CN (TGCN). It should be noted that TGCN is characterized by being highly crystalline.

In some other examples, the polymeric CN is heptazine-based polymeric CN (HPCN).

In some examples, the polymeric CN is characterized by a melon structure. The term melon structure refers to a structure consisting of repeating units of nitrogen-rich heterocyclic rings (i.e. heptazine units) linked by nitrogen atoms.

In some examples, the polymeric CN is characterized by having a graphitic CN (g-C₃N₄) structure. The term g-C₃N₄ structure refers to a structure having layered material where carbon and nitrogen atoms form planar sheets similar to graphite, which are composed of heptazine or triazine units that are stacked through weak van der Waals interactions, leading to a graphitic-like structure.

In some examples, the polymeric CN is characterized by having an amorphous structure. The term amorphous structure refers to a structure consisting of randomly distributed carbon and nitrogen atoms, forming a disordered network. In other words, amorphous structure lacks long-range order found in crystalline forms.

In some examples, the polymeric CN is characterized by having a porous structure. The term porous structure refers to a structure having pores (at times introduced during the synthesis process) which may be mesoporous (2-50 nm) or microporous (<2 nm) size range. It should be notes that the porous structure may increase the specific surface area.

In some examples, the catalytic material is a modified CN.

In some examples, the modified CN is doped CN.

The term doped CN refers to CN in which heteroatoms or metal atoms are introduced into the polymeric CN framework.

In some examples, the modified CN is doped with one or more heteroatoms. In some examples, the heteroatom is one or more of sulfur (S), phosphorus (P), boron (B), oxygen (O), or halides (Cl, Br, I). In some examples, the modified CN is doped with one or more metals. In some examples, the metal is Ti, Ni, Co, Mn, Cu, Bi, Sb, Sn, Feₓ Zn, V, W, Mo, As, In, Ce, Y, Eu, La, Cr, Zr, Al, alkaline and alkaline-earth elements.

In some examples, the modified CN is a CN with one or more of the following functional groups: NO₂, NH₂, CN, COOH, OCH₃, CO, CONH₂, C₆H₆.

In some examples, the carbon-based material is one or more of graphene, graphene oxide, reduced graphene oxide, graphite.

In some examples, the carbon-based material is one or more of carbon or inorganic nanotubes.

In some examples, the carbon-based material is a carbon dot.

In some examples, the carbon-based material is a nitrogen-doped carbon.

In some examples, the catalytic material is a metal and/or metal-containing material.

In some examples, the metal and/or metal-containing material is one or more of a metal halide perovskite, an oxide perovskite, a metal sulfide, a metal nitride, a metal oxynitride, a metal selenide, a metal telluride, a metal phosphide, a metal boride, metal hydroxide, metal dichalcogenide, a pure metal, a partially oxidized metal or a metal alloy, an inorganic metal oxide, a double metal hydroxide, a metal oxyhydroxide, or any combination thereof.

In some examples, the catalytic material is an inorganic metal oxide, metal sulfide, metal selenide, metal telluride, metal nitride, metal boride, metal phosphide, metal hydroxide, metal oxyhydroxide, metal double hydroxide, metal dichalcogenide, metal oxynitride, or a combination thereof with multiple metallic elements or multiple non-metallic elements in a single material.

In some examples, the metal-containing material is a metal halide perovskite.

In some examples, the metal-containing material is an oxide perovskite.

In some examples, the metal-containing material is a metal sulfide. In some examples, the metal sulfide is MoSₓ, CdS, ZnS, SuS, PbS, EuS, NiS, CuₓS, In₂S₃, Bi₂S₃, Sb₂S₃, CoₓS_{y}, FeₓS_{y}, AgS, WSₓ, VSₓ, TaSₓ, WSₓ, TiSₓ, ZrSₓ, TaSₓ or a combination thereof.

In some examples, the metal-containing material is a metal nitride. In some examples, the metal nitride is TiN, MouN, VN, WₓN, NbN, GaN, CrN.

In some examples, the metal-containing material is a metal oxynitride. In some examples, the metal oxynitride is TaOₓN_{y}, LaTaON₂, SrₓNb_{y}OₚN_{q}, CaₓTa_{y}OₚNₓ, TiₓO_{y}N_{z}

In some examples, the metal-containing material is a metal selenide.

In some examples, the metal-containing material is a metal telluride.

In some examples, the metal-containing material is a metal phosphide.

In some examples, the metal-containing material is a metal boride.

In some examples, the metal-containing material is a metal carbide.

In some examples, the metal-containing material is a pure metal. In some examples, the metal is one or more of Au, Pt, Ni, Co, Mn, Mo, Zn, Sn, In, Bi, Pd, Cu, Ru, Rh or any combination thereof.

In some examples, the metal-containing material is a partially oxidized metal or a metal alloy. In some examples, the partially oxidized metal or a metal alloy is one or more of M, MO, MOOH, M₁ₓM_{2y}OₚH_{q}, where M₁ and M₂ are two different metal elements.

In some examples, the metal-containing material is a metal oxide.

In some examples, the metal-containing material is a metal hydroxide.

In some examples, the metal-containing material is a metal oxyhydroxide.

In some examples, the metal oxide is at least one of bismuth oxide (Bi₂O₃), zinc oxide (ZnO), tungsten trioxide (WOs), titanium dioxide (TiO₂), cadmium oxide (CdO), cadmium zinc oxide (CdZnO), bismuth vanadate (BiVO₄), coper bismuth vanadate (CuBiVO₄), barium titanate (BaTiO₃), cerium oxide (CeO₂), iridium oxide (IrO₂), ruthenium oxide (RuO₂), iron oxides (FeₓO_{y}), zinc iron oxides (ZnFe₂O₄₋ₓ), tantalum oxide (TaOₓ), tantalum oxynitride (TaOₓN_{y}), indium oxide (In₂O₃), tin oxide (SnO₂), fluorine-doped tin oxide (FTO), aluminum-doped zinc oxide (AZO), tin-doped indium oxide (ITO) or any combinations thereof.

In some examples, the catalytic material is WOs. In some examples, the catalytic material is Bi₂O₃. In some examples, the catalytic material is ZnO. In some examples, the catalytic material is TiO₂.

In some examples, the catalytic material is a covalent organic framework material (COFs).

In some examples, the catalytic material is a metal-organic framework material (MOFs).

In some examples, the catalytic material is a polyoxometalate material (POMs).

In some examples, the catalytic material is a nanoparticle. In some examples, the nanoparticle is a light active nanoparticle.

In some examples, the catalytic material is one or more of polymeric CN, a modified CN, CN incorporated with a salt, a metal halide perovskite, an oxide perovskite, a metal sulfide, a metal nitride, a metal oxynitride, a metal selenide, a metal telluride, a metal phosphide, a metal boride, a metal oxynitride, a metal carbide, a SiC, a covalent organic framework, a metal organic framework, a polyoxometalate, a carbon or inorganic nanotube, a graphene, a carbon dot, a graphene oxide, a reduced graphene oxide, a graphite, a nitrogen-doped carbon, a light active nanoparticle, a pure metal, a partially oxidized metal or metal alloy, a metal oxide, a metal double hydroxide, a metal hydroxide, a metal oxyhydroxide, or any combination thereof.

In some examples, the catalytic material may comprise one or more catalytic materials in a single material. In some examples, the single material may be an alloy and/or a multielement semiconductor.

In some examples, the catalytic material may comprise one or more catalytic materials in a hybrid nanostructure. In some examples, the hybrid nanostructure comprises two domains with partial or full contact. In some examples, the hybrid nanostructure has a core-shell, Janus, decorated, yolk-shell, match-stick or any combination thereof.

As described herein the panel comprises a substrate material.

The substrate material as used herein refers to a surface on which a catalytic material is deposited (attached/associated), embedded, or supported.

The substrate may provide mechanical support, ensuring the catalytic material maintains its structure and stability during reactions and in addition, it may have an active role in facilitating the catalytic process by influencing heat distribution, electronic or ionic conductivity, adsorption of reactants or intermediates, stabilization of molecules, or surface interactions.

The present disclosure is not limited to a specific substrate material. The substrate material in accordance with some examples, serves as a layer that supports the catalytic activity and which may also contribute to the overall performance and durability of the catalytic panel.

The substrates material may be made from various materials, depending on the specific application and the operating conditions, such as temperature, pressure, or chemical environment.

In some examples, the substrate material is or comprises at least one of glass, metal, metal oxide, doped-metal oxide ceramics, a polymer or any combination thereof.

In some examples, the substrate material is or comprises a glass material.

In some examples, the substrate material is or comprises a doped glass material.

In some examples, the substrate material is a conductive substrate.

In some examples, the substrate is fluorine-doped tin oxide coated glass substrate (FTO).

In some examples, the substrate material is or comprises a metal material.

In some examples, the substrate material is or comprises a metal-oxide over a metal material.

In some examples, the metal material is or comprises one or more of aluminum, zinc, copper, nickel, cobalt, silver, chromium, zirconium, iron cobalt nickel alloy, titanium, molybdenum, copper molybdenum alloy, copper tungsten, tungsten, gold, platinum, iridium, aluminum, or stainless steel.

In some examples, the substrate material is or comprises a ceramic material. In some examples, the ceramic material comprises silicon carbide, tantalum oxynitride, tungsten carbide, alumina, silicon nitride, zirconia, sapphire, aluminium oxide, aluminium nitride, aluminium titanate, ferrite, yttria, mullite, forsterite, porcelain, cordierite., silica, alumosilicate, nickel boride, magnesia or a combination thereof.

In some examples, the substrate material is or comprises a polymer.

In some examples, the polymer is or comprises a thermoplastic polymer.

A thermoplastic polymer, as used herein, refers to a class of materials, some of them are polymers, that become soft and malleable when heated to a certain temperature and harden upon cooling.

In some examples, the thermoplastic polymer is or comprises at least one of polyethylene (PE), polypropylene (PP), Polystyrene (PS), Polyvinyl Chloride (PVC), Polyethylene Terephthalate (PET), Polyethylene Terephthalate Glycol (PETG), Poly (methyl methacrylate) (PMMA), Acrylonitrile Butadiene Styrene (ABS), polyvinyl alcohol (PVA), polylactic acid (PLA), polycarbonate (PC), poly ether ester ketone (PEEK), polyetherimide (ULTEM), polyether sulfone (PES), thermoplastic elastomers (TPE), or any combination thereof.

In some examples, the thermoplastic polymer is or comprises PE.

In some examples, the thermoplastic polymer is or comprises high-density polyethylene (IHDPE), medium-density polyethylene (MDPE), low-density polyethylene (LDPE) or a combination thereof.

In some examples, the thermoplastic polymer is or comprises HDPE.

Regardless of the catalytic material and the substrate, the association/deposition/attachment of at least one catalytic material on the substrate or within the substrate may be homogeneous, heterogeneous, layered, patterned, gradient, porous, or multiphase. It should be noted that the association may depend on the functional requirements of the catalytic panel.

In accordance with some aspects, the present disclosure provides a panel comprising a glass and a polymeric CN.

In some examples, the panel comprising glass and polymeric CN is characterized by comprising melon-type CN or a combination of melon-type and graphitic C₃N₄. As shown in Example 1A, the crystallinity of the polymeric CN material may be characterized by XRD peaks, including a peak at about 27.4° 2θ.

In accordance with some aspects, the present disclosure provides a panel comprising a metal and a polymeric CN. In accordance with some aspects, the present disclosure provides a panel comprising a metal and a modified polymeric CN.

In accordance with some aspects, the present disclosure provides a panel comprising aluminum and a polymeric CN. In accordance with some aspects, the present disclosure provides a panel comprising aluminum and a modified polymeric CN.

In accordance with some aspects, the present disclosure provides a panel comprising a glass and a modified polymeric CN.

In accordance with some aspects, the present disclosure provides a panel comprising a glass and a metal oxide.

In some examples, the panel comprising glass and WO₃.

In accordance with some aspects, the present disclosure provides a panel comprising at least one catalytic material and at least one polymer.

As discussed herein and shown in Example 8, in panels comprising a polymer material as a support (for example HDPE), the catalytic material (for example CN) is at least partially embedded within the polymer material.

As further shown in Example 8, the present disclosure may be applicable to a variety of catalytic materials.

In some examples, the panel comprises polymeric CN and at least one polymer.

In some examples, the panel comprises polymeric CN and at least one recyclable polymer.

As used herein, a “recyclable polymer” refers to a polymer capable of being reprocessed and reused, optionally a thermoplastic polymer.

In some examples, the panel comprises a metal oxide and at least one polymer.

In some examples, the panel comprises Bi₂O₃ and at least one polymer.

In some examples, the panel comprises WO₃ and at least one polymer.

In some examples, the panel comprises TiO₂ and at least one polymer.

In some examples, the panel comprises ZnO and at least one polymer.

The polymer may be any polymer that in some examples is a thermoplastic polymer as described herein. In some examples, the polymer is a recyclable polymer. In some examples, the polymer comprises recycled polymer material. In some examples, the polymer comprises recycled HDPE. In some examples, the polymer comprises post-consumer HDPE waste.

In some examples, the panel comprises polymeric CN and HDPE.

In some examples, the panel comprises polymeric CN and recyclable HDPE.

In some examples, the panel comprises a metal oxide and HDPE.

In some examples, the panel comprises Bi₂O₃ and HDPE.

In some examples, the panel comprises WO₃ and HDPE.

In some examples, the panel comprises TiO₂ and HDPE.

In some examples, the panel comprises ZnO and HDPE.

The catalytic panels described herein can be employed in a variety of photocatalytic, photo-electrocatalytic, and electrocatalytic reactions.

Hence, in accordance with some aspects, the panel is for use in photocatalytic reactions, photo-electrocatalytic reactions, or electrocatalytic reactions, wherein the panel comprising at least one catalytic material and at least one substrate, wherein the catalytic material is directly associated to the substrate As shown in the Examples below, the panel was characterized by being stable during the catalytic reactions.

In accordance with some aspects, the panel is for use in at least one of (i)hydrogen peroxide (H₂O₂) production, (ii) oxidizing at least one organic compound, (iii) activating a C—H bond of an organic compound, (iv) water purification, (v) hydrogen H₂(g) production, wherein the panel comprising at least one catalytic material and at least one substrate, wherein the catalytic material is directly associated to the substrate.

As shown in Example 3 and Example 9, the panel described herein was successfully used in hydrogen peroxide (H₂O₂) production.

As shown in Example 3, the panels were stable during H₂O₂ generation as demonstrated by UV—vis and FTIR spectra as well as by the fact that the panels did not decompose at least during 2 h of operation suggesting the stability of the panels during operation and hydrogen peroxide production. As also shown in this example, hydrogen peroxide was produced in the presence of oxygen but not in the presence of argon.

As shown in Example 9, the panels showed long-term stability under operational conditions for continuous-three-week operation.

As shown in Example 10, panels comprising carbon nitride (CN) and HDPE (including HDPE derived from waste) further demonstrated long-term stability under operational conditions for photocatalytic hydrogen evolution reaction (HER). In some examples, the panels maintained stable hydrogen evolution over extended periods, including periods of several weeks.

In some examples, average areal hydrogen evolution rates of about 4.67 mmol h⁻¹ m⁻² were maintained over approximately 21 weeks, and rates of about 5.83 mmol h⁻¹ m⁻² were maintained over at least about 6 weeks.

In accordance with some aspects, the present disclosure provides a panel for use in a method of production of hydrogen peroxide (H₂O₂), wherein the panel comprises at least one catalytic material and at least one substrate, and wherein the catalytic material is directly associated to the substrate.

The present disclosure is also directed to a method for hydrogen peroxide production. The method comprises exposing a panel to a light source, wherein the panel comprises at least one catalytic material and at least one substrate, and wherein the catalytic material is directly associated to the substrate, to thereby produce hydrogen peroxide.

The panel for use and the method in connection with hydrogen peroxide production may include at least one catalytic material and at least one substrate as described herein above. In other words, any combination of catalytic material and substate as described herein may be applicable.

In accordance with some examples in which the panel is for use in a method of hydrogen peroxide production, the at least one catalytic material may be polymeric CN.

In accordance with some examples, the polymeric CN is characterized by a melon structure.

In accordance with some examples in which the panel is for use in a method of hydrogen peroxide production, the at least one catalytic material may be modified polymeric CN.

In accordance with some examples in which the panel is for hydrogen peroxide production, the substrate may be glass.

In accordance with some examples in which the panel is for hydrogen peroxide production, at least one catalytic material may be polymeric CN, and the substrate may be glass.

In accordance with some examples in which the panel is for hydrogen peroxide production, at least one catalytic material may be modified polymeric CN, and the substrate may be glass.

In accordance with some examples in which the panel is for hydrogen peroxide production, at least one catalytic material may be CN, and the substrate may metal oxide or doped-metal oxide over glass.

In accordance with some examples in which the panel is for hydrogen peroxide production, the substrate may be at least one polymer.

In accordance with some examples in which the panel is for hydrogen peroxide production, at least one catalytic material may be CN (polymeric or modified), and the substrate may be at least one polymer. In accordance with some examples in which the panel is for hydrogen peroxide production, at least one catalytic material may be CN, and the substrate is HDPE.

In accordance with some aspects, the present disclosure provides a panel for use in a method of producing hydrogen peroxide, wherein the panel comprises at least one catalytic material and at least one substrate, wherein at least one substrate is at least one polymer and wherein the catalytic material is at least partially embedded within the polymer.

The present disclosure is also directed to a method for producing hydrogen peroxide. The method comprises exposing a panel to a light source, wherein the panel comprises at least one catalytic material and at least one substrate, wherein the at least one substrate is at least one polymer and wherein the catalytic material is at least partially embedded within the polymer, to thereby produce hydrogen peroxide.

In some examples, the substrate polymer is a thermoplastic polymer, optionally comprising recycled polymer material or post-consumer waste-derived polymer material (for example, recycled HDPE). In some examples, the panel is configured for use in sequential photocatalytic reactions under oxygen reduction reaction (ORR) conditions, and the panel may be reused in multiple consecutive reaction cycles (for example, a plurality of cycles of at least about 24 hours each), optionally with washing (for example, water washing) between cycles, without replacement of the catalytic material. In some examples, the catalytic panel facilitates reduction of molecular oxygen to hydrogen peroxide while a hydroxyl-group containing compound undergoes oxidation, wherein the hydroxyl-group containing compound functions as a hole scavenger, thereby supporting sustained photocatalytic activity. In some examples, the same catalytic panel is used sequentially with different hydroxyl-group containing compounds in consecutive reaction cycles, and the panel maintains activity over extended cumulative operation times, including cumulative durations exceeding about 100 hours, exceeding about 250 hours, or exceeding about 500 hours. In some examples, the catalytic panel exhibits substantially no degradation and/or substantially no leaching of the catalytic material during such sequential operation.

In accordance with some examples, the method of producing hydrogen peroxide comprises exposing the panel to a light source.

In some examples, the method of producing hydrogen peroxide comprises exposing the panel to a light source in the presence of oxygen.

In some examples, the method of producing hydrogen peroxide comprises contacting the panel with oxygen.

In some examples, the method of producing hydrogen peroxide comprises exposing the panel to a light source in the presence of water.

In some examples, the method of producing hydrogen peroxide comprises exposing the panel to a light source in the presence of at least one hydroxyl-group containing compound.

In some examples, the method of producing hydrogen peroxide comprises contacting the panel with oxygen, water and at least one hydroxyl-group containing compound.

In some examples, the method of producing hydrogen peroxide comprises exposing the panel to a light source and contacting the panel with oxygen, water and at least one hydroxyl-group containing compound.

In some examples, the method of producing hydrogen peroxide comprises exposing the panel to a light source in the presence of oxygen, water and at least one hydroxyl-group containing compound.

A hydroxyl-group containing compound as used herein refers to a chemical substance that includes one or more hydroxyl groups (—OH) in its structure.

In some examples, the hydroxyl-group containing compound may be at least one of an alcohol, a phenol, a carbohydrate, a carboxylic acid or a combination thereof.

In some examples, the hydroxyl-group containing compound may be at least one of an alcohol, a phenol, a carboxylic acid or a combination thereof.

In some examples, the hydroxyl-group containing compound may be at least one of methanol, ethanol, glycerol, phenol, glucose or any combination thereof.

In some examples, the hydroxyl-group containing compound may be ethanol.

In some examples, the hydroxyl-group containing compound may be glucose.

Without being bound by theory, it was suggested that the mechanism by which panel described herein produces H₂O₂ is as shown in FIG. 24. Accordingly, it was suggested that in panel in which the catalytic material is polymeric CN, upon absorption of two photons by CN, holes are created that predominantly reside at N₂ and N₆ atoms, while the corresponding electrons are found on C₁ and N₄ atoms. The holes oxidize ethanol, which results in the hydrogenation of N2 and N6. Subsequently, an electron from C1 or N4 reduces molecular oxygen (O₂) to form a superoxo radical. Immediately, this superoxo radical is further reduced by another electron to form a 1,4-endoperoxide species on the triazine ring of CN. Finally, the successive protonation of the formed 1,4-endoperoxide species yields H₂O₂ to complete the catalytic cycle.

As shown in Example 4, the panel described herein was successfully used in oxidizing organic compounds such as biomass-derived products. Specifically, as shown in Example 4, the panel described herein was successfully used in oxidizing 5-hydroxymethyfurfural (HMF).

In accordance with some aspects, the present disclosure provides a panel for use in a method of oxidizing at least one organic compound, wherein the panel comprises at least one catalytic material and at least one substrate, and wherein the catalytic material is directly associated to the substrate.

The present disclosure is also directed to a method for oxidizing an organic compound. The method comprises exposing a panel to a light source, wherein the panel comprises at least one catalytic material and at least one substrate, and wherein the catalytic material is directly associated to the substrate, to thereby oxidizing at least one organic compound.

The panel for use and the method in connection with oxidizing an organic compound may include at least one catalytic material and at least one substrate as described herein above. In other words, any combination of catalytic material and substate as described herein may be applicable.

The present disclosure is not limited to a specific organic compound and is applicable for a variety of organic compounds. As appreciated, biorefineries or biomass are considered as candidates to replace ever-growing demand for crude oil and to substitute chemical molecules deriving from petroleum based refineries.

In accordance with some aspects, the present disclosure provides a panel for use in a method of oxidizing at least one biomass-derived product, wherein the panel comprises at least one catalytic material and at least one substrate, and wherein the catalytic material is directly associated to the substrate.

The present disclosure is also directed to a method for oxidizing biomass-derived product. The method comprises exposing a panel to a light source, wherein the panel comprises at least one catalytic material and at least one substrate, and wherein the catalytic material is directly associated to the substrate, to thereby oxidizing at least one biomass-derived product.

In some examples, the organic compound is a biomass-derived compound.

In some examples, the organic compound is a hydroxyl-containing compound.

Biomass consists predominantly biopolymers such as cellulose, hemi-cellulose, and lignocelluloses and these polymers can be depolymerized into C₆ monosaccharides such as fructose, glucose and polysaccharides such as starch and cellulose.

In some examples, the biomass-derived compound is derived from cellulose, hemi-cellulose, and lignocelluloses.

As appreciated, the ability of the panel described herein to oxidize organic compounds, including biomass-derived compounds is important for several key reasons, particularly in the fields of sustainable energy, chemical production, and environmental impact reduction.

In some examples, the biomass product compound is derived from cellulose.

In some examples, the biomass product compound is derived from at least one sugar.

In some examples, the biomass product compound is derived from glucose or fructose.

In some examples, the biomass product compound is 5-hydroxymethylfurfural (HM F).

In accordance with some examples in which the panel is for use in a method of oxidizing HMF, the at least one catalytic material may be polymeric CN. In accordance with some examples, the polymeric CN is characterized by a melon structure. In accordance with some examples in which the panel is for oxidizing HMF, the substrate may be glass. In accordance with some examples in which the panel is for hydrogen peroxide production, at least one catalytic material may be polymeric CN, and the substrate may be glass.

In some examples, HMF is oxidized to 2,5-Furandicarboxylic Acid (FDCA).

In some examples, HMF is oxidized to 5-Hydroxymethyl-2-furancarboxylic Acid (HMFA).

In accordance with some examples, the method of oxidizing HMF comprises exposing the panel to a light source.

In some examples, the method of oxidizing HMF comprises exposing the panel to a light source in the presence of oxygen.

In some examples, the method of oxidizing HMF comprises contacting the panel with oxygen.

In some examples, the method of oxidizing HMF comprises contacting the panel with oxygen and water.

In some examples, the method of oxidizing HMF comprises exposing the panel to a light source and contacting the panel with oxygen and water.

In some examples, the method of oxidizing HMF comprises exposing the panel to a light source in the presence of oxygen and water.

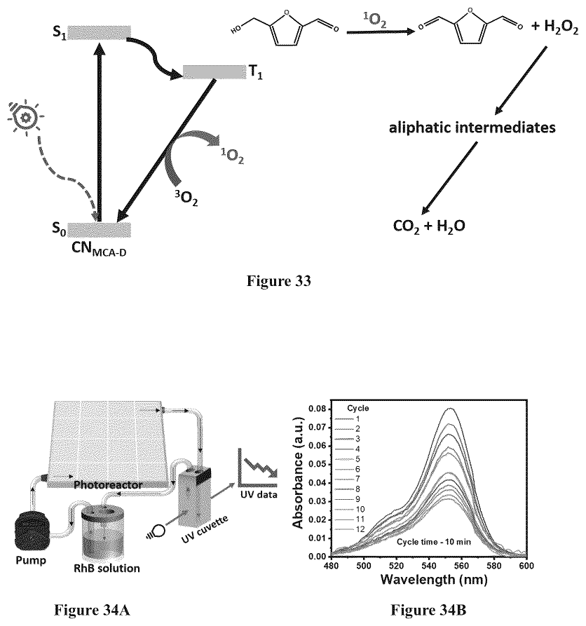

Without being bound by theory, it was suggested that the mechanism by which panel described herein oxidizes HMF is as shown in FIG. 33. Accordingly, it was suggested that in panel in which the catalytic material is polymeric CN, upon illumination, the electrons in the CN are excited to a singlet state and form singlet excitons, which quickly converts to triplet excitons by an intersystem crossing process. Then, triplet excitons react with O₂ to produce ¹O₂. The ¹O₂ then oxidizes HMF to DFF along with H₂O₂ generation. The generated H₂O₂ further oxidizes the DFF to various aliphatic intermediates before complete mineralization.

In some examples, the catalytic panel is for use in activating a C—H bond of an organic compound. The term activating a C—H bond in an organic compound as used herein refers to a process in which a typically inert carbon-hydrogen (C—H) bond is transformed into a more reactive site, enabling subsequent chemical reactions. This activation allows the carbon atom to become reactive.

The present disclosure is not limited to a specific organic compound and is applicable toa variety of organic compounds (carbohydrates).

It should also be noted that the organic compound may not include a hydroxyl group.

In some examples, the organic compound is one or more of cyclohexane, toluene, xylene, CH₄ or any combination thereof.

In some examples, the activation of a CH bond is as a result of bond oxidation.

In some examples, the CH bond is activated directly by photogenerated holes of the photocatalyst.

In some examples, the CH bond is activated by the generated H₂O₂ in an ORR reaction.

In some examples, the activation of a CH bond is as a result of bond oxidation. In some examples, the CH bond is activated (i) directly by photogenerated holes of the photocatalyst (ii) by the generated H₂O₂ in the ORR reaction or (iii) a combination thereof.

As shown in Example 5, the panel described herein was successfully used in degrading water contaminants and hence is considered suitable for water purification.

In accordance with some aspects, the present disclosure provides a panel for use in a method of water purification, wherein the panel comprises at least one catalytic material and at least one substrate, and wherein the catalytic material is directly associated to the substrate.

The present disclosure is also directed to a method for water purification. The method comprises exposing a panel to a light source, wherein the panel comprises at least one catalytic material and at least one substrate, and wherein the catalytic material is directly associated to the substrate, to thereby allow water purification.

The panel for use and the method in connection with water purification may include at least one catalytic material and at least one substrate as described herein above.

In other words, any combination of catalytic material and substate as described herein may be applicable.

The term water purification refers to reducing (degrading) water contamination.

In some examples, the panel is for use in a method of degrading water contamination.

The present disclosure is not limited to a specific contaminant and may be applicable to various contaminants.

In some examples, the water contaminant is an organic contaminant.

In some examples, the water contaminant is 9-(2-carboxyphenyl)-6-(diethylamino)-N,N-diethyl-3H-xanthen-3-iminium chloride, (rhodamine B, RhB).

In accordance with some examples in which the panel is for use in a method of water purification, the at least one catalytic material may be polymeric CN.

In accordance with some examples, the polymeric CN is characterized by a melon structure.

In accordance with some examples in which the panel is for use in a method of water purification, the at least one catalytic material may be a modified CN.

In accordance with some examples in which the panel is for water purification, the substrate may be glass.

In accordance with some examples in which the panel is for water purification, the at least one catalytic material may be polymeric CN and the substrate may be glass.

In accordance with some examples, the method of water purification comprises exposing the panel to a light source.

In some examples, the method of water purification comprises exposing the panel to a light source in the presence of oxygen.

In some examples, the method of water purification comprises contacting the panel with oxygen.

In some examples, the method of water purification comprises contacting the panel with oxygen and water.

In some examples, the method of water purification comprises exposing the panel to a light source and contacting the panel with oxygen and water.

In some examples, the method of water purification comprises exposing the panel to a light source in the presence of oxygen and water.

As shown in Example 6 and Example 10 and Example 11, the panel described herein was successfully used in hydrogen H₂(g) production.

As shown in Example 6 and Example 10, for H₂(g) production from water, a cocatalyst such as pt was applied on the binder-free panels.

In addition, as shown in Example 6, SEM image of the panel after the HER experiment, confirmed that the panel was stable.

In accordance with some aspects, the present disclosure provides a panel for use in a method of producing hydrogen (H₂), (hydrogen evolution reaction (HER)) wherein the panel comprises at least one catalytic material and at least one substrate, and wherein the catalytic material is directly associated to the substrate.

The present disclosure is also directed to a method for producing hydrogen. The method comprises exposing a panel to a light source, wherein the panel comprises at least one catalytic material and at least one substrate, and wherein the catalytic material is directly associated to the substrate, to thereby produce hydrogen.

The panel for use and the method in connection with producing hydrogen may include at least one catalytic material and at least one substrate as described herein above.

In other words, any combination of catalytic material and substate as described herein may be applicable.

In some examples, in which the catalytic panel is for use in a method of hydrogen evolution reaction (HER), i.e. hydrogen production, and the method comprises addition of a cocatalyst for the HER, the HER catalysis may be associated with the panel. In some examples, the cocatalyst may be deposited on the panel. In some examples, the cocatalyst may be deposited on the panel, wherein the panel is polymeric CN or a modified CN or a composite film containing the CN or the modified CN. In some examples, the cocatalyst is deposited on the catalytic material.

It should be noted that in such aspects and/or examples, the use or method are not limited to a specific HER cocatalyst. In some examples, the catalyst may be at least one metal, for example Pt, Au, Ni, Co, Cu, Ru, Ag, Pd, and their alloys, and combinations on the nanoscale as core-shell and decoration, phase-segregated particles, and their oxides.

In accordance with some examples in which the panel is for use in a method of producing hydrogen, the at least one catalytic material may be polymeric CN.

In accordance with some examples, the polymeric CN is characterized by a melon structure.

In accordance with some examples in which the panel is for use in a method of producing hydrogen, the at least one catalytic material may be modified CN.

In accordance with some examples in which the panel is for producing hydrogen, the substrate may be glass.

In accordance with some examples in which the panel is for hydrogen production, the at least one catalytic material may be polymeric CN and the substrate may be glass.

In accordance with some examples in which the panel is for hydrogen production, the substrate may be at least one polymer.

In accordance with some examples in which the panel is for hydrogen production, the at least one catalytic material may be CN and the substrate may be at least one polymer. In accordance with some examples in which the panel is for hydrogen production, the at least one catalytic material may be polymeric CN and the substrate is thermoplastic polymer.

In accordance with some aspects, the present disclosure provides a panel for use in a method of producing hydrogen (H₂), wherein the panel comprises at least one catalytic material and at least one substrate, wherein the at least one substrate is at least one polymer and wherein the catalytic material is at least partially embedded within the polymer.

In some examples, the catalytic panel comprising polymeric carbon nitride and a polymeric substrate, such as HDPE, is capable of sustained photocatalytic hydrogen evolution reaction (HER) over extended operational periods.

In some examples, the catalytic panel may maintain HER activity for prolonged durations, including period extending for several weeks and, in some cases, for several months.

In some examples, the panel retains a substantially constant hydrogen evolution rate during operation over at least one week, at least two weeks, at least one month, or longer.

These results further demonstrate the suitability of the disclosed catalytic panels for prolonged and optionally continuous hydrogen production processes.

The present disclosure is also directed to a method for producing hydrogen. The method comprises exposing a panel to a light source, wherein the panel comprises at least one catalytic material and at least one substrate, wherein the at least one substrate is at least one polymer and wherein the catalytic material is at least partially embedded within the polymer, to thereby produce hydrogen.

In accordance with some examples, the method of producing hydrogen comprises exposing the panel to a light source.

As shown in Example 12, panels were used for electrochemical (EC) and photoelectrochemical (PEC). Specifically, as shown in Example 12, panels in which the substrate was a transparent conductive oxide, such as, fluorine-doped tin oxide coated glass substrate (FTO) were used for electrochemical (EC) and photoelectrochemical (PEC) methanol oxidation to formaldehyde. In this example, the panel served as an electrode for MeOH electrochemical oxidation to HCHO.

In accordance with some aspects, the present disclosure provides a panel for use as an electrode, wherein the panel comprises at least one catalytic material and at least one substrate, wherein the substrate is a conductive substrate and wherein the catalytic material is directly associated to the substrate.

In some examples, the conductive substrate is at least one of fluorine-doped tin oxide coated glass substrate (FTO), transparent conductive oxide (TCO), Indium Tin Oxide (ITO), Aluminum-doped Zinc Oxide (AZD), Gallium-doped Zinc Oxide (GZO), Antimony-doped Tin Oxide (ATO), Antimony-doped Indium Oxide (AIO) or any combination thereof.

An exemplary set up is shown in FIG. 70A in which the panel serves as an anode.

As shown in Example 12, the electrode was used for methanol (MeOH) electrochemical oxidation to formaldehyde (HCHO).

As described herein in Example 7, the present disclosure relates to a novel oxygen reduction reaction (ORR)-active photocatalyst, that is even hydrogen evolution reaction (HER)-inactive. Specifically, as shown herein, a powder was shown to produce hydrogen peroxide (H₂O₂) coupled with the selective oxidation of a hydroxyl-containing compound (e.g., methanol (MeOH). The powder allowed spontaneous reaction of H₂O₂ with HCHO to produce hydrogen (H₂) and formic acid (HCOOH), eliminating the need for separation units, thereby improving sustainability and industrial scalability. The powder is suitable in allowing these reactions independently of the specific catalyst used, whether it is CN or WOs, demonstrating broad applicability across different catalytic systems.

In accordance with some aspects, it is provided a composite material for use in a method of producing hydrogen, the composite material comprising at least one catalytic material.

In accordance with some aspects, it is provided a particulate matter for use in a method of producing hydrogen, the particulate matter comprising at least one catalytic material.

In some examples, the particulate matter is in the form of particles, pellets, granules, powder or any other form of solid discrete elements. In some examples, the particulate matter is in the form of a powder.

These solid elements may be homogenous or non-homogenous is shape and dimension. In some embodiments, the elements are in the size range of microns to few millimeters.

In accordance with some aspects, it is provided a powder comprising at least one catalytic material for use in a method of producing hydrogen.

In accordance with some aspects, it is provided a powder comprising at least one catalytic material for use in a method of reducing oxygen to hydrogen peroxide. In some aspects, it is provided a powder comprising at least one catalytic material for use in a method of oxidizing a compound containing a hydroxy group to an aldehyde or a carboxylic acid.

In some examples, the catalytic material is characterized by having a Valence Band Maximum (VBM) and the Conduction Band Minimum (CBM) that allows the oxidization of a compound containing a hydroxy group to the respective aldehyde or carboxylic acid and in parallel the reduction of oxygen to hydrogen peroxide.

In some examples, the catalytic material is characterized by having a VBM that is sufficiently positive to allow oxidization of a compound containing a hydroxy group to the respective aldehyde or carboxylic acid and a CBM is sufficiently negative to allow reduction of oxygen to hydrogen peroxide or facilitate hydrogen evolution from water by reduction of protons or water.

In some examples, the catalytic material is WO₃. In some examples, the catalytic material is polymeric CN. In some examples, the catalytic material is a modified CN.

In some examples, the catalytic material is not configured to reduce hydrogen from water that is the hydrogen evolution reaction.

It should be noted that the present disclosure encompasses uses of the powder as is and also encompasses uses of the powder in panels described herein.

As described in Example 2 below, the panel described herein may be incorporated into a photoreactor.

Hence, the present disclosure provides in accordance with some aspects, a photoreactor comprises at least one panel as described herein.

In accordance with some aspects, it is provided a photoreactor comprises a particulate matter as described herein.

It should be noted that in cases in which the photoreactor comprises two or more panels, the two or more panels may be the same or may be different.

The present disclosure is applicable for various types of photoreactor.

In some examples, the photoreactor is a continuous flow photoreactor.

In some examples, the photoreactor is a batch photoreactor.

These reactors may be used for scalable applications of the catalytic panels described herein, for example, in energy production, pollutant degradation, and chemical synthesis.

The present disclosure is also directed to processes of preparation of the panels described herein.

FIG. 1A, FIG. 1B and FIG. 56 show schematic representations of exemplary processes for the preparation of the panels described herein.

The process schematically represented in FIG. 1A is denoted as “sandwich process” and the process schematically represented in FIG. 1B is denoted as “blade assisted sandwich process”. As described herein, in cases in which the substrate is a polymer material, the process may be schematically represented in FIG. 56.

The present disclosure provides in accordance with some aspects, a process for preparing a panel. The process comprising applying conditions for polymerizing a CN precursor over a substrate.

In some examples, the process comprising prior to polymerizing, applying the CN precursor in a paste form or powder form onto a substrate.

In some examples, applying the CN precursor comprises spreading the CN precursor homogenously onto the substrate.

In some examples, applying the CN precursor comprises spreading the CN precursor as paste onto the substrate.

In some examples, applying the CN precursor comprises spreading the CN precursor as powder onto the substrate.

In some examples, spreading the CN precursor comprises (i) spreading the CN precursor as paste onto the substrate and (ii) spreading the CN precursor as powder onto the substrate.

In some examples, the process comprising prior to polymerizing and after applying the CN precursor in a paste form or powder form onto the substrate, applying a second substrate onto the CN precursor, to thereby form a sandwich structure.

In some examples, the CN precursor comprises one or more of melamine, cyanuric acid, or cyanuric acid and melamine complex: MCA.

In some examples, applying conditions for polymerizing the CN precursor comprises heating the CN precursor to allow polymerization. In some examples, heating the CN precursor is at a temperature of at least 150° C. and a maximum of 700° C.

In some examples, polymerizing the CN precursor provides polymeric CN.

In some examples, the substrate is glass.

The present disclosure provides in accordance with some aspects, a process for preparing a panel. The process comprising applying conditions for integrating a catalytic material in a substrate, wherein the substrate is in a molten state.

The molten state of the substrate as used herein refers to the condition in which the substrate material has been preheated to a temperature sufficient to melt it into a liquid form.

It should be noted that in this state, the substrate is able to flow and allow for the catalytic material to be integrated or embedded. Upon cooling, the substrate solidifies, securing the catalytic material within its structure.

In some examples, the substrate is a polymer.

In some examples, the substrate is a thermoplastic polymer.

In some examples, the substrate is HDPE.

In some examples, the catalytic material is polymeric CN, modified CN or a metal oxide.

In some examples, the metal oxide is at least one of Bi₂O₃, ZnO, WO₃, TiO₂, or any combination thereof.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. As used herein the term “about” refers to 10%.

It should be noted that various embodiments of this invention may be presented in a range format. The description of a range should be considered to have specifically disclosed all the possible sub ranges as well as individual numerical values within that range inclusive the end points values. For example, description of a range such as from 1 to 6 or between 1 and 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6.

It should be noted that the term “at least one” refers to one or more of the following and encompasses any one of 1, 2, 3, or more of the specified information.

It is to be understood that the terminology used herein is used for the purpose of describing particular embodiments only and not intended to be limiting since the scope of the present invention will be limited only by the appended claims and equivalents thereof.

Throughout this specification and the Examples and claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

It must be noted that, as used in this specification and the appended claims, the singular forms “a”, “an” and “the” include plural referents unless the content clearly dictates otherwise.

The following examples are representative of techniques employed by the inventors in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

It should be noted that the various embodiments and examples detailed herein in connection with various aspects of the invention may be applicable to one or more aspects disclosed herein. It should be further noted that any embodiment described herein, for example, related to the panel, may be applied separately or in various combinations. Various embodiments and aspects of the present invention as delineated hereinabove and as claimed in the claims section below find experimental support in the following examples. Various embodiments and examples of the invention can be combined (from the same or from different aspects) without departing from the scope of the invention.

### Some Non-Limiting Examples

### Methods

1. Characterization methods.

a. Powder X-ray diffraction (XRD). Powder X-ray diffraction patterns (XRD) of CN and WO₃ recorded using a PANalytical's Empyrean diffractometer, which is equipped with a position-sensitive detector X'Celerator (scan time of ~15 min, 20 ranging from 5° to 70° using Cu Kα radiation, λ=1.54178 Å, 40 kV, 30 mA).

b. X-ray photoelectron spectroscopy (XPS). X-ray photoelectron spectroscopy (XPS) data was recorded using an X-ray photoelectron spectrometer ESCALAB-Xi+ ultrahigh vacuum (4×10⁻¹⁰ bar) apparatus with an Al Kα X-ray source and a monochromator. The X-ray beam size was 500 μm and the survey spectra were recorded with a pass energy of 150 eV. The individual high-resolution spectra were recorded with a pass energy of 20 eV. All spectra were calibrated relative to a carbon C is peak positioned at 284.8 eV to correct the charging effects.

The liquid products of MeOH oxidation were analyzed using an HPLC instrument (Agilent 1260) coupled to a diode array detector (DAD) and equipped with a Hiplex-H column. A 0.05 M H₂SO₄ solution was used as the mobile phase. The yield of HCOOH was quantified using calibration curves obtained from known concentrations of HCOOH samples (FIG. 53C and FIG. 72A).

The generated H₂(g) was collected from the headspace of the reactor using a gas-tight syringe and analyzed by gas chromatography (Agilent 7820 GC system equipped with a CPmolecular sieve SA and PoraPLOT Q columns coupled to a thermal conductivity detector, TCD).

The pH of the reaction mixture (including the catalyst) was recorded using a Lab Star PH 111 pH meter.

c. High-resolution scanning electron microscopy (HRSEM). The surface morphology of the CN and WO₃ was analyzed by scanning electron microscopy (SEM) using a FEI Verios 460 L high-resolution FEG-source microscope using a through-lens detector (TLD) operated at U₀=3.5 kV and I=25 pA. The samples were sputtered with ≤12 nm AuPd using a Quorum Q150T ES system to avoid charging effects during imaging.

d. Energy dispersive X-ray spectroscopy (EDS). Energy dispersive X-ray spectroscopy (EDS) measurements were performed on the same FEI Verios SEM, equipped with an Oxford instruments Xmax 80 mm² EDS detector (127 eV Si drift detector) on samples without sputtering at U₀=30 kV.

e. Fourier-transform Infrared (ATR-FTIR) spectroscopy. Fourier-transform infrared spectroscopy (FTIR) was performed to analyze the functional groups of CN and WO₃ using a Thermo Scientific Nicolet iS5 FTIR spectrometer (KBr window; diamond iD7 attenuated total reflectance (ATR) optical base; each measurement has 16 scans with 4 cm⁻¹ resolution in the 400-4000 cm⁻¹ range).

f. UV—vis spectroscopy and photoluminescence. UV—vis absorption spectroscopy in reflectance (R) mode-using a diffuse reflectance accessory (DRA)—was recorded on a Cary 100 spectrophotometer. Tauc plot analysis was conducted (using a Kubelka-Munk analysis of the reflectance spectra) to estimate the optical band gap, assuming a direct band gap for CN and WO₃. UV—vis in transmittance mode complemented film analysis over transparent substrates to calculate the absorbance. Absorbance (optical density) in quartz cuvettes with 1.0 cm optical path was used to measure the concentration of various chemical species in solutions. Photoluminescence (PL, Horiba Scientific FluoroMax 4 spectrofluorometer) and UV—vis absorption spectroscopies were employed to study the optical properties of CN panels.

The irradiance spectrum of the 100 W white LED (the visible range illumination source for photocatalysis, LZ-220V, LCFocus, China, driven using a constant 3 A current), incident was recorded using a StellarNet Black-Comet-C-SR-50 spectrometer measuring the irradiance through an F600-UVVIS-SR 600 μm single-strand fiber-optic cable ending with a CR2 cosine receptor and a 2.7% aperture, all calibrated for irradiance using aNIST traceable lamp (StellarNet Incₓ, USA).

The detector was placed at the lateral position of the reaction tube inside a water jacket (the difference being that the inner part of the reaction vessel was not filled with water, only the jacket).

The incident energy flux of the white LED illumination source on the reaction tube was calculated by integrating the obtained irradiance spectra from 300 to 800 nm of three separate measurements yielding (7.9±0.9)×10³ W m⁻² (irradiance onset ~400 nm).

g. White LED measurements. The spectrum of the 100 W white LED illumination source (Bridgelux BXRA-50C5300; in the visible range) was recorded using StellarNet Black-Comet-C-SR-50 spectrometer measuring the irradiance through an F600-UVVIS-SR 600 μm single-strand fiber-optic cable ending with a CR2 cosine receptor and a 2.7% aperture; all calibrated for irradiance using a NIST traceable lamp (StellarNet Incₓ, USA).

The incident energy flux of the white LED illumination source was calculated by integrating the obtained irradiance spectra from 280 to 1000 nm to be ~2680 W m⁻². h. Calculation of valence band energies. The valence band energies (E_{CB}) of the CN panels were calculated by subtracting the width of HeI-UPS spectra from the excitation energy (Eₙ=21.21 eV). The conduction band energy (E_{CB}) is therefore calculated from E_{VB}−E_{g} (where E_{g} is optical bandgap energy, calculated using the Tauc plot analysis assuming a direct E_{g}). The obtained E_{CB} and E_{CB} values were converted to electrochemical energy potential using standard reference scale (normal hydrogen electrode (NHE) at pH=0), where 0 V vs. NHE=4.44 eV vs. E_{vac}.

I. High Performance Liquid Chromatography (HPLC). The liquid products of HMF oxidation were analyzed using an HPLC instrument (Agilent 1260) coupled to a diode array detector (DAD) and equipped with a C-18 column. 50:50% v/v of DI water:MeCN solution was used as the mobile phase. The liquid products of MeOH oxidation were analyzed using an HPLC instrument (Agilent 1260) coupled to a diode array detector (DAD) and equipped with a Hiplex-H column. A 0.05 M H₂SO₄ solution was used as the mobile phase.

J. Gas Chromatography (GC). The generated H₂(g) from the headspace of the reactor was collected using a gas-tight syringe and analyzed by gas chromatography (Agilent 7820 GC system).

Nitrogen sorption measurements and specific surface area calculations using the Brunauer-Emmet-Teller (BET) model from the adsorption isotherm were performed on a Quantachrome NOVAtouch NT LX3 system at 77 K.Material

All chemicals were obtained from the indicated commercial vendors and used as received without further purification.

Melamine (M, 99%), cyanuric acid (CA, 99%), 5-hydroxymethylfurfural (HMF, 99% h), 9-(2-carboxyphenyl)-6-(diethylamino)-N,N-diethyl-3H-xanthen-3-iminium chloride, abbreviated as Rhodamine B (RhB, ≥95%), 8% wt. chloroplatinic acid (H₂PtCl₆) solution, dicyandiamide (DCDA, 99%), barbituric acid (B, 99%), and sodium azide (NaN₃, ≥99.5%) were purchased from Sigma-Aldrich. Ethylene glycol (EG, ≥99.5%) was purchased from Merck. Ethanol (EtOH, 99.9%, absolute) and acetone (AR grade) were purchased from Bio-Lab, Israel. Hydrogen peroxide (H₂O₂, 30% wt.) was purchased from JT Baker. Potassium iodide (KI, ≥99%) and acetonitrile (MeCN, HPLC grade 99.99%) were purchased from Fisher Chemicals. Potassium hydrogen phthalate (HPLC grade) and salicylic acid (SA, 99%) were purchased from Thermo Scientific. 2,5-Diformylfuran (DFF, 98%), 1,5-dihydroxynaphthalene (DHN, 98%), and ammonium paratungstate (99%) were purchased from Angene Chemical, UK. 2,5-Furandicarboxylic acid (FDCA, 99%) was purchased from Combi-Blocks, USA. High purity oxygen (99.99%) and argon (99.999%) gases were purchased from Maxima Ltd., Israel. 1,4-benzoquinone (p-BQ, >98%) was purchased from TCI.

Deionized (DI) water for all aqueous solution preparations was collected after treatment through a Millipore Direct-Q 3 water purification system (resistivity of 18 MCI cm at room temperature).

Fluorine-doped tin oxide (FTO)-coated glass (12-14Ω sq⁻¹) was purchased from Xop Glass company, Spain. The glass substrates were cleaned by subsequent sonications of 15 min in DI water, ethanol, and acetone.

Ammonium acetate (>99%) and formic acid (HCOOH, 98/100′%) were purchased from Fisher Chemicals. Potassium hydrogen phthalate (KHT, HPLC grade) was purchased from Thermo Scientific. Acetylacetone and acetic acid (99.7%, AR grade) were purchased from Lobachemie, India.

### Example 1: Preparation and Characterization of Panels Comprising Catalytic Materials

### Example 1A: Preparation and Characterization of Binder-Free Polymeric Carbon Nitride (CN) Photocatalytic Panels

### Materials and Methods

### Synthesis of Supramolecular Assemblies as CN Precursors

Finely-ground melamine (M) and cyanuric acid (CA) (1:1 mol ratio) were dissolved in 25 mL of DI water and shaken in a tube for 24 h using an automatic shaker at 300 rpm. The formed supramolecular precursor (MCA) was centrifuged at 6000 rpm (4430 rcf) for 10 min, washed with DI water three times, and finally vacuum-dried at 50° C. overnight. MCA(1:1.5) is the product of the same procedure with a 50% molar excess of CA (1:1.5 M:CA molar ratio).

The same procedure was followed for Mel-CA (1:1 mol ratio of melem (Mel) and CA) and MCAB(0.05) (1:1:0.05 mol ratio of M, CA, and barbituric acid (B)) supramolecular aggregates. The MCAB(0.1) supramolecular aggregate was prepared in EtOH as the solvent.

The melem powder (Mel) was prepared by placing 10 g of melamine in a ceramic crucible covered with a lid and calcined at 400° C. in air for 12 h.

### Synthesis of Binder-Free CN Panels

Binder-free CN panels were prepared by forming a glass/precursor/glass sandwich, where the CN precursor was either melamine (M) or melamine:cyanuric acid supramolecular aggregates in a 1:1 or 1:1.5 molar ratio (MCA and MCA(1:1.5), respectively. Briefly, 2 g of precursor powder was sandwiched between two 6.7×6.7 cm² clean glass substrates. The glass/precursor/glass sandwich was placed in a rectangular ceramic crucible covered with a lid. Subsequently, the crucible was placed in a tube furnace at 530° C. for 4 h under a constant N₂ flow, which resulted in the formation of melon-type CN thin films on the glass substrate. After removing the crucibles from the over, the two glass substrates are easily detached without application of force (with the exception of M panels, where gentle tapping is used to detach the two glass substrates). The weakly bound CN was removed either by compressed-air treatment (MCA precursors) or by sonication in water for 30 min (M precursor). The CN panels had a well-attached photocatalyst layer (both glass substrates) and were labeled as CNₓ, where X=M, MCA, or MCA(1:1.5). CN panels with a thicker photocatalyst coating were prepared by adapting the doctor-blade approach. Finely ground MCA powder (1 g) was dispersed in ethylene glycol (1.2 mL) and further ground using a mortar and pestle to form a paste. This MCA paste was doctor-bladed with a thickness of 2 scotch tapes on two glass sheets and dried at 85° C. for 20 min. Subsequently, these two precursor-coated glass sheets were used to sandwich 1 g of MCA powder and the whole assembly was calcined under conditions identical to those used for the CN_{MCA} preparation. The obtained CN panel was denoted as CN_{MCA-D}. For comparison, CN_{MCA}-n and CN_{MCA-D3}, were synthesized, where 1 and 3 represent glass sheets with doctor-bladed MCA paste with a thickness of 1 and 3 scotch tapes respectively (note: according to this naming scheme, CN_{MCA} is actually CN_{MCA-D2}, since it uses a thickness of 2 scotch layers during doctor-blading, but for ease of reading it is referred to simply as CN_{MCA}).

Synthesis of other binder-free CN panels: 2.0 g of dicyandiamide (D), Mel-CA, MCAB(0.05), or MCAB(0.1) powder precursors were sandwiched between two 6.7×6.7 cm² clean glass substrates followed by a calcination in a tube-furnace at 530° C. for 4 h under constant N₂ flow to yield CN_{D}, CN_{Mel-CA}, CN_{MCAB(0.05)}, or CN_{MCAB(0.1)} panels, respectively. The CN_{MCAB(0.05)-500} and CN_{MCAB(0.1)-500} panels were synthesized at 500° C. for 4 h under a constant N₂ flow. The precursor, MCA supramolecular aggregate or M, was sandwiched between two 6.7×6.7 cm² Al foils, followed by calcination at 530° C. for 4 h under constant N₂ flow to yield CN_{MCA-Al foil} and CN_{M-Al foil} panels, respectively.

### Results

The synthesis of binder-free melon-type CN panels, depicted in FIG. 1A, relies on the in situ thermal polymerization of precursors over a glass substrate. To achieve this, melamine (M) and cyanuric acid (CA) (1:1 mol ratio) MCA supramolecular aggregates are sandwiched between two glass substrates and then calcined to yield CN_{MCA}. To show the generality of this method to other precursors, pristine melamine was used as the precursor or MCA(1:1.5) supramolecular aggregates, in which the melamine-to-cyanuric acid ratio is non-stoichiometric; the resulting CN films over glass are denoted as CN_{M} and CN_{MCA(1:1.5)} panels, respectively.

A unique feature of the reported method is that it uses only about 23 mg precursor per square centimeter of the resulting CN panel, which is significantly less than the reported state-of-the-art CN thin films (Table 1).

TABLE 1
Summary of known synthetic procedures of various polymeric CN thin films on glass substrates.

| | Glass | | Final | | | |
|---|---|---|---|---|---|---|
| | substrate | Precursor | photocatalyst | | | |
| | area | loading | loading | Fabrication | | |
| Photocatalyst | (cm²) | (mg cm⁻²) | (mg cm⁻²) | technique | Used as | Application |
| CN_{MCA} | 44.89 | 22.3 | — | Glass/precursor/ | Binder-free | Continuous- |
| (this work) | | | | glass sandwich | CN panels in | flow |
| | | | | | continuous- | photoreactor |
| CN_{MCA-D} | | | 0.67 | Dr. blade + | flow | for H₂O₂ |
| (this work) | | | | glass/precursor/ | photoreactor | production, |
| | | | | glass sandwich | | HMF oxidation, |
| | | | | | | RhB degradation, |
| | | | | | | and HER |
| G*-C₃N₄ | 6.25 | 80 | — | Chemical Vapor | Free-standing | Ion transport |
| | | | | Deposition (CVD) | CN membrane | membrane |
| g-C₃N₄ | 17.5 | 2.9 | — | Glass on top of | Free-standing | Photocatalytic |
| | | | | crucible | CN film | RhB dye |
| | | | | | | degradation |
| g-C₃N₄ | 7.2 | 416 | — | Chemical Vapor | Free-standing | Autonomous |
| | | | | Deposition (CVD) | CN film | actuator |
| CNₓ\|Ni₂P | 25 | — | 1.92 | Drop casting the | CN panels | Photoreforming |
| | | | | catalyst slurry on | in flow | of plastic to |
| | | | | frosted glass | photoreactor | HER |

*graphitic

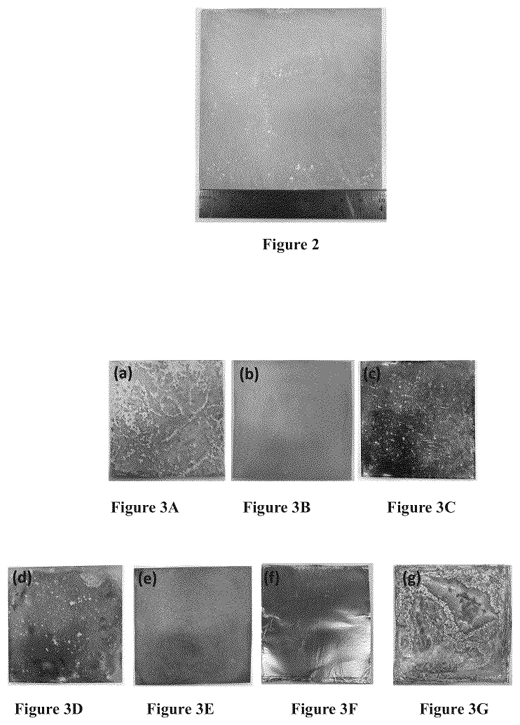

The scalability of this method is demonstrated here by preparing a 10×10 cm² CN_{MCA} panel (FIG. 2); in general, the panel size can be further increases, provided that a furnace of suitable dimensions is available.

The growth of various CN films was shown using different combinations of precursors on glass and aluminum foil, further establishing the generality of the method (FIG. 3A-3G). FIG. 3A-3E show CN films on glass substrate: CN_{D}, D refers to dicyanamide precursor; calcined at 530° C., FIG. 3B—CN_{Mel-CA} calcined at 530° C., Mel refers to melem, thus Mel-CA is the supramolecular aggregate formed between melem and cyanuric acid, and carbon-rich polymeric carbon nitride synthesized from a supramolecular assembly of melamine, cyanuric acid, and barbituric acid (B): FIG. 3C CN_{MCAN(0.05)} calcined at 530° C., FIG. 3D CN_{MCAB(0.05).500} (calcined at 500° C.), and FIG. 3E CN_{MCAB(0.1)} (calcined at 530° C.). The method was also shown on Aluminum foil as a substrate in FIGS. 3F-3G. FIG. 3F CN_{MCA}, and FIG. 3G CN_{M}.

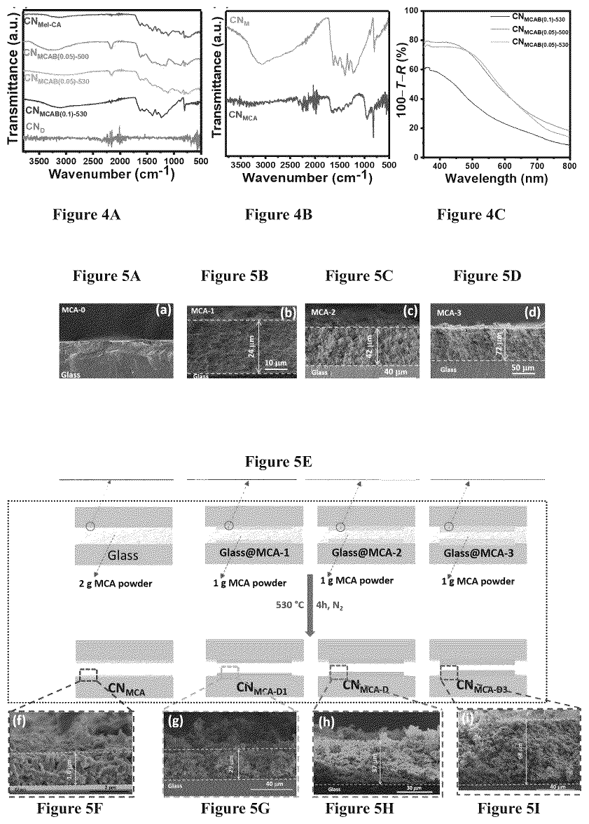

FTIR spectra (FIG. 4A) confirms formation of polymeric carbon nitride since it exhibits vibrations related to breathing modes of heptazine and triazine (804 cm⁻¹), in-plane stretching and bending vibrations of C—N heterocycles (1200-1650 cn⁻¹), and stretching modes of —NHₓ groups about 3200-3500 cm⁻¹. Furthermore, a cyano group vibration about 2180 cm⁻¹ demonstrates that CN_{MCAB} has surface cyano groups similar to CN_{MCA} (without barbituric acid in the precursor paste).

FIG. 4B is FTIR analysis of CN_{M} and CN_{MCA} on Al foil.

These results show that changing the substrate does not significantly alter the functional groups of the polymeric carbon nitride.

The wide band in CN_{M} around 2500-3400 cm⁻¹ stems from hydrogen bonds (e.g., —OH groups) on the surface of the Al foil with its native oxide; they are stronger in CN_{M} since the CN film is thinner.

Moreover, the incorporation of barbituric acid to the MCA precursor resulted in CN panels with extended visible light absorption (FIG. 4C), which further demonstrates the scope of the synthesis procedure for a variety of CN panels.

Taken together these results showed the versatility of the precursors as well as the substrate.

For the synthesis of thicker CN panels, the method mentioned above for CN_{MCA} film preparation is combined with the doctor-blade technique, as shown in FIG. 1B and FIG. 5.

This preparation method is schematically shown in FIG. 1B.

Briefly, the MCA supramolecular aggregates are dispersed in a hydrogen-bonding solvent, ethylene glycol, until a viscous paste is formed, which is then doctor-bladed on two glass substrates. After drying, MCA powder is sandwiched with these precursor-coated substrates, and the resulting assembly is calcined under similar conditions to yield CN_{MCA-D} panels.

The difference in thickness is shown in FIGS. 5A-5I. FIG. 5A shows a clean glass cross-sectional SEM image. FIG. 5B (MCA-1 stands for x=1, i.e., one layer coated on glass substrate using the scotch tape layers with a thickness ~24 μm), FIG. 5C (MCA-2 stands for x=2, i.e., two layers coated on glass substrate using the scotch tape layers with a thickness ~42 μm), FIG. 5D (MCA-3 stands for x=3, i.e., three layers coated on glass substrate using the scotch tape layers with a thickness ~72 μm). all three doctor-bladed samples were prepared in the presence of additional 1 g MCA powder in the ‘sandwich’. The number of doctor-blade layers is determined by the number of scotch-tapes serving as the barrier.

FIG. 5E is a schematic synthesis process of binder-free CN panels, where the grey lines represent the doctor-bladed precursor layer and after calcination the resulting CN is shown in thick orange line, the thin yellow line represents thin CN from the powder sublimation only.

The MCA powder was placed between two glass slides, which by itself results in CN film (thickness ca. 1.6 μm) over glass shown in FIG. 5F.

When x layers (x=1, 2, or 3) of doctor-bladed MCA powder were added (shown in FIG. 5E as gray lines at the glass interface), it results in films of precursor MCA-x.

These are shown in FIGS. 5F-5I after calcination of the corresponding polymeric carbon nitride films on glass (CN_{MCA-D1}, CN_{MCA-D}, and CN_{MCA-D3}).
are shown in FIG. 5G-5I (final thickness about 29, 37, and 68 μm).
and FIGS. 5F-5I cross-sectional SEM images of CN_{MCA}, CN_{MCA-D3} (final thickness about 29 μm), CN_{MCA-D2} (final thickness about 37 μm), and CN_{MCA-D3} (final thickness about 68 μm).

Augmenting the “sandwich” method with doctor-blading pastes of precursors allows the thickness of the coating to be controlled (FIGS. 5G-5I), which is particularly important when solar radiation harvesting is a critical bottleneck for photocatalytic and related applications.

Moreover, CN-based heterojunctions may be designed by layering pastes of different compositions and thicknesses over the glass (i.e., “sandwich” precursor and doctor-bladed paste combinations).

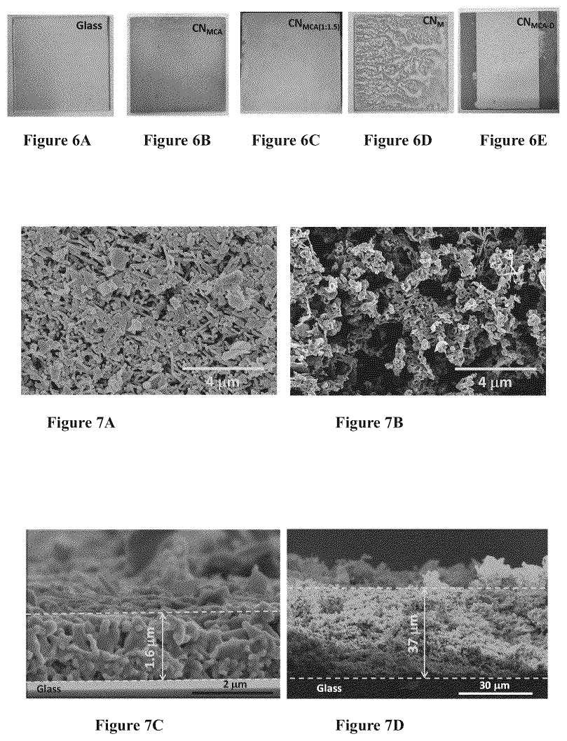

Digital images of the obtained 6.7×6.7 cm² binder-free CN panels prepared by the method described herein are shown in FIGS. 6A-6E.

FIG. 6A is an image of a clean glass. FIG. 6B-6D are images of CN panels prepared by “sandwich” method and MCA as a precursor with a molar ration of 1:1 and 1:1.5 between melamine and cyanuric acid (CN_{MCA} and CN_{MCA (1:1.5)}) and melamine as a precursor (CN_{M}), respectively.

FIG. 6E is a CN panel prepared by doctor-blade assisted “sandwich” method and MCA as a precursor with a molar ration of 1:1 between melamine and cyanuric acid (CN_{MCA-D}).

The sandwich method with MCA as the precursor yielded a transparent uniform CN_{MCA} film; adding the doctor-blade step resulted in a thicker and uniform CN_{MCA-D} film. By contrast, CN_{M}, from pristine melamine, was formed as a non-uniform film.

Moreover, this method can be extended to other photocatalyst materials such as TiO₂ and WO₃ as shown below. Furthermore, varying the doctor-bladed paste and sandwiching powder forms a variety of heterojunction- or homojunction-containing photocatalyst panels.

### Structural Characterization of CN Panels

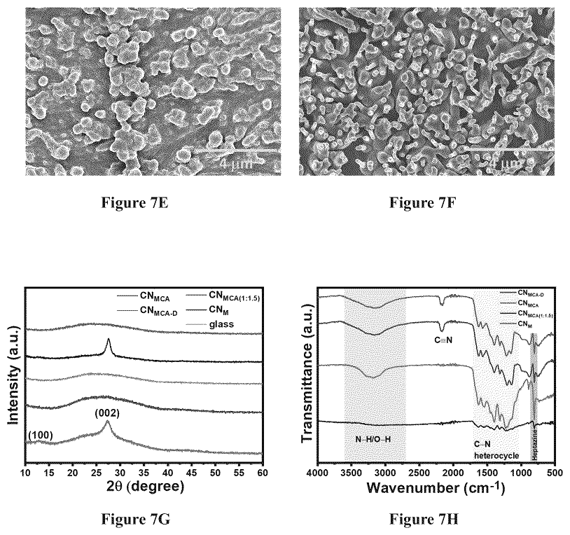

Scanning electron microscopy (SEM) reveals a regular and uniform rod morphology for CN_{MCA}, made from the simple MCA precursor sandwich (FIG. 7A). The interactions between the hydroxy and amine functional groups of MCA and the glass surface (mainly SiO₂) direct the CN growth in the case of the CN_{MCA} panel, and cross-sectional analysis reveals a dense layer of CN rods with an average thickness ca. 1.6 μm (FIG. 7C and FIG. 5F).

On the other hand, a regular porous CN morphology is observed for CN_{MCA-D} (FIG. 7B), and the corresponding cross-sectional analysis reveals a dense porous CN layer with an average thickness of 37 μm (FIG. 7D and FIG. 5H). SEM images of CN_{M} and CN_{MCA(1:1.5)} are provided in FIGS. 7E-7F.

Powder X-ray diffraction (XRD) of CN_{MCA-D} (FIG. 7G) shows the characteristic diffraction signals around 26=27.4° and 13°, which correspond to the interlayer stacking of melon-based CN layers (002 plane) and in-plane ordering of heptazine units (100 plane), respectively. The CN_{MCA} panels do not show noticeable diffraction signals, suggesting an amorphous nature.

Fourier-transform infrared spectroscopy (FTIR) confirms the formation of CN over the glass (FIG. 7H). CN_{MCA-D} and CN_{MCA} show three groups of peaks located at 804, 1200-1650, and 3200-3500 cm⁻¹, which correspond to breathing modes of heptazine and triazine, in-plane stretching and bending vibrations of C—N heterocycles, and stretching modes of —NH groups, respectively. Moreover, the CN_{MCA} panel exhibits an additional peak centered at 2180 cm⁻¹, which were ascribed to the stretching mode of C≡N groups. The appearance of C—N groups indicates the presence of incompletely condensed tri-s-triazine units in CN_{MCA}.

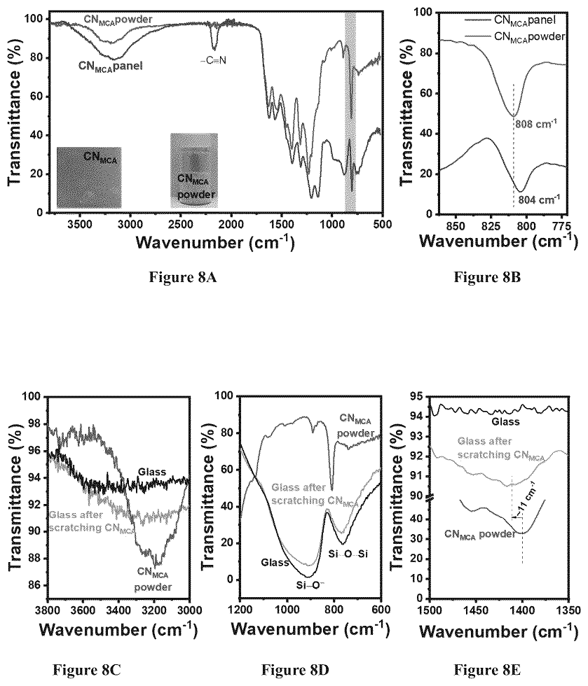

To investigate the influence of the glass substrate on the polymerization process and its interaction with the obtained CN, the FTIR spectra of the exposed glass substrate after scratching the CN_{MCA} layer and CN_{MCA} powder (synthesized under identical conditions without glass) were compared to a pristine CN_{MCA} panel (FIG. 8). From the additional FTIR features measured on the CN panel, it was suggested that the glass substrate influences the formation of CN (i.e., the Si—O⁻ and Si—O—Si bonds are responsible for the strong adherence of CN, FIG. 8).

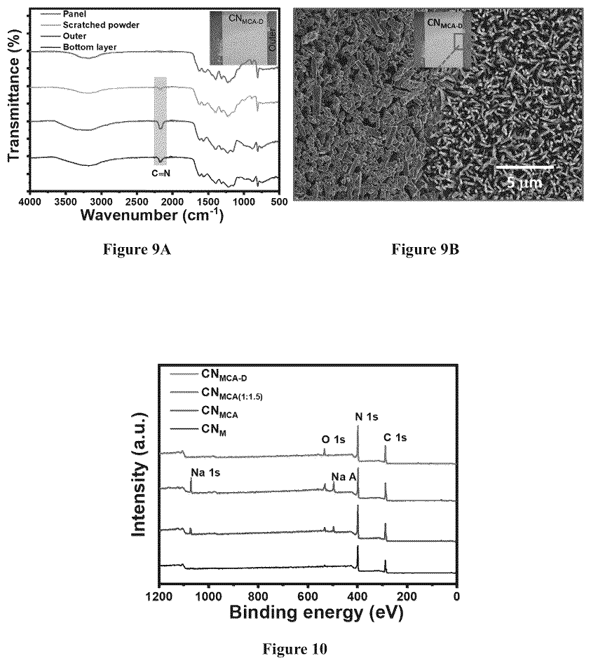

To explore the role of the doctor-blade step, the FTIR spectra of the scratched CN powder, the bottom layer, and the outer layer of the CN_{MCA-D} panel were analyzed, comparing them with the spectrum of the original CN_{MCA-D} panel (FIG. 9A).

Compared to a CN_{MCA-D} panel, the scratched CN_{MCA-D} powder, outer layer, and bottom layer (obtained by scratching the upper layer of the panel) all exhibit an additional cyano group vibration (shaded with gray in FIG. 9A). This C≡N group resembles the signal detected in a CN_{MCA} panel that did not undergo a doctor-blading procedure. Its presence indicates the formation of two distinct CN layers when an MCA supramolecular precursor is doctor-bladed on a glass substrate (FIG. 9A). The MCA precursor layers that are adjacent to the glass yield the ‘bottom layer’ of CN_{MCA-D}, which is similar to that of a CN_{MCA} panel (FIG. 9A brown and FIG. 8A blue).

On the other hand, the MCA precursor away from the surface of the glass substrate yields an ‘upper layer’ of CN_{MCA-D}, which is similar to CN_{MCA} powder (FIG. 9A pink and FIG. 8A red). The observed FTIR features confirm the formation of a homojunction composed of two different CN layers. The top-view SEM image of CN_{MCA-D} panel at the interface between the ‘upper layer’ and the ‘outer’ part, which was not doctor-bladed (FIG. 9B), shows the formation of regular CN rods on the non-doctor-bladed side (right), and regular porous CN on the doctor-bladed side (left). This analysis demonstrates the formation of a heterojunction composed of two different CN layers in the case of the CN_{MCA-D} panels and further supports the conclusions drawn from the FTIR analysis.

Compared to CN_{MCA} powder (synthesized under identical conditions without glass), an additional peak is found around 2180 cm⁻¹ in the CN panel, which is attributed to C≡N groups, and the intense stretching modes of —NH. groups also appear in a CN panel spectrum (FIG. 8A). It shows the influence of the glass substrate during the formation of CN. In addition, a red shift of the stretching of the CN conjugated system band from 808 cm⁻¹ to 804 cm⁻¹ occurs (FIG. 8B). This shift was attributed to increased CN conjugation in a CN panel compared to its powder counterpart. Moreover, the characteristic CN vibrations can still be observed even after scratching CN from the glass-along with the decrease in the intensity of the signals corresponding to Si—O—Si and Si—O⁻ groups (FIGS. 5C-8D), supporting the strong interaction between CN and the glass substrate. In addition, the peak at 1400 cm⁻¹ for the CN powder shifted to 1411 cm⁻¹, which further suggests the strong connection of CN with the surface of the glass substrate (FIG. 8E).

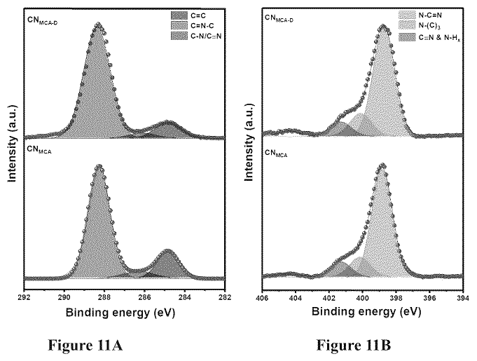

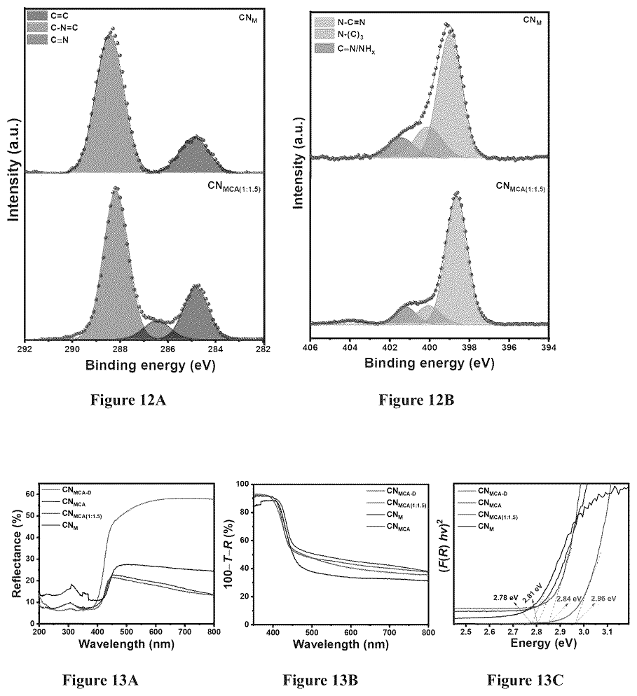

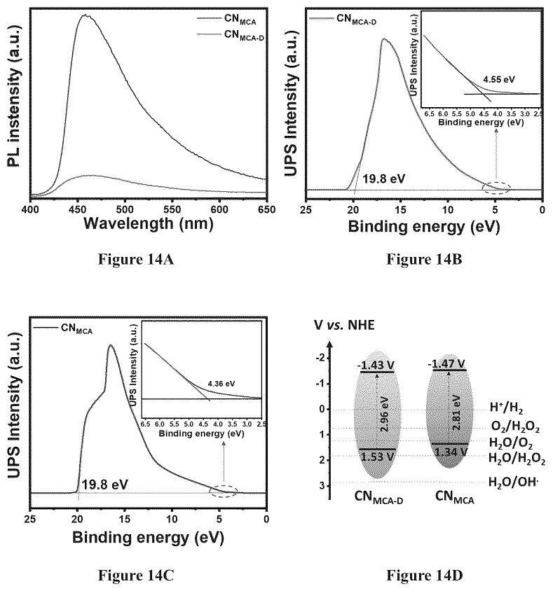

X-ray photoelectron spectroscopy (XPS) analysis of the panels shows the surface chemical composition of the CN films (FIGS. 10-12). The XPS survey spectra confirm the presence of C, N, and O (FIG. 10). The low-intensity O 1s signal is attributed to adsorbed surface impurities (H₂O and CO₂). The high-resolution C is spectra of both CN_{MCA} and CN_{MCA-D} are deconvoluted into three peaks (FIG. 11A): The peak around 288.4 eV is attributed to sp² hybridized carbon of CN heptazine rings (N—C≡N). The peak around 286.2 eV is attributed to C—NHₓ or C≡N species; the intensity of this peak is slightly higher for CN_{MCA} than for CN_{MCA-D}, which might result from the presence of —C≡N groups, as was also indicated by FTIR analysis (FIG. 9A pink). The peak at ca. 284.8 eV is attributed to graphitic carbons (C═C/C—C). The high-resolution N Is spectra of both CN_{MCA} and CN_{MCA-D} are also deconvoluted into three peaks (FIG. 11B). The peaks around 398.8 and 400.1 eV are ascribed to bi-coordinated and tri-coordinated nitrogens (namely, C—N═C and N—(C)₃), respectively, which are present in the heptazine rings. The peak around 401.3 eV is attributed to nitrogen atoms present in—C≡N or —NHₓ species. Overall, XPS analysis confirms the presence of heptazine units in both the CN_{MCA} and CN_{MCA-D} panels.

The C is XPS spectra of CN_{M} and CN_{MCA(1:1.5)} in FIG. 12A, show similar functional groups as CN_{MCA-D} and CN_{MCA} (FIG. 11A), confirming the successful synthesis of a polymeric carbon nitride. The most significant difference is no cyano group detected in CN_{M}, possibly due to absence of cyanuric acid precursor. The N Is XPS spectra of CN_{M} and CN_{MCA(1:1.5)} in FIG. 12B, show similar functional groups as CN_{MCA-D} and CN_{MCA} (FIG. 11B), except higher signal of N—(C)₃ in the CN_{M} case, since there are less nitrogen defects in the polymeric structure.

### Optical Properties of CN Panels

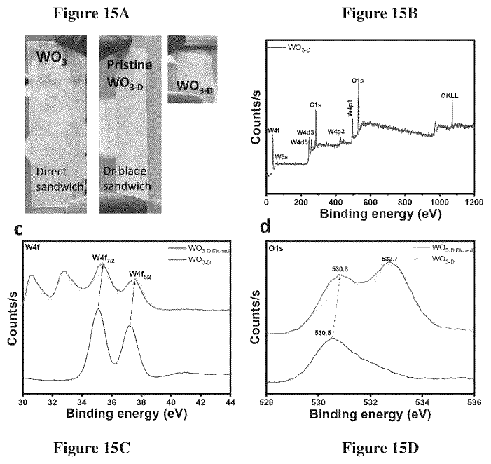

UV—vis optical absorption spectra of CN panels (FIG. 13) indicate significant absorbance into the visible region. However, the CN_{MCA} film exhibits increased optical activity, especially at wavelengths higher than 450 nm (FIG. 13B). This was ascribed to its rod-like morphology, which might result in multiple reflections of incident light (FIG. 13A). The optical bandgaps (E_{g}) of CN_{MCA} and CN_{MCA-D} are estimated to be 2.81 and 2.96 eV, respectively, using a Tauc plot analysis (FIG. 13C). Photoluminescence (PL) spectra (FIG. 14A) show that CN_{MCA-D} has a lower PL intensity than CN_{MCA}, which might indicate better charge separation.

The valence band (VB) positions of CN_{MCA} and CN_{MCA-D} (E_{VB}, FIGS. 14B-14C) are estimated to be 1.34 and 1.53 V, respectively. On the basis of the obtained E_{VB} and energy gap (E_{g}), the conduction band energy (E_{CB}) of CN_{MCA-D} and CN_{MCA} were calculated to be −1.43 and −1.47 V, respectively, as illustrated in the energy band diagram shown in FIG. 14D. The E_{CB} of CN_{MCA-D} and CN_{MCA} are more negative than the redox couples, allowing water reduction to H₂ and the two-electron oxygen reduction reaction (ORR) to H₂O₂. On the other hand, the E_{VB} of CN_{MCA-D} is more positive than that of CN_{MCA}, which, from a thermodynamic driving force perspective facilitates a four-electron oxidation of water to produce 02. However, for both materials, the E_{VB} position is not positive enough for two-electron water oxidation to H₂O₂ and water decomposition into OH•.

### Example 1B: Preparation and Characterization of Binder-Free Metal-Oxide Photocatalytic Panels

### Methods:

A sandwiched 2.0 g of ammonium paratungstate was placed between two glass slides and calcined in an air oven at 500° C. for 4 h. The doctor-bladed glass with ammonium paratungstate paste (2.0 g ammonium paratungstate dispersed in 0.60 mL ethylene glycol) coated as a layer with two scotch tapes, followed by drying at 85° C. for 10 min and calcination under air for 4 h 500° C.

### Results:

As can be seen in FIG. 15A, using the methods described above a thick panel was formed. Moreover, a strong sonication removes the weakly bound WO₃ and still shows a thick and well-attached WO₃ coating on glass (FIG. 15A).

The XPS scan spectra of WO_{3-D} obtained after 5 mins sonication of pristine WO₃-D shows peaks corresponds to only W and O, which proves the formation of WO₃ on glass substrate (FIG. 15B).

High-resolution W 4f and O 1s spectra (FIGS. 15C and 15D, respectively) were recorded on the surface and of etched WO₃ film To prove the strong interaction between formed WO₃ and glass surface.

The W 4f spectra and O 1 s spectra recorded after etching WO₃ surface shows an obvious peak shift compared to the spectra recorded on surface, which strongly proves the alteration of chemical environment of W and O near the glass surface, which might be due to the presence of W—O—Si bond. The linkage of W and O atoms with Si atoms of glass substrate probably induced the observed charge imbalance of W—O bond near the glass substrate.

Taken together the results how that the technique can be applied to various catalytic materials, including polymeric CN as well as metal oxides such as WO₃, TiO₂.

In addition, these results show that various substrates can be used including glass, aluminum fold.

### Example 2: Design of Continuous Flow Photoreactor

Photocatalytic activity of CN panels was tested in a continuous-flow photoreactor.

### Materials and Method

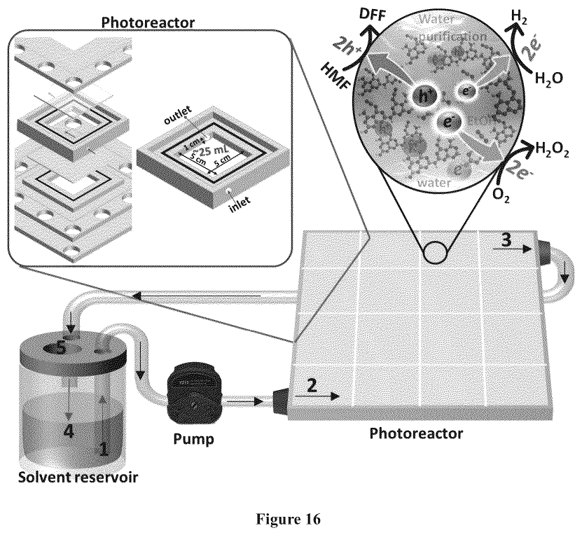

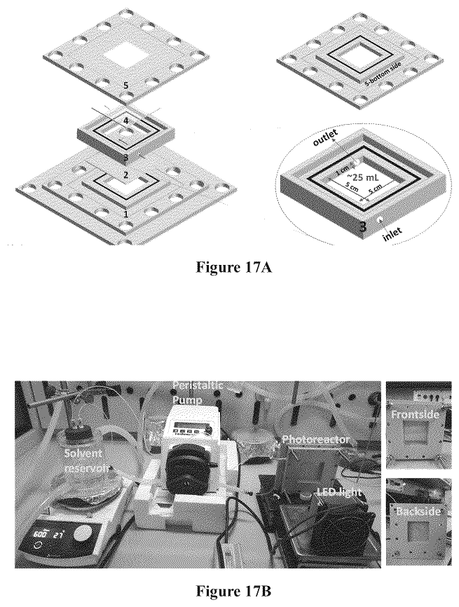

The photoreactor was manufactured at the Faculty of Natural Sciences' workshop at the Ben-Gurion University of the Negev, Beer-Sheva, Israel, according to the design shown in FIG. 16 from high-performance engineering plastic, PEEK (polyether ether ketone).

### Results

To demonstrate the advantage of the binder-free solar panels, their photocatalytic activity was studied in several representative reactions, namely continuous hydrogen and hydrogen peroxide formation, biomass oxidation to valuable chemicals, and water decontamination, as illustrated in FIG. 17, where a schematic of the flow photoreactor assembly illustrates the possible reactions of photogenerated charges.

The reactor consists of 5 different parts (FIG. 17A); 1) is bottom part, 2) CN-coated panel, 3) middle part (~25 mL), 4) quartz glass window, and 5) upper part. To assemble the complete photocatalytic setup in a flow mode, first the reactor (FIG. 16A) is closed using M6 stainless steel screws and bolts. Then, the assembled reactor is connected via a peristaltic pump to a solvent reservoir (over a heating plate as the temperature control). The illumination source is placed in front of the quartz window of the assembled photoreactor. All the described system is shown in FIG. 17B.

### Example 3: H₂O₂ Production Using CN Panels in a Continuous Flow Photoreactor

### Materials and Methods

Photocatalytic H₂O₂ Production.

The H₂O₂ production experiments were carried out in an 5×5 cm² continuous-flow photoreactor developed in-house under continuous flow of the reaction mixture (~1 mL min⁻¹) from a solvent reservoir containing 80 mL H₂O:EtOH mixture (20% vol. ethanol in purified water) using a peristaltic pump. Oxygen was continuously bubbled through the solution in the solvent reservoir. The temperature of the solvent reservoir was kept constant (25° C.) during the reaction using a circulating water jacket coupled to a chiller. The produced H₂O₂ was quantified by iodometry. The produced OH• was monitored by colorimetry using salicylic acid (SA) as a probe molecule: SA reacts with the OH• radical to produce 2,3-dihydroxybenzoic acid (2,3-DHBA), which gives a characteristic absorption at ca. 510 nm.

### Results

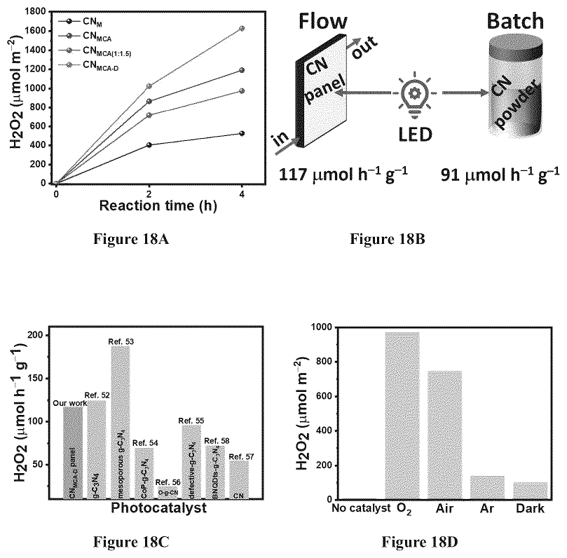

The photocatalytic production of H₂O₂ by the CN panel was conducted in a continuous-flow photoreactor from an aqueous solution (20% vol. ethanol) and oxygen (FIG. 18A and FIG. 17).

Over 2 h irradiation using a 100 W LED light (white light, λ>410 nm, FIG. 19), the CN_{MCA} panel produced 865 μmol m⁻² of H₂O₂, a higher rate than that of CN_{M} and CN_{MCA(1:1.5)} (FIG. 18A).

To increase the photocatalyst loading relative to CN_{MCA}, thicker CN panels (for example CN_{MCA-D} with a resulting CN thickness ~37 μm) were created using the doctor-blade approach. The greater thickness and increased amount of CN are associated with higher optical absorbance and higher loading of active sites per unit area, which lead to higher production of H₂O₂, up to 1023 μmol m⁻² in the case of CN_{MCA-D} where two layers of doctor-bladed MCA precursor were applied (FIG. 18A).

To compare the activities of the CN_{MCA-D} panel and of a heterogeneous photocatalyst counterpart, their production was measured normalized to employed CN mass. The measured mass of CN_{MCA-D} on a 5×5 cm² panel is about 16.8 mg, with a H₂O₂ production rate of 117 μmol h⁻¹ g⁻¹ (FIG. 18B left). A batch reaction under identical conditions using CN_{MCA-D} powder yields a H₂O₂ specific production rate of 91 μmol h-g⁻¹ (FIG. 18B right).

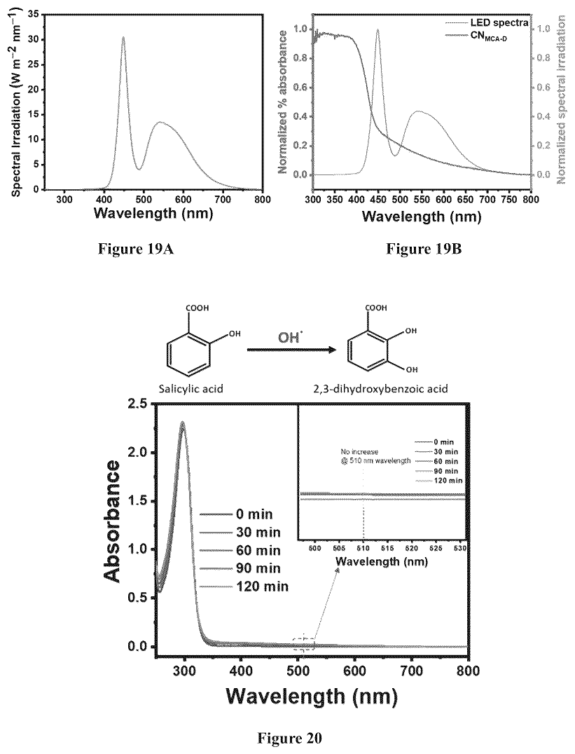

To investigate the influence of the CN panel and photocatalytic conditions on the generated H₂O₂, the production of OH• radicals was indirectly monitored, which would result from the decomposition of H₂O₂ by photogenerated electrons. These measurements confirm that the generated H₂O₂ does not decompose over CN panels during at least 2 h of continuous-flow operation (FIG. 20).

The H₂O₂ yield further increases to 1191 μmol m⁻² (15 mM m⁻²) and 1628 μmol m⁻² (242 μmol g⁻¹ or 20 mM m⁻²) after 4 h using CN_{MCA} and CN_{MCA-D}, respectively (FIG. 18A). Importantly, H₂O₂ is produced at industrially relevant concentrations for water purification (>1 mM H₂O₂).

The recent results of CN photocatalysts studied under nearly similar conditions to the current experimental conditions were summarized (FIG. 18C and Table 2). It was noted that a precise comparison of H₂O₂ activity of the current CN panels with state-of-the-art CN based photocatalysts is not trivial, as those studies were performed in a batch configuration and used different experimental conditions. As shown in FIG. 18C, the CN_{MCA-D} panel shows high activity compared to many reported CN photocatalysts. It should be noted that the CN panels remain stable after 4 h of operation under illumination (the generated H₂O₂ is being recirculated as part of the reaction media) at relatively high flow rates (~1 mL min⁻¹).

For simplicity, a CN_{MCA} panel was used for control experiments to evaluate the possible mechanism for H₂O₂ formation. All control measurements presented in FIG. 18D confirm the essential role of the CN panel as a photocatalyst for H₂O₂ production: no H₂O₂ is produced in the absence of the photocatalyst, maximal ORR when the system is saturated with the reacting 02(g). Changing pure 02(g) to air (ca. 20% O₂(g)), less H₂O₂ production was observed. Under Ar(g) purge, very little H₂O₂ is formed since it requires O₂ as the reactant. Unlike the first four described control experiments, when no illumination was done (dark), the photocatalyst could not produce photogenerated electrons and holes, thus almost no H₂O₂ was photocatalytically produced. FIG. 19A presents the spectral irradiance of the white LED light that was used for illumination. FIG. 19B shows the same irradiance in a normalized manner (right y-axis) and is compared to the normalized absorbance spectrum of the CN_{MCA-D} panel. The spectra demonstrate the room for improvement in light harvesting since significant part of the illuminated power is not harvested.

TABLE 2
Summary of known polymeric carbon nitride-based photocatalysts for H2O2
production.

| | | Catalyst mass | Specific H₂O₂ |
|---|---|---|---|
| | | concentration in the | production rate |
| Photocatalyst | Conditions | solvent (g L⁻¹) | (μmol h⁻¹ g⁻¹) |
| CN_{MCA-D} panel | 20% vol. EtOH, 80 mL | 0.21 | 117 |
| (this work) | | | |
| g-C₃N₄ | 90% vol. EtOH, 5 mL | 4 | 125 |
| Mesoporous-g- | 90% vol. EtOH, 5 mL | 4 | 188 |
| C₃N₄ | | | |
| CoP-g-C₃N₄ | 10% vol. EtOH, 20 mL | 1 | 70 |
| O-g-CN | 20% vol. EtOH, 10 mL | 0.5 | 25 |
| Defective-g- | 20% vol. propane-2-o1, | 0.83 | 96 |
| C₃N₄ | 60 mL | | |
| BNQDts-g-C₃N₄ | 10% vol. propane-2-ol, | 1 | 72.3 |
| | 50 mL | | |
| CN | 5% vol. EtOH, 20 mL | 1 | 55 |

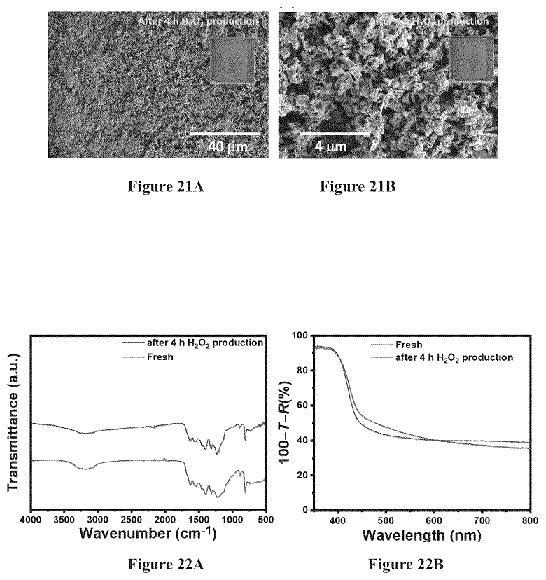

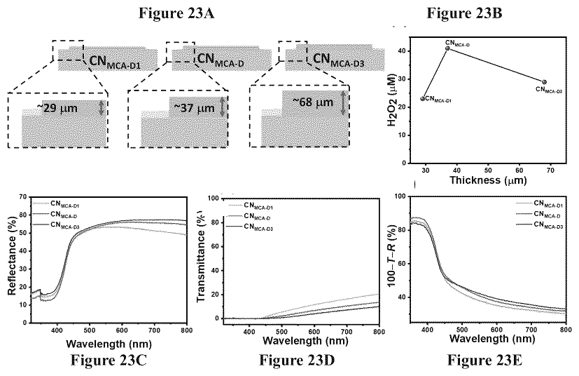

SEM images after 4 h confirm the physical stability of the CN_{MCA-D} panels, which is attributed to the strong interaction between the glass surface and the CN films obtained by the sandwich method (FIGS. 21-21). In addition, the UV—vis and FTIR spectra resemble those of fresh CN_{MCA-D}, further confirming the stability of the CN panels (FIGS. 22A-22B). In addition, to study the effect of CN film thickness on H₂O₂ production, the CN_{MCA-D1} (1 layer of MCA precursor) and CN_{MCA-D3} (3 layers of MCA precursor) panels (FIGS. 23A-23E) were tested relative to the CN_{MCA-D} prepared using 2 layers. CN_{MCA-D} (2 layers of MCA precursor) showed the highest H₂O₂ yield, i.e., the measured yield order is CN_{MCA-D1}<CN_{MCA-D3}<CN_{MCA-D} (FIG. 23B).

Based on our results, a possible mechanistic pathway was proposed for H₂O₂ formation over CN panels (represented by a heptazine subunit in the scheme) in FIG. 24. Upon absorption of two photons by CN_{MCA} (shown in a), holes are created that predominantly reside at N2 and N6 atoms, while the corresponding electrons are found on Cl and N4 atoms (shown in b). The holes oxidize ethanol, which results in the hydrogenation of N2 and N6 (shown in c). Subsequently, an electron from C1 or N4 reduces molecular oxygen (O₂) to form a superoxo radical (shown in d). Immediately, this superoxo radical is further reduced by another electron to form a 1,4-endoperoxide species on the triazine ring of CN_{MCA} (shown in e). Finally, the successive protonation of the formed 1,4-endoperoxide species yields H₂O₂ to complete the catalytic cycle (shown in a).

It has been shown that the aromatic endoperoxides generate singlet oxygen upon heating or photoexcitation. The generated singlet oxygen can be trapped by 1,5-dihydroxynaphthalene (1,5-DHN) to yield 5-hydroxynaphthalene-1,4-dione (juglone).

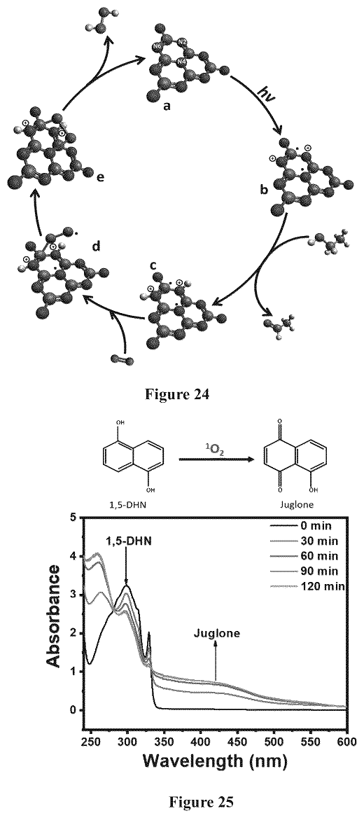

To prove the formation of 1,4-endoperoxide species, 1,5-DHN was added to the reaction mixture (FIG. 25) and monitored the formation of juglone at regular time intervals. As shown in FIG. 25, the juglone concentration increases with the reaction time, indicating the formation of singlet oxygen, thus indirectly confirming the formation of 1,4-endoperoxide species on triazine rings during a two-electron ORR.

While hydrogen peroxide (H₂O₂) is a promising low-cost, carbon-free liquid fuel, the conventional anthraquinone process (AOP) for H₂O₂ production raises environmental concerns as it involves high energy consumption and causes environmental pollution. In addition, the AOP requires external H₂ to regenerate the catalyst.

Therefore, the results shown herein above provide an eco-friendly reaction using the photocatalytic activity of the reported CN panels.

### Example 4: Photocatalytic HMF Oxidation Performance

### Materials and Method

### Photocatalytic HMF Oxidation

The experimental conditions and basic setup for 5-hydroxymethyfurfural (HMF) oxidation were similar to H₂O₂ experiments described above.

In this case, the solvent reservoir contained 80 mL of a 5.0 mM aqueous solution of HMF. To understand the role of reactive oxygen species (superoxide radical and singlet oxygen) on HMF photooxidation, controlled experiments were performed under batch conditions in a quartz reaction tube, where 5 mg of CN_{MCA-D} powder and 1 mM of HMF/DFF in 5 mL of water were taken and magnetically stirred under 100 W LED light irradiation (2680 W m⁻²).

### Results

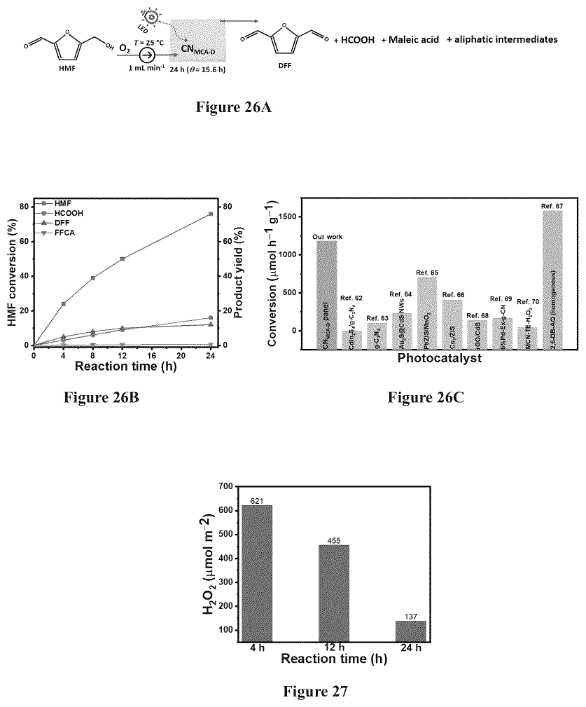

Photocatalytic HMF oxidation was conducted over a CN_{MCA-D} panel in pure water using a continuous-flow reactor (see reaction scheme in FIG. 26A). The reaction resulted in 75% HMF conversion with a 13% DFF yield after 24 h (estimated residence time θ=15.6 h) (FIG. 26B). The moderate DFF selectivity was attributed to the formation of H₂O₂ in parallel to HMF oxidation (FIG. 27). However, the H₂O₂ concentration constantly decreases with time, as it is consumed, presumably by reaction with DFF—leading to the cleavage of bonds and the formation of CO₂ or other aliphatic intermediates. The aliphatic intermediates formed during HMF photooxidation in water were monitored at regular intervals using high-pressure liquid chromatography (HPLC, FIGS. 28A-28B). The concentration of aliphatic intermediates increased with time (FIG. 28B), along with DFF yield (FIG. 28A). The HCOOH and MA were identified as one of the intermediates (FIG. 28B). To confirm the effect of generated H₂O₂ on DFF yield, a photocatalytic batch reaction was performed using CN_{MCA-D} powder as a control experiment, where aq. H₂O₂ was added to the reaction mixture containing DFF. After 4 h, the entire DFF was consumed, forming aliphatic intermediates, including MA and HCOOH (FIGS. 29A-29B).

Nevertheless, it was noted that the obtained DFF yield in this study is comparable to the DFF yield obtained by conventional batch systems where water is used as a green solvent (Table 3).

TABLE 3
Summary of known photocatalysts for HMF oxidation.

| | | HMF conversion | DFF production |
|---|---|---|---|
| Photocatalyst | Conditions | rate (μmol h⁻¹ g⁻¹) | rate (%) |
| CN_{MCA-D} panel | 0.5 mmol HMF, 80 mL | 1185 | 184 |
| (This work) | water, 16.75 mg catalyst, 24 | | |
| | h (θ = 15.6 min) | | |
| CdIn₂S₄/g-C₃N₄ | 0.0025 mmol HMF, 5 mL | 5.4 | 5 |
| | water, 50 mg catalyst, 6 h | | |
| g-C₃N₄ | 0.1 mmol HMF in 5 mL | 104 | 89 |
| | ACN-PF3, 50 mg catalyst, 6 | | |
| | h | | |
| Au₂S@CdS NWs | 0.01 M HMF, 1 mL ACN, | 238 | 238 |
| | 10 mg catalyst, 4 h | | |
| Pt/ZIS/MnO₂ | 0.2 mmol HMF, 10 mL | 710 | 607 |
| | water, 30 mg catalyst, 6 h | | |
| Co₁/ZIS | 5 mM HMF, 15 mL ACN, 15 | 411 | 380 |
| | mg catalyst, 12 h | | |
| 2,6-DB-AQ | 2.8 mg, 8 mM HMF, 5 mL | 1586 | 1364 |
| | DMSO, 8 h | | |
| rGO/CdS | 50 mg/20 mL aq., 200 mg | 141 | 138 |
| | catalyst, 10 h | | |
| Ex-g-C₃N₄/Pd 6% | 500 M HMF, 50 mL water, | 173 | 74 |
| | 20 mg catalyst, 5 h | | |
| MCN-TE-H₂O₂ | 0.5 mM HMF, 150 mL water, | 48.75 | 42.9 |
| | 100 mg catalyst, 4 h | | |

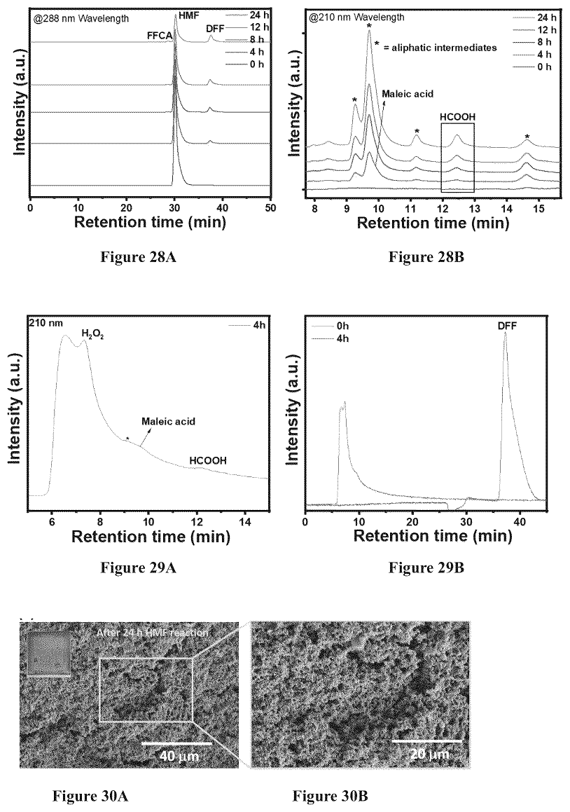

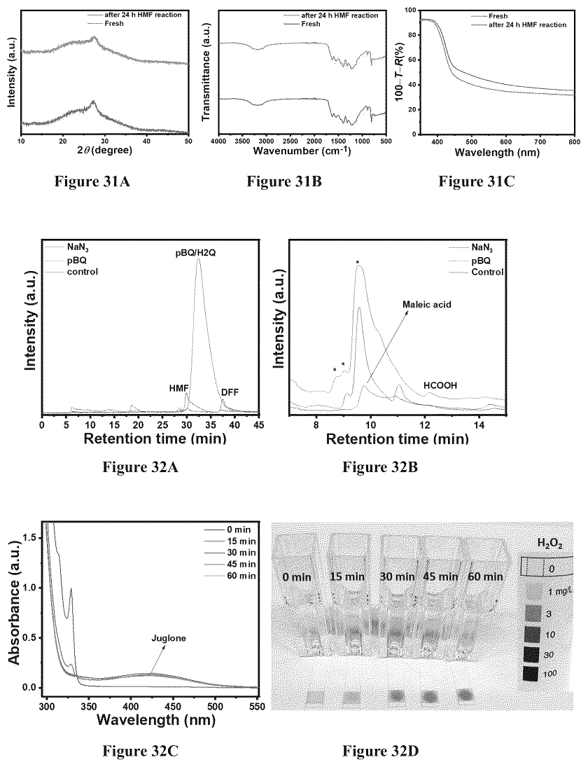

It should be noted that using CN panels in continuous-flow conditions, high HMF conversion rate (1185 μmnol h⁻¹ g⁻¹) was achieved, which is among the state-of-the-art heterogeneous photocatalysts (FIG. 26C and Table 3). Post-operational characterization studies emphasize the structural and chemical stability of the panel after a continuous operation for 24 h (FIGS. 30-31). This stability and the high HMF conversion in pure water motivate the adaptation of continuous-flow photochemistry to oxidation reactions of more challenging biomass substrates (e.g., lignin, cellulose, and glycerol).

Based on the previous reports on HMF photooxidation using carbon nitride-based photocatalysts in air/O₂ atmosphere and above disused H₂O₂ generation mechanism over CN panel, it is assumed that the singlet oxygen could be the ROS species responsible for photooxidation HMF. To elucidate the mechanism, the role of ¹O₂ (singlet oxygen) was verified by two control experiments, in presence of NaN₃ (singlet oxygen trapping agent) and 1,5-DHN, during the HMF oxidation experiment. The presence of NaN₃ decreases the HMF conversion drastically and lowers the yield of DFF, MA, and HCOOH (FIGS. 32A-32D). UV—vis absorbance shows the formation of juglone during the HMF oxidation due to its reaction with 1,5-DHN (FIG. 32C). Interestingly, after the complete consumption of 1,5-DHN, the yield of H₂O₂ increases (FIG. 31D), confirming the dominant role of singlet oxygen during HMF oxidation.

The HMF oxidation via superoxide radical formation was ruled out by using 1,4-benzoquinone (p-BQ) as superoxide trapping agent. The p-BQ leads to an increased HMF conversion and higher yield of aliphatic intermediates including MA and HCOOH compared to both control and singlet oxygen quenching experiment (FIGS. 32A-32B).

Therefore, based on the obtained results and published HMF photooxidation, a mechanism was suggested and shown in FIG. 33.

Upon illumination, the electrons in the CN are excited to a singlet state and form singlet excitons, which quickly converts to triplet excitons by an intersystem crossing process. Then, triplet excitons react with O₂ to produce ¹O₂. The ¹O₂ then oxidizes HMF to DFF along with H₂O₂ generation. The generated H₂O₂ further oxidizes the DFF to various aliphatic intermediates before complete mineralization.

### Example 5: Water Purification

### Materials and Methods

### Photocatalytic RhB Dye Degradation

The basic setup for photocatalytic water decontamination experiments (photodegradation of a representative organic contaminant, 9-(2-carboxyphenyl)-6-(diethylamino)-N,N-diethyl-3H-xanthen-3-iminium chloride, abbreviated as rhodamine B, RhB) was similar to that for HMF oxidation, except that an aqueous RhB solution was circulated through the system continuously, passing through a standard 10 mm quartz cuvette before reaching the solvent reservoir.

### Results

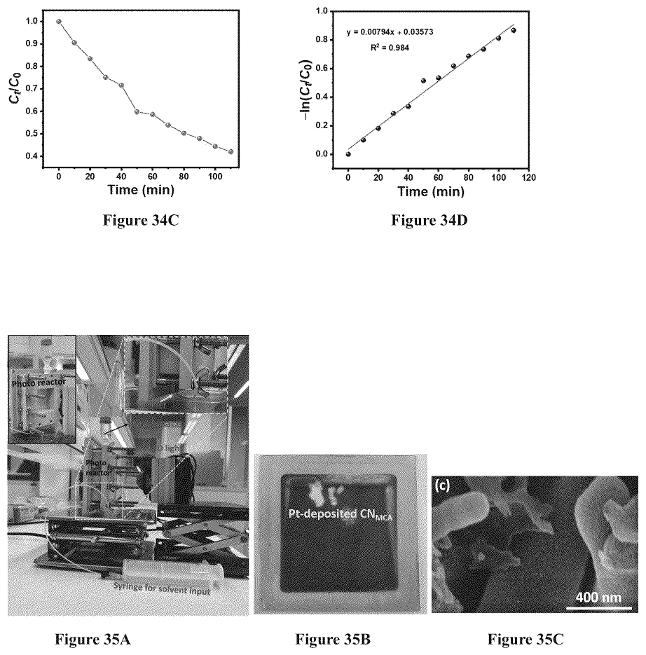

The RhB concentration was continuously monitored by UV—vis absorption; scans were recorded every 10 minutes from 600 to 480 nm. (FIG. 34A) Here, the RhB degradation progress was followed by connecting the continuous-flow reactor with a simple UV—vis spectrometer (FIG. 34B). The CN panel showed 58% pollutant degradation after 110 min (FIG. 34C)(calculated pseudo-first order rate constant k=0.0079 min⁻¹ (FIG. 34D).

These results demonstrate the versatility of the binder-free CN panels by the continuous decontamination of organic pollutants in water. The photodegradation of Rhodamine B (RhB) was studied as a model molecule. A significant advantage of continuous-flow chemistry is continuously monitoring the reactants and products. This allows the reaction rate to be determined using various analytical instruments, unlike batch reactors, where aliquots are taken for sampling and require separating the solid catalyst before analysis.

### Example 6: Direct H₂ Production Using Binder-Free Photocatalysts

### Materials and Methods

### Photocatalytic H Production

The photocatalytic H₂ production experiments were carried out in the same 5×5 cm² continuous-flow photoreactor by connecting its outlet to an additional gas reservoir of ~13.5 mL volume (FIG. 35A). Typically, a volume of 25 mL of 20% vol. EtOH in water that also contained 20 μL of 8% wt. chloroplatinic acid (EtOH was used as a sacrificial electron donor and Pt as cocatalyst-photodeposited in situ during the H₂ production) was fed to the flow reactor using a regular syringe by manual force. The empty gas reservoir (~13.5 mL) was purged with Ar gas for 30 min. Any gas produced during the experiment automatically feeds the reservoir, as it is connected perpendicular to the outlet of the tightly-sealed photoreactor. After illumination, a 200 μL sample was collected from the headspace of the gas reservoir using a gas-tight syringe and analyzed by gas chromatography (GC).

### Results

For the H₂(g) production, Pt was deposited as a reduction cocatalyst on the binder-free CN panels and used EtOH as a hole scavenger (see FIGS. 35A-35B for the experimental setup). The CN panel generates 5.84 μmol of H₂ at a rate of 584 μmol h⁻¹ m⁻² after 4 h. The SEM image of a CN panel after the HER experiment confirms the stability of the materials as well as the successful Pt photoreduction (3.65% wt. of Pt measured by energy-dispersive X-ray spectroscopy (EDS) analysis) on CN_{MCA} (FIG. 35C).

### Example 7: Co-Catalyst-Free Peroxide-Mediated H₂ Production Using HER Inactive Semiconductors

### Materials and Methods

### Materials

Melamine (M, 99%), cyanuric acid (CA, 99%), 8% wt. chloroplatinic acid (H₂PtCl₆) solution, formaldehyde (37% wt., ACS grade, 10-15% methoanol as stabilizer), and WO₃ nanoparticles were purchased from Sigma-Aldrich. Methanol (EtOH, 99.9%, absolute) was purchased from Bio-Lab, Israel. Hydrogen peroxide (H₂O₂, 30% wt.) was purchased from JT Baker. Formaldehyde (37% wt.). Potassium iodide (KI, ≥99%) was purchased from Fisher Chemicals. Potassium hydrogen phthalate (HPLC grade) and salicylic acid (SA, 99%) were purchased from Thermo Scientific. 1,5-dihydroxynaphthalene (DHN, 98%), and ammonium paratungstate (99%) were purchased from Angene Chemical, UK. High purity oxygen (99.99%) and argon (99.999%) gases were purchased from Maxima Ltd., Israel.

Deionized (DI) water for all aqueous solution preparations was collected after treatment through a Millipore Direct-Q 3 water purification system (resistivity of 18.2 MD cm at room temperature).

### Synthesis of LMCA Precursors

Melamine (M) and cyanuric acid (CA) (1:1 mol ratio) powders were dissolved in 25 mL of DI water and shaken in a tube for overnight using an automatic shaker at 300 rpm. The obtained MCA precursor was centrifuged at 6000 rpm (4430 rcf) for 15 min and washed with DI water three times, and finally vacuum-dried at 50° C. overnight ready to be used as a precursor for CN synthesis. Multiple batches were synthesized at the same time to get large amount of MCA precursor.

### Synthesis of CN

The obtained MCA powder was placed in a rectangular ceramic crucible and covered with a lid. Then, the crucible placed in a tube furnace and calcined at 530° C. for 4 h under constant N2 flow, which yielded melon-type CN powder.

### Synthesis of CN Photocatalysts

CN powders were prepared by calcination of MCA supramolecular assembly powders, serving as the CN precursor according to our previously reported procedure.1 The MCA powder (~4.5 g) was placed in a rectangular ceramic crucible (1×w×h=6.9×6.9 x1 cm3) covered with a lid.

Subsequently, the crucible was placed in a tube furnace, heated to 120° C. within 1 h followed by heating to 530° C. with a heating rate of 5° C. min⁻¹ and maintained at 530° C. for 4 h under a constantN2 flow. After calcination, the sample was cooled to 50° C. within 100 min under N2 flow, which yielded (~18%) melon-type CN powder. The obtained CN powder shows a BET specific surface area of 46.5 m²g⁻¹.

### Synthesis of Bulk WOs

Bulk WO₃ was synthesized according to a reported procedure. Briefly, 3 g of ammonium paratungstate was placed in a ceramic crucible and calcined at 500° C. with a heating rate of 5° C. min⁻¹ and maintained at 500° C. for 4 h under static air. After calcination the sample cooled down to room temperature, naturally. Commercially available WO₃ NPs were purchased from Sigma Aldrich (Product No. 550086, nanopowder <100 nm particle size via TEM).

Photocatalytic H₂ and HCOOH Production Over CN and WO₃ Photocatalyst

The photocatalytic experiments were carried out in a typical 53 cell under visible-light in a controlled atmosphere (static air, O₂(g), or ArWg). Briefly, 20 mg of the chosen photocatalyst (CN powder, bulk WO₃, or WO₃ NPs) were dispersed in a volume of 5 mL basic (or neutral) aqueous solution containing 20% vol. MeOH (1 mL McOH+either 4 mL 0.1 M NaOH(aq), or 0.25 M NaOH, or pure DI water).

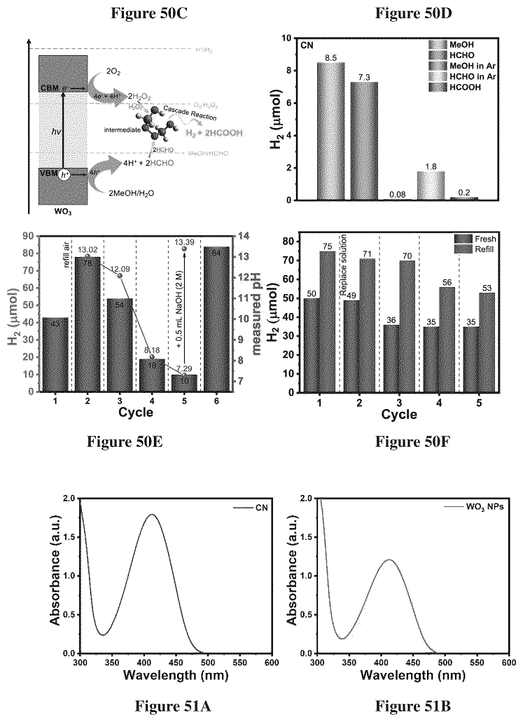

The quartz cell was sealed with a rubber septum under ambient air. The quartz cell was kept in a water bath, maintained at temperature of 25 or 40° C. using a water-circulating chiller. White LED light (100 W, 2680 W m⁻²) used as a light source. Upon illumination, 200 μL of gas sample was collected from the headspace of the reaction utilizing a gas tight syringe for analysis of gaseous products using gas chromatography (GC). The liquid products analyzed by high-p liquid chromatography (HPLC) equipped with DAD detector using a hiplex-H column. It should be noted that during CN photocatalytic experiments in NaOH(aq), the formed HCOOH might be in an anionic form initially. However, during prolonged recyclability experiments, a decrease in pH was observed (FIG. 50E). For consistent quantification of liquid products, the 10 μL of filtered reaction mixture was diluted to a total volume of 1 mL using 0.05 M H₂SO₄ solution and analyzed in HPLC using 100% 0.05 M H₂SO₄ solution as the mobile phase.

### Computational Details

Density functional theory (DFT) simulations were conducted using Vienna Ab Initio Simulation Package (VASP)3 version 5.4.4. The functional of choice was Perdew-Burke-Ernzerhof (PBE).4,5 Core electrons were represented by Projector Augmented Wave pseudopotentials (PAW)6 and valence electrons were expanded in plane waves with a kinetic energy cutoff of 450 eV. The electronic convergence was at least 10-5 eV and the force threshold for ionic convergence was set to 0.02 eV A-1 for geometrical optimization. Frequency calculations were performed using a step size of 0.015 A and all the atoms except the target molecule were fixed. The explicit solvation calculations (water-mediated methanol oxidation) were carried out by placing four water molecules close the adsorbate/target molecule. The monoclinic bulk WO₃ (P12₁/c1) was optimized, with k-point sampling of 4×4×4.

Then, the WO₃ (002) surface slab was constructed as a supercell (√2×√2)R45° with 4 layers (lateral size 15.43 A, thickness 15.36 A, vacuum ~15 A) and the k-point sampling was reduced to G point. The MeOH oxidation and ORR were computed using DFT-PBE as explained above in VASP. The potential energy of H+ was obtained from the computational hydrogen electrode (CHE) framework. The gas-phase 02 was optimized with a spin polarization calculation in an asymmetric cell. Slab calculations included a 15 A vacuum layer, the dipole correction was applied in the z direction, and two bottom layers were fixed during the relaxation.

The conformer sampling for HOCH2OOH and HOCH2OOCH2OH was carried out using the CREST7 (GFN2-xTB)8 and the resulting structures and cascade reaction energetics were computed with DFT as implemented in Gaussian09.9 The B3LYP10-12 correlation functional and 6-31G (d) basis sets13-15 were used for all atoms. The most stable conformers for both intermediates were considered for the reaction energetics.

The files for all the structures can be inspected through the ioChem-BD database at the following link:
https://iochem-bd.iciq.es/browse/review-collection/100/96976/571927baaa1aadafacf7e69d

### Life Cycle Impact Assessment (LCIA)

### Environmental Sustainability Assessment of the Synthetic Procedures

### Scope, System Boundary, and Functional Unit:

A cradle-to-gate LCIA was performed for two synthesis pathways: (i) polymeric carbon nitride (CN) and (ii) polymeric carbon nitride incorporating platinum (CN/Pt). This assessment encompasses all inputs, emissions, transportation, and processes involved, from raw material acquisition to the production of CN and CN/Pt, including upstream resource extraction, energy consumption for reagent production, and direct emissions from energy generation. A mass-based functional unit of one gram of synthesized CN or CN/Pt was selected to demonstrate the environmental impact reduction associated with the elimination of the Pt co-catalyst.

### Impact Assessment:

The LCIA was conducted on the synthesis routes for the production of 1 g CN or CN/Pt as described in Table 4 and Table 5. The impact assessment was performed using SimaPro 9.6.0.2 (PRe Consultants). The United States Life Cycle Inventory (USLCI)16 was chosen when available; otherwise, Industry Data 2.017 or Ecoinvent 318,19 was selected. Environmental impacts were modeled using the United States Environmental Protection Agency's Tool for the Reduction and Assessment of Chemical and Other Environmental Impacts (TRACI) 2.1 assessment method.20 Environmental impact categories include ozone depletion (OD, in kg CFC-11 eq), global warming potential (GWP, in kg CO2 eq), photochemical smog formation (PS, in kg 03 eq), acidification (AC, kg SO2 eq), eutrophication (EU, kg N eq), human health impacts from toxic carcinogenic (HHC) andnoncarcinogenic (HHNC) substances (in comparative toxic units for human toxicity impacts, or CTUh), respiratory effects (RE, in kg PM2.5 eq), ecotoxicity (EC, in comparative toxic units for aquatic ecotoxicity impacts, or CTUe), and fossil fuel depletion (FF, in MJ surplus); eq represents equivalents. Bare and colleagues provide a detailed overview of the impact-assessment methodologies and the characterization factors applied to each of the aforementioned TRACI impact categories.21

TABLE 4
Life cycle inventory to produce the CN photocatalyst, including the Pedigree matrix for unit processes (all distributions assumed to be lognormal).

| | | | | | | ^{a}Pedigree | |
|---|---|---|---|---|---|---|---|
| | | | | | | Matrix | |
| | | | | | | Uncertainty | |
| | | | | | | Factors | |
| | Section | Material | Amount | Unit | LCI Database | (A, B, C, D, E) | Comments |
| 0.81 g of CN | Input | Melamine | 2.23 | g | Melamine {GLO}\| | 1, 4, 1, 1, 1, na | |
| | | | | | market for melamine \| | | |
| | | | | | Cut-off, U | | |
| Yield 18% | | Cyanuric acid | 2.27 | g | Created | 1, 4, 1, 1, 1, na | Based on²³ |
| | | Water | 225 | g | Water, deionised | 1, 4, 1, 1, 1, na | |
| | | | | | {RoW}\| market for | | |
| | | | | | water, deionised \| | | |
| | | | | | Cut-off, U | | |
| | | Nitrogen gas | 89 | g | Nitrogen, liquid | 2, 4, 1, 1, 1, na | Calcination inert gas. Note: In the experimental |
| | | | | | {RoW}\| market for | | setup, we used a nitrogen generator rather than |
| | | | | | nitrogen, liquid \| | | the modeled compressed nitrogen; as a result, the |
| | | | | | Cut-off, U | | reported contributions represent conservative |
| | | | | | | | estimate of the contribution of N₂. |
| | | Electricity | 40.17 | kWh | Electricity, at grid, | 4, 4, 1, 1, 1, na | |
| | | | | | US/US | | |
| | Emission | Ammonia | 0.60 | g | | 2, 4, 5, 1, 1, na | Approximately 2 NH₃ liberated by melamine |
| | to air | | | | | | pyrolysis at 530° C. for 4 h (mole/mole |
| | | | | | | | melamine). Based on^{24, 25} |
| | | | | | | | CH₃H₆N₆(s) → C₃N₄(s) + 2NH₃(g) |
| | | Isocyanic acid | 2.27 | g | | 2, 4, 5, 1, 1, na | All cyanuric acid is decomposed into iso cyanic |
| | | | | | | | acid at 530° C. Based on^{26, 27} |
| | | | | | | | C₃H₃N₃O₃(s) → 3HNCO(g) |
| | | Water | 225 | g | | 1, 4, 1, 1, 1, na | Evaporation |
| | | Nitrogen | 89 | g | | 2, 4, 1, 1, 1, na | Calcination inert gas |
| Cyanuric | | Urea | 9.2 | g | Urea, as 100% | 1, 4, 4, 3, 1, na | This LCI refers to 1 kg of N, resp. 2.17 kg urea |
| acid (for | | | | | CO(NH₂)₂ (NPK 46.6- | | with a N-content of 46%. Thus, to account for the |
| 12.75 g) | | | | | 0-0), market mix, at | | 20 g of urea needed, an amount of 9.2 g is used |
| | | | | | regional storage | | |
| | | | | | {RNA} Economic, U | | |
| Yield 89% | | Kerosene | 40 | mL | Kerosene, at | 1, 4, 4, 3, 1, na | |
| based on²³ | | | | | refinery/1/US | | |
| | | Deionized | 15 | g | Water, deionised | 1, 4, 4, 3, 1, na | |
| | | water | | | {RoW}\| market for | | |
| | | | | | water, deionised \| | | |
| | | | | | Cut-off, U | | |
| | | Electricity | 5.4 | kWh | Electricity, at | 4, 4, 1, 1, 1, na | Used for stirring, heating, drying |
| | | | | | grid, US/U2 | | |
| | Emission | Ammonia | 5.67 | g | | 1, 4, 4, 3, 1, na | 3CH₄N₂O → C₃H₃N₃O₃ + 3NH₃ |
| | to air | | | | | | Based on²⁸ |
| | | Water | 15 | g | | 1, 4, 4, 3, 1, na | Evaporation |

^{a}The numbers indicate the type of uncertainty considered in the pedigree matrix approach, selected from the options available in the SimaPro uncertainty methodology. A = 1: ‘verified data based on measurements’, A = 2: ‘verified data partly based on assumptions or non-verified data based on measurements’, A = 4: ‘qualified estimate’. B = 4: ‘representative data from only one site relevant for the market considered or some sites but from shorter period’. C = 1: ‘less than 3 years of difference to the time period of the dataset, C = 4: ‘less than 15 years of difference’, and C = 5: ‘age of data unknown or more than 15 years of difference’. D = 1: ‘data from area under study’, D = 3: ‘data from area with similar production conditions’. E = 1: ‘data from enterprises, processes and materials under study’. ‘na’ corresponds with unspecified sample size.

TABLE 5
Life cycle inventory to produce the CN/Pt photocatalyst, including the Pedigree
matrix for unit processes (all distributions assumed to be lognormal).

| | | | | | | ^{a}Pedigree | |
|---|---|---|---|---|---|---|---|
| | | | | | | Matrix | |
| | | | | | | Uncertainty | |
| | | | | | | Factors | |
| | Section | Material | Amount | Unit | LCI Database | (A, B, C, D, E) | Comments |
| 20 mg of CN/Pt | Input | Melamine | 0.055 | g | Melamine {GLO}\| | 1, 4, 1, 1, 1, na | |
| | | | | | market for melamine \| | | |
| | | | | | Cut-off, U | | |
| Yield assumed | | Cyanuric | 0.056 | g | Created | 1, 4, 1, 1, 1, na | Based on²³ |
| to be 100% | | acid | | | | | |
| | | Water | 29 | g | Water, deionised | 1, 4, 1, 1, 1, na | |
| | | | | | {RoW}\| market for | | |
| | | | | | water, deionised \| | | |
| | | | | | Cut-off, U | | |
| | | Nitrogen | 9.88 | g | Nitrogen, liquid {RoW}\| | 2, 4, 1, 1, 1, na | Calcination inert gas. Note: In the |
| | | gas | | | market for nitrogen, | | experimental setup, we used a |
| | | | | | liquid \| Cut-off, U | | nitrogen generator rather than the |
| | | | | | | | modeled compressed nitrogen; as |
| | | | | | | | a result, the reported contributions |
| | | | | | | | represent conservative estimates, |
| | | Electricity | 33.86 | kWh | Electricity, at grid, US/US | 4, 4, 1, 1, 1, na | Used for stirring, sonication, |
| | | | | | | | drying, and calcination |
| | | Hexachloro- | 1.26 | mg | Created | 1, 4, 1, 1, 1, na | Based on²⁹ |
| | | platinic | | | | | |
| | | acid | | | | | |
| | | Methanol | 0.791 | g | Methanol {GLO}\| market | 1, 4, 1, 1, 1, na | |
| | | | | | for methanol \| Cut-off, U | | |
| | Emission | Ammonia | 0.01485 | g | | 2, 4, 5, 1, 1, na | Approximately 2 NH₃ molecules |
| | to air | | | | | | are liberated by melamine |
| | | | | | | | pyrolysis at 550° C. for 4 h |
| | | | | | | | (mole/mole melamine). Based |
| | | | | | | | on^{24, 25} |
| | | | | | | | C₃H₆N₆(s) → C₃N₄(s) + 2NH₃(g) |
| | | Isocyanic | 0.056 | g | | 2, 4, 5, 1, 1, na | All cyanuric acid is decomposed |
| | | acid | | | | | into cyanic acid at 530° C. |
| | | | | | | | Based on²⁶ |
| | | | | | | | (CNOH)₃(s) → 3HNCO(g) |
| | | Water | 29 | g | | 1, 4, 1, 1, 1, na | Evaporation |
| | | Nitrogen | 9.88 | g | | 2, 4, 1, 1, 1, na | Calcination inert gas |
| Hexachloroplatinic | | Nitric | 1.2 | kg | Nitric acid, in water (60% | 1, 4, 4, 3, 1, na | Values according to stoichiometry |
| acid (for 1 kg) | | acid | | | HNO3) (NPK 13.2-0-0), | | |
| Based on²⁹ | | | | | market mix, at regional | | |
| | | | | | storage {RER} Economic, U | | |
| | | Hydrochloric | 1.8 | kg | Hydrochloric acid (30% | 1, 4, 4, 3, 1, na | Values according to stoichiometry |
| | | acid | | | HCl) (Mannheim), at plant | | |
| | | | | | {RER} Economic, U | | |
| | | Platinum | 0.37 | kg | Platinum {ZA}\| platinum | 1, 4, 4, 3, 1, na | Values according to |
| | | extraction | | | group metal, extraction and | | stoichiometry, 74.2% of platinum |
| | | | | | refinery operations \| | | stems from South Africa |
| | | | | | Cut-off, U | | |
| | | Platinum | 0.1 | kg | Platinum {RU}\| platinum | 1, 4, 4, 3, 1, na | Values according to |
| | | mine | | | group metal mine operation, | | stoichiometry, 20.7% of platinum |
| | | operation | | | ore with high palladium | | stems from South Africa |
| | | | | | content \| Cut-off, U | | |
| | | Electricity | 0.18 | kWh | Electricity, at grid, US/US | 4, 4, 1, 1, 1, na | Accounts for the energy required |
| | | | | | | | to heat up the solution |
| | | Transport | 1.1 | tkm | Transport, freight train | 1, 4, 4, 3, 1, na | Standard distances from ecoinvent |
| | | (freight | | | {US}\| market for transport, | | guidelines |
| | | train) | | | freight train \| Cut-off, U | | |
| | | Transport | 0.35 | tkm | Transport, freight, lorry 16- | 1, 4, 4, 3, 1, na | Standard distances from ecoinvent |
| | | (freight | | | 32 metric ton, EURO6 | | guidelines |
| | | lorry) | | | {RoW}\| transport, freight, | | |
| | | | | | lorry 16-32 metric ton, | | |
| | | | | | EURO6 \| Cut-off, U | | |
| | | Organic | 4e−10 | p | Chemical factory, organics | 1, 4, 4, 3, 1, na | Standard from ecoinvent |
| | | chemical | | | {GLO}\| market for chemical | | guidelines |
| | | factory | | | factory, organics \| Cut-off, U | | |
| | Emission | Nitrogen | 0.45 | kg | | 1, 4, 4, 3, 1, na | Values according to stoichiometry |
| | to air | oxides | | | | | |
| | | Heat, waste | 0.66 | MJ | | 1, 4, 4, 3, 1, na | From electricity input |
| | Emissions | Wastewater | 0.002 | m³ | | 1, 4, 4, 3, 1, na | Water from chemical reactions, |
| | to water | | | | | | values according to stoichiometry |

^{a}The numbers indicate the type of uncertainty considered in the pedigree matrix approach, selected from the options available in the SimaPro uncertainty methodology. A = 1: ‘verified data based on measurements’, A = 2: ‘verified data partly based on assumptions or non-verified data based on measurements’, A = 4: ‘qualified estimate’. B = 4: ‘representative data from only one site relevant for the market considered or some sites but from shorter period’. C = 1: ‘less than 3 years of difference to the time period of the dataset, C = 4: ‘less than 15 years of difference’, and C = 5: ‘age of data unknown or more than 15 years of difference’. D = 1: ‘data from area under study’, D = 3: ‘data from area with similar production conditions’. E = 1: ‘data from enterprises, processes and materials under study’. ‘na’ corresponds with unspecified sample size.

### Uncertainty Analysis:

Uncertainty analysis was performed using Monte Carlo simulation (1000 runs, confidence interval 95%, SimaPro 9.6.0.) to assess the uncertainty of the cumulative unit process life cycle inventory data associated with each synthesis route. For unit processes available in the selected databases (i.e., USLCI, Ecoinvent, Industry Data 2.0), the default lognormal distributions were used. For the unit processes created by the authors, the uncertainty factors were calculated for each input and output data considering a lognormal distribution and utilizing the pedigree matrix approach (the factors used in the pedigree matrix are listed in Table 4 and Table 5, and the resulting standard deviations from the detailed uncertainty analysis are reported in Table 6 and Table 7.

TABLE 6
Life cycle impact assessment results (with standard deviations calculated
determined from uncertainty analysis) for producing 1 g CN when the
electricity is solar generated.

| Impact category | Unit | Total | SD |
|---|---|---|---|
| Ozone depletion | kg CFC-11 eq | 5.29E−08 | 1.02E−08 |
| Global warming | kg CO₂ eq | 3.2505302 | 0.3057129 |
| Smog | kg O₃ eq | 0.14474101 | 0.01301688 |
| Acidification | kg SO₂ eq | 0.01915345 | 0.00159327 |
| Eutrophication | kg N eq | 0.00375304 | 0.00129144 |
| Carcinogenics | CTUh | 7.28E−07 | 7.84E−07 |
| Non carcinogenics | CTUh | 4.65E−07 | 3.58E−05 |
| Respiratory effects | kg PM2.5 eq | 0.00188365 | 0.00024822 |
| Ecotoxicity | CTUc | 62.646577 | 16.596628 |
| Fossil fuel depletion | MJ surplus | 4.8812837 | 0.74289428 |

TABLE 7
Life cycle impact assessment results (with standard deviations calculated using
uncertainty analysis) for producing 1 g CN and 1 g CN/Pt

| Impact | | | | | |
|---|---|---|---|---|---|
| category | Unit | 1 g CN | SD | 1 g CN/Pt | SD |
| Ozone | kg CFC-11 eq | 2.14E−09 | 2.08E−10 | 6.05E−08 | 6.76E−09 |
| depletion | | | | | |
| Global | kg CO₂ eq | 39.615315 | 4.1970393 | 1321.6325 | 146.14674 |
| warming | | | | | |
| Smog | kg O₃ eq | 2.6622404 | 0.28210401 | 89.404643 | 9.8204552 |
| Acidification | kg SO₂ eq | 0.34521404 | 0.03618613 | 11.515016 | 1.2610311 |
| Eutrophication | kg N eq | 0.00525666 | 0.00052119 | 0.18319181 | 0.01947829 |
| Carcinogenics | CTUh | 7.79E−08 | 1.71E−07 | 2.85E−06 | 1.74E−06 |
| Non | CTUh | 1.28E−06 | 8.38E−06 | 5.44E−05 | 5.15E−05 |
| carcinogenics | | | | | |
| Respiratory | kg PM2.5 eq | 0.01675059 | 0.00175457 | 0.55957293 | 0.0611341 |
| effects | | | | | |
| Ecotoxicity | CTUe | 16.038583 | 3.2636192 | 850.1725 | 118.45234 |
| Fossil fuel | MJ surplus | 25.024269 | 2.6431657 | 833.03423 | 92.044683 |
| depletion | | | | | |

### Synthesis of 0.81 g CN (Reaction Yield of 18% Wt.)-LCI:

### LCI Inputs:

i. 2.23 g melamine
ii. 2.27 g cyanuric acid
iii. 225 mL of deionized water
iv. Nitrogen gas: assuming flow rate of 160 mL min-1 for the entire calcination process of (142+240+100=482 min)=160 mL min-1 ' 1.16 kg m⁻³ ' 1 m3/103 L=0.089 kg
v. Electricity:
a) Shaker (Heidolph, Unimax 1010): 50 W for 12 h
b) Centrifuge (HERMLE, Z 206 A): 100 W for 15 min
c) Vacuum Oven (SHEL LAB): 439 W at 150° C. for 12 h
d) Vacuum Pump (Vacuubrand, MZ 2C NT): 180 W for 12 h
e) Furnace (NBD-01200-80T): 4000 W for 8.03 h (note: this is maximal power, serving as an upper limit)

$$Total electricity consumption = ( {50}^{′} 12 ) + ( {100}^{′} 0.25 ) + ( {439}^{′} 12 ) + ( {180}^{′} 12 ) + ( {4000}^{′} 8.03 ) = 40.173 kWh$$

vi. LCI emission to air:
Ammonia 0.60 g
Isocyanic acid 2.27 g
Water 225 g
Nitrogen 89 g

### Synthesis of 20 mg CN/Pt (Pt Yield of 100% Wt.)—LCI:

### LCI Inputs:

i. 0.055 g melamine
ii. 0.056 g cyanuric acid
iii. 9.5 mL of deionized water
iv. 1.26 mg hexachloroplatinic acid
v. Nitrogen gas: Since 20 mg of CN was used in the synthesis, the nitrogen consumption was calculated proportionally to this mass, based on previous calculations for CN. The resulting nitrogen consumption was determined to be 9.88 g.
vi. 0.791 g methanol
vii. Electricity:
a) 100 W LED (LZ 220 V): 100 W for 24 h
b) Chiller (vivo RT4): 825 W for 24 h
c) Stirrer (Heidolph, MR Hei-Tec): 300 W for 24 h

$$Subtotal electricity consumption = ( {100}^{′} 24 ) + ( {825}^{′} 24 ) + ( {300}^{′} 24 ) = 29.4 kWh$$

Additional electricity consumption for 20 mg CN added to this process=4.46 kWh

$$Thus , the total electricity consumption = 29.4 + 4.46 = 33.86 kWh$$

viii. LCI emission to air:
Ammonia 0.01485 g
Isocyanic acid 0.056 g
Water 29 g
Nitrogen 9.88 g

### Results

FIG. 36A is a schematic diagram of the proposed H₂O₂-mediated co-catalyst free H₂ and HCOOH production with FIG. 36B showing CN_{MCA} photocatalyst powders or panels in comparison with the traditional approach where a Pt co-catalyst is deposited before the reaction takes place.

As schematically shown in FIGS. 36A and 36B, the catalytic material (shown for example as CN) oxidizes a compound containing a hydroxyl group (shown for example as methanol) to the respective aldehyde and in parallel reduces oxygen to hydrogen peroxide. These two reactions products, i.e. the aldehyde and hydrogen peroxide react to form hydrogen.

This in situ H₂O₂-mediated approach unlocks a new way to produce H₂ using the so called ‘HER-inactive’ photocatalysts. This new approach not only reduces the cost of catalytic system by ~8 times by completely avoiding the use of precious metal co-catalysts, but also produces valuable HCOOH as a valuable liquid product (as schematically shown in FIGS. 36A and 36B).

FIG. 36A shows the photocatalyst activity that simultaneously generates H₂O₂ via ORR and oxidizes methanol into formaldehyde (HCHO). In the second step of the cascade reaction, H₂O₂ reacts with HCHO, producing hydrogen and formic acid. To demonstrate the concept, we have chosen two abundant and cheap materials that are known for their inability to generate hydrogen for different reasons. Polymeric carbon nitride cannot generate hydrogen without a cocatalyst, while WO₃ is an inactive photocatalyst for hydrogen production owing to an unsuitable CB edge.14 CN was prepared by calcination of a melamine-cyanuric acid supramolecular precursor. As shown below, the photocatalytic co-catalyst free H₂ and HCOOH production can be done using several semiconductors, namely CN and WOs.

### Characterization of Catalysts

The CN prepared by calcination of melamine-cyanuric acid supramolecular precursor. Powder X-ray diffraction (XRD) of CN (FIG. 37A) presents diffraction signals around 2θ=27.4° and 13°, which are assigned to the interlayer stacking of CN layers (002 plane) and in-plane ordering of tri-s-triazine structure (100 plane), respectively. The FTIR spectra of CN (FIG. 37B) presents characteristic peaks around 3200-3500 cm⁻¹, 1200-1650 cm⁻¹ and 804 cm⁻¹, which are assigned to —NH. groups, C—N heterocycles and heptazine/triazine moiety, respectively.

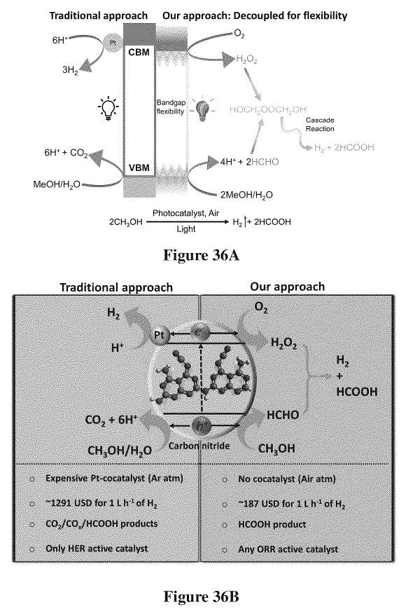

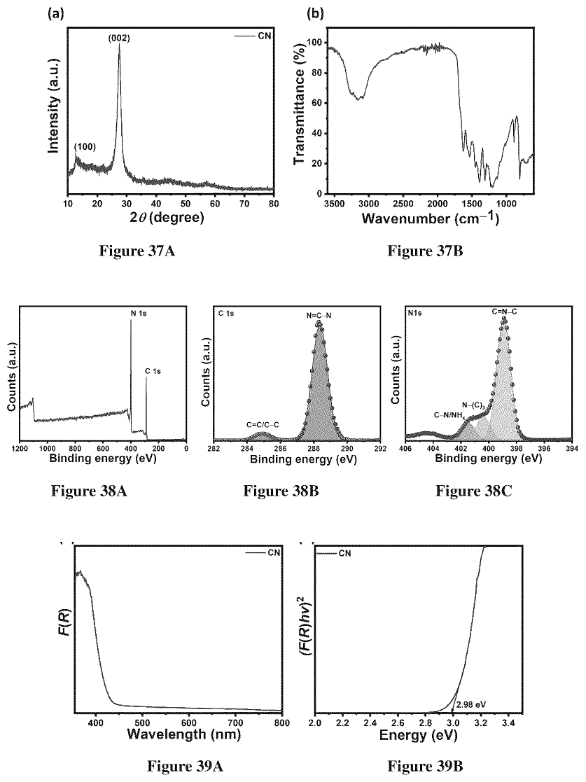

The XPS survey spectra of CN (FIG. 38A-38C) confirms the presence of C and N elements. The individual high-resolution C 1s and N 1s spectra further confirms the nature of C and N in the CN.

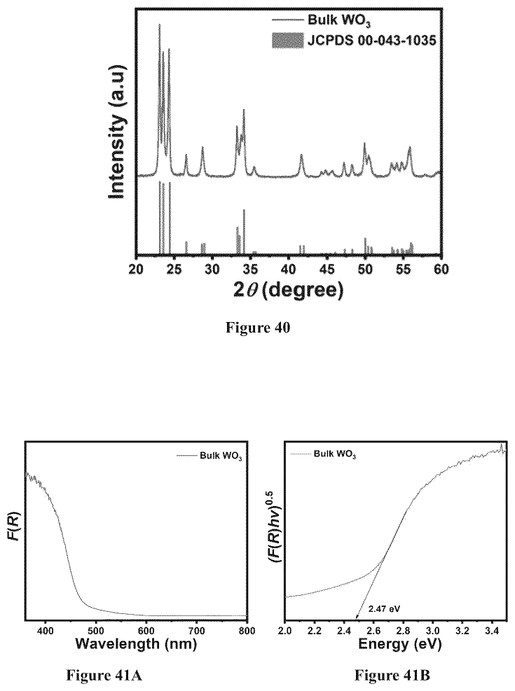

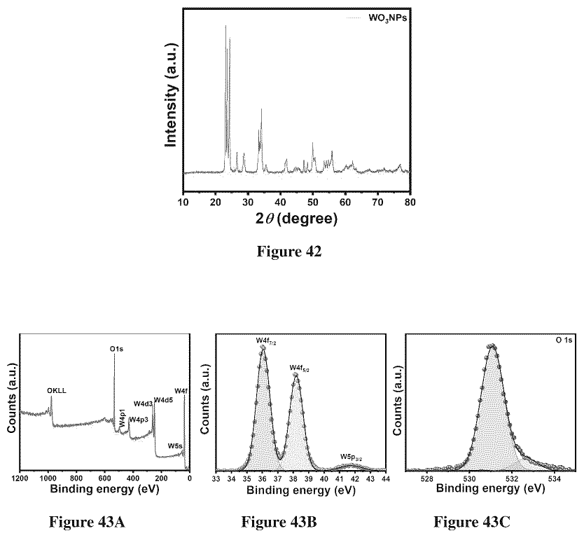

The calculated absorption spectrum, using the Kubelka-Munk method (FIG. 39A) and Tauc-plot (FIG. 39B) reveal a band gap energy of about 2.98 eV for CN_{MCA} The bulk WO₃ prepared according to previous literature and its basic characterization confirms the formation of bulk WO₃ (FIG. 40-41).¹⁴ The basic characterization of commercially purchased WO₃ NPs can be found in FIGS. 41-42).

Visible-Light Driven H₂ Production Mediated by In Situ Generated H₂O₂

Photocatalytic H₂O₂ generation through ORR is possible in the presence of multiple semiconductor-based photocatalysts.⁷ Among all the reported catalysts, the polymeric CN-based photocatalysts showed high H₂O₂ yields, promoted by water oxidation or aqueous-phase biomass oxidation.⁶ Recently, our group has demonstrated a continuous-flow photoreactor for H₂O₂ production over CN panels. The generated H₂O₂ is often consumed during biomass-derived chemical oxidation-effecting the overall H₂O₂ yield as well as the selectivity of targeted biomass oxidation product. It has been demonstrated that the H₂O₂ rapidly reacts with HCHO to produce H₂ and HCOOH without any catalyst.¹¹ Therefore, CN photocatalyst can oxidize methanol (MeOH) to HCHO along with a two-electron 02 reduction (ORR) to H₂O₂ under ambient air. Furthermore, the in situ generated H₂O₂ and HCHO react at contact to produce H₂ and HCOOH without requiring a co-catalyst.

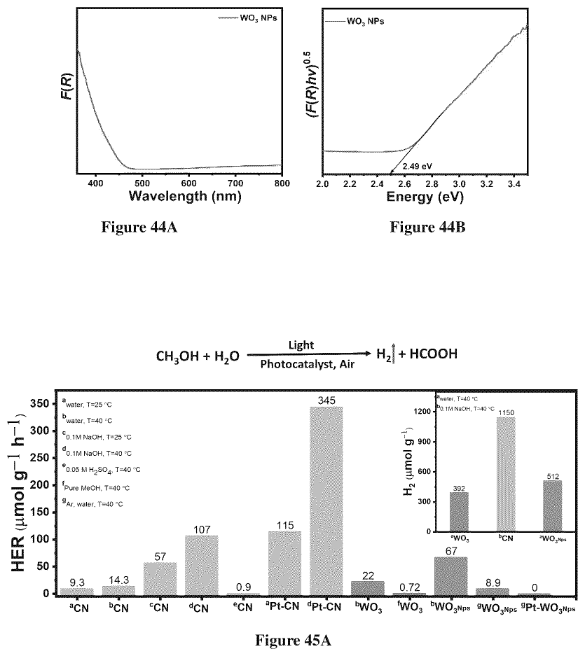

XPS survey spectra (FIG. 43A), W 4f XPS spectra (FIG. 43B), and O 1s XPS spectrum (FIG. 43C) of commercial WO₃ nanoparticles show pure WO₃ material was used.

The calculated absorption spectrum, with the Kubelka-Munk method (FIG. 4A) and Tauc-plot (FIG. 44B) depict a band-gap energy of about 2.49 eV for WO₃ nanoparticles.

To look for a potential cascade reaction, pairing up the rates at which each of the events takes place is of fundamental relevance. It is known that in solution, the reaction of H₂O₂ with HCHO is very fast and exclusively produces H₂ and HCOOH without the need of a catalyst. Inspired by this observation, we aimed to design a photocatalytic system capable of concurrently producing H₂O₂ and HCHO. We selected polymeric CN as the photocatalyst based on its high H₂O₂ production yield by two-electron O₂ reduction (ORR) under an ambient atmosphere. As for HCHO, it can be readily produced by the oxidation of methanol (MeOH). Thereafter, the in situ generated H₂O₂ and HCHO react to produce H₂ and HCOOH without requiring a cocatalyst.

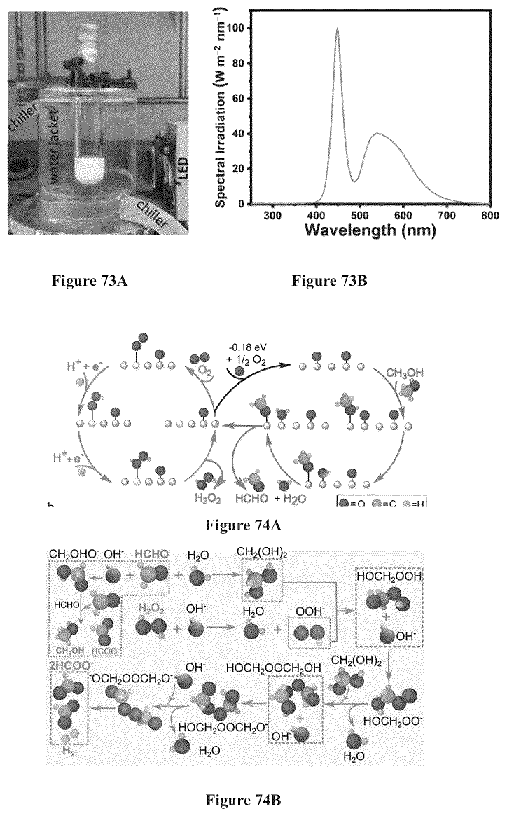

Initially, we studied and optimized the reaction parameters, such as solvent and reaction temperature, by performing photocatalysis experiments (experimental setup in FIG. 73A).

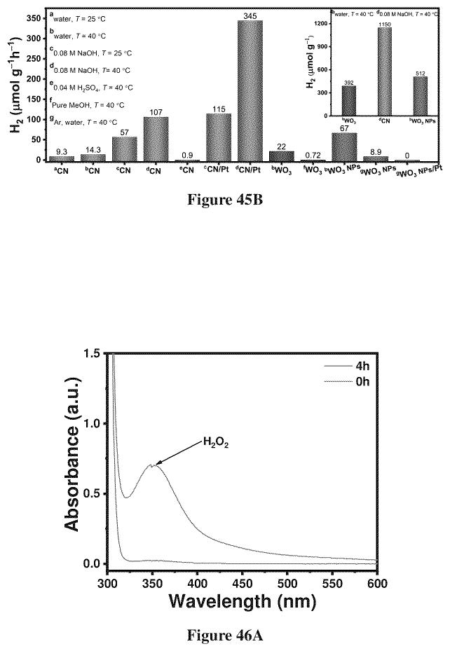

First, the reaction parameters, such as solvent and reaction temperature were studied as shown in FIGS. 45A and 45B under visible-light illumination and average product rates were assessed. The CN produced 0.7 μmol H₂ at rate of 9.3 μmol h⁻¹ g⁻¹ from pure water or MeOH at 25° C. temperature after 4 h and the same reaction at 40° C. produced 1.1 μmol H₂ at rate of 14.3 μmol h⁻¹ g⁻¹. Changing the solvent to an alkaline one (0.1 M NaOH) the CN produced more H₂ (7.2 μmol) at a rate of 57 μmol h⁻¹ g⁻¹ at 25° C. Further increase of the reaction temperature to 40° C., produced 8.5 μmol H₂ at a rate of 107 μmol h⁻¹ g⁻¹. The same experiment in presence of 0.05 M H₂SO₄ produced only 0.07 μmol H₂ at a rate of 0.9 μmol h⁻¹ g⁻¹.

In an alkaline solution (0.08 M NaOH), CN produced more H₂ (4.6 μmol) at a rate of 57 μmol h-1 g-1 at 25° C.; further increasing the reaction temperature to 40° C. resulted in the production of 8.5 μmol H₂ at a rate of 107 μmol h-1 g-1. The same experiment in the presence of 0.04 M H₂SO₄ produced only 0.07 μmol H₂ at a rate of 0.9 μmol h-1 g-1. Thus, 0.08 M NaOH and 40° C. was used as the optimized conditions for further studies using the CN photocatalyst.

Further, the ‘standard’ photocatalytic HER experiments were performed in 20% vol MeOH in 0.08 M NaOH using CN powder loaded with 3% wt. Pt as the co-catalyst, has produced 9 and 30 μmol H₂ at a rate of 115 and 345 μmol h⁻¹ g⁻¹ at 25 and 40° C. respectively.

It should be noted that this new approach allows the use of any H₂O₂-producing photocatalyst for H₂ production without additional co-catalyst(s). To demonstrate the advantage of this new H₂ production process, it was chosen to test WO₃—a visible-light active photocatalyst, known for 2-electron ORR—yet, inactive for photocatalytic H₂ production. Surprisingly, bulk WO₃ has produced 1.8 μmol H₂ at a rate of 22 μmol h⁻¹ g⁻¹ from water/MeOH at 40° C. The same experiment in pure MeOH produced only 0.1 μmol H₂ at rate of 0.72 μmol h⁻¹ g⁻¹, which suggests that the necessity of water. To verify the suggested mechanism and to show the generality of our new approach, commercial WO₃ NPs (50-100 nm size) were tested-prior to our MeOH photooxidation experiments, this WO₃ NPs was first tested for regular H₂O₂ production in presence of 20 vol % EtOH in pure water at 40° C. and results proved the commercial WO₃ NPs can produce H₂O₂ (FIGS. 46A and 46B)—WO₃ NPs produced 5.3 μmol H₂ at a rate of 67 μmol h⁻¹ g⁻¹ from water/MeOH at 40° C., which is much higher than bulk WO₃ and CN under similar conditions.

To verify the suggested mechanism and show the generality of our approach, commercial WO₃ nanoparticles (NPs; 50-100 nm size) were tested. Before our MeOH photooxidation experiments, we tested the ability of WO₃ NPs to produce H₂O₂ under light illumination in the presence of 20% vol ethanol (EtOH) in water at 40° C.; after 4 h illumination with visible light, iodide ions (I⁻) were added to the solution as an indicator; iodide reacts with H₂O₂ to form triiodide (I3⁻). The presence of I3⁻ was detected by UV—vis spectroscopy, confirming that H₂O₂ was indeed produced (FIG. 46B). In water/MeOH at 40° C., over 4 h, WO₃ NPs produced 5.3 μmol H₂ at an average rate of 67 μmol h-1 g-1, which is higher than with bulk WO₃ or CN under similar conditions.

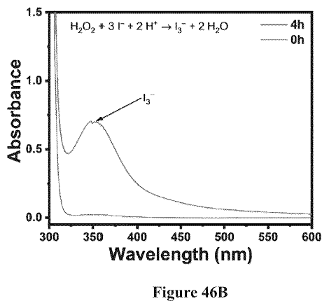

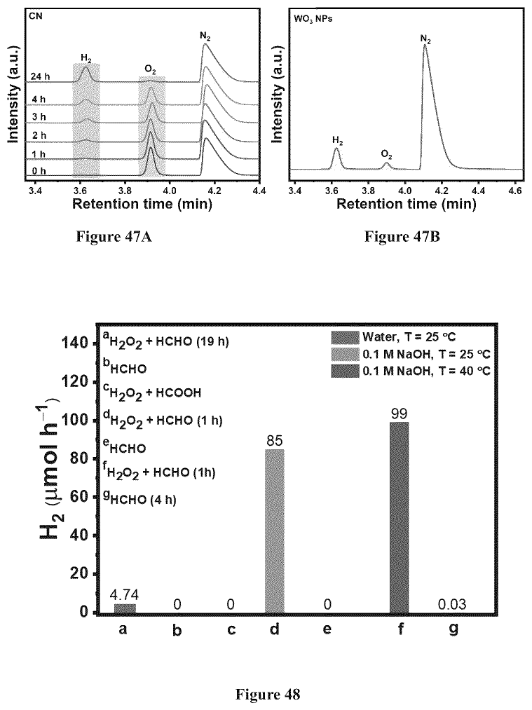

The control experiment in presence of argon (Ar) atmosphere showed negligible H₂ production-confirming the crucial role of O₂ in generating H₂ under these experimental conditions. After 24 h, CN and both WO₃ photocatalysts shows improved H₂ yields (inset of FIGS. 45A-45B). The GC analysis of the headspace shows the consumption of O₂ during this reaction along with H₂ production, further showcasing the ORR coupled H₂ production (FIGS. 47A-47B). Recently, it has been demonstrated that WO₃—nanowires could produce H₂ due to shifting of their conduction band upwards as a result of quantum confinement.¹⁵ Therefore, WO₃ NPs were also checked for regular photocatalytic HER using 3% wt. Pt as the co-catalyst-no H₂ was produced under these experimental conditions (it should be noted that this experiment repeated two times). This result strongly supports our hypothesis that WO₃ NPs—an otherwise inactive photocatalyst for HER—can produce H₂ via the reported H₂O₂-mediated approach.

### Mechanistic Investigations

To understand the reaction of in situ generated H₂O₂ and HCHO to produce H₂ and HCOOH, a direct reaction of commercial H₂O₂(30% wt.) and HCHO (37% wt.) were performed under identical conditions without photocatalyst in the dark (FIG. 48). The direct mixture in pure water at 25° C. produced 4.73 pol h⁻¹ of H₂. No H₂ was produced with individual HCHO even after 24 h, which indicates the role of H₂O₂ in HCHO oxidation to H₂ and HCOOH production.

The same reaction in 0.1 M NaOH at 25° C. produced 85 μmol h⁻¹ of H₂, which also confirms the better H₂ yields obtained in 0.1 M NaOH with CN photocatalyst earlier. The higher activity obtained in 0.1 M NaOH might be due to the formation hydroperoxide anion (HOO—), which is a better nucleophile than H₂O₂.¹⁶No H₂ was produced with only HCHO even after 24 h, which further rules out the reaction of HCHO with NaOH to give H₂ and strongly supports the role of H₂O₂ under these experimental conditions. Increasing the reaction temperature to 40° C. produced higher H₂ (99 μmol h⁻¹), which further supports the higher H₂ yield obtained with CN in earlier experiments. The HCHO alone produced negligible H₂(0.03 mol h⁻¹) at 40° C., which almost 3300 times less that of the experiment with H₂O₂. This not only rules out the possibility of direct HCHO oxidation to H₂ but also the role of H₂O₂ to generate H₂ under these experimental conditions.

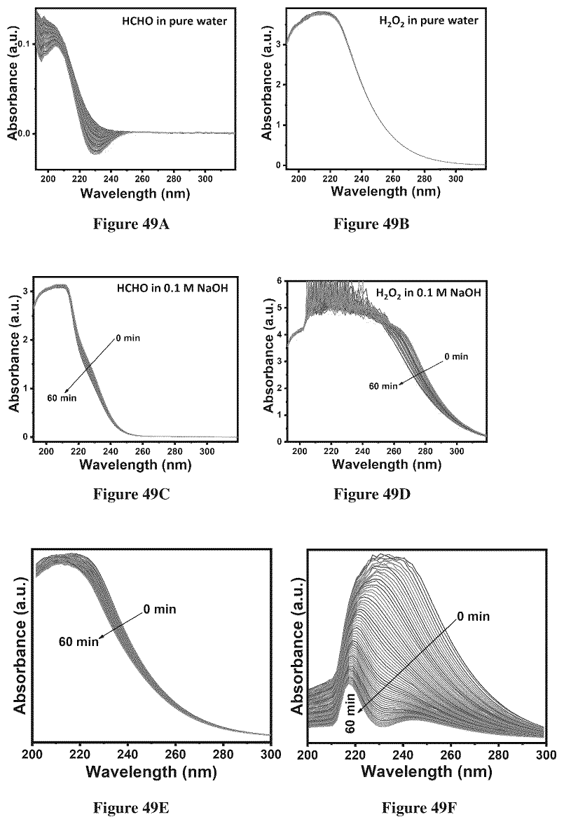

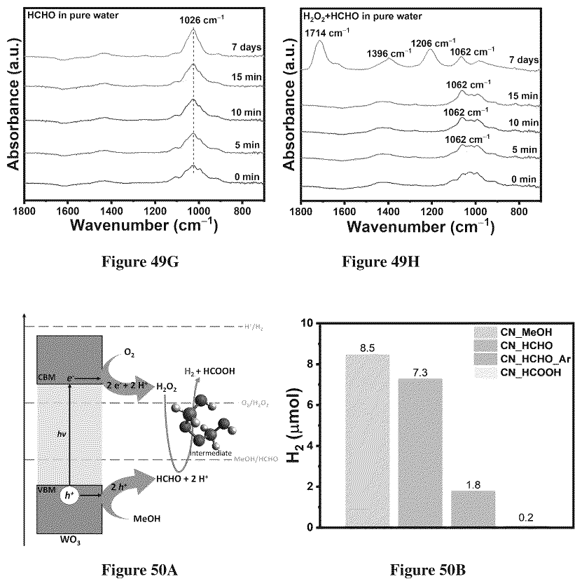

To understand the kinetics of H₂O₂ reaction with HCHO in pure water and 0.1 M NaOH, H₂O₂/HOO⁻UV—vis spectra in situ were monitored during the dark reaction at 25° C. for 1 h (FIGS. 49A-49F). FIG. 49A-49D show no significant change in individual H₂O₂/HOO⁻ and HCHO UV—vis spectra for 1 h, which shows individual H₂O₂ and HCHO is stable in both pure water and 0.1 M NaOH. After mixing H₂O₂ and HCHO in pure water, the corresponding H₂O₂ band slowly decreased during 1 h, which shows the H₂O₂ is being consumed during the reaction with HCHO (FIG. 49E). Surprisingly, the same mixture in 0.1 M NaOH resulted a rapid decrease in HOO—UV—vis band (FIG. 49F).

This fast kinetics is due to the better nucleophilicity of HOO—than H₂O₂.¹⁶ This in situ UV—vis analysis results further supports the better H₂ yield obtained in 0.1 M NaOH over CN photocatalyst previously (FIGS. 45A-45B). Since, H₂O₂ reacts relatively slow with HCHO in pure water (FIG. 49E), it can be possible to observe the formation of new intermediate C-0 bonds that arises due to the reaction of H₂O₂ with HCHO using FTIR spectroscopy technique. Therefore, FTIR were recorded by simply mixing commercial H₂O₂ with HCHO in pure water (FIGS. 49G-49H). The FIG. 49G shows no change in individual FTR spectra of HCHO even after 7 days-no formation of C—O bonds. The FIG. 49H shows the FTIR spectra of the mixture of H₂O₂ and HCHO. The peak at 1026 cm⁻¹, corresponds to C—OH group of HCHO in water, gradually deceasing with the rise of a new peak at 1064 cm⁻¹, corresponds to C—O bonds, with time. It was ascribed that this new peak corresponds to the intermediate (HO)CHOOCH(OH). After 7 days, the C—OH group of HCHO in water completely disappeared with formation of new peaks at 1206 cm⁻¹ and 1711 cm⁻¹ which corresponds to HCOOH.

To elucidate the critical intermediates involved in H₂ production and the entire mechanistic pathway, we employed density functional theory (DFT-PBE) to compute the reaction energies for the catalytic and cascade reactions. The detailed reaction schemes for both reactions are illustrated in FIGS. 74A and 74B.

Based on literature reports^{4,6,1411}, the possible mechanistic pathway for the photocatalytic co-catalyst free H₂O₂-mediated H₂ production is proposed in FIG. 50A.

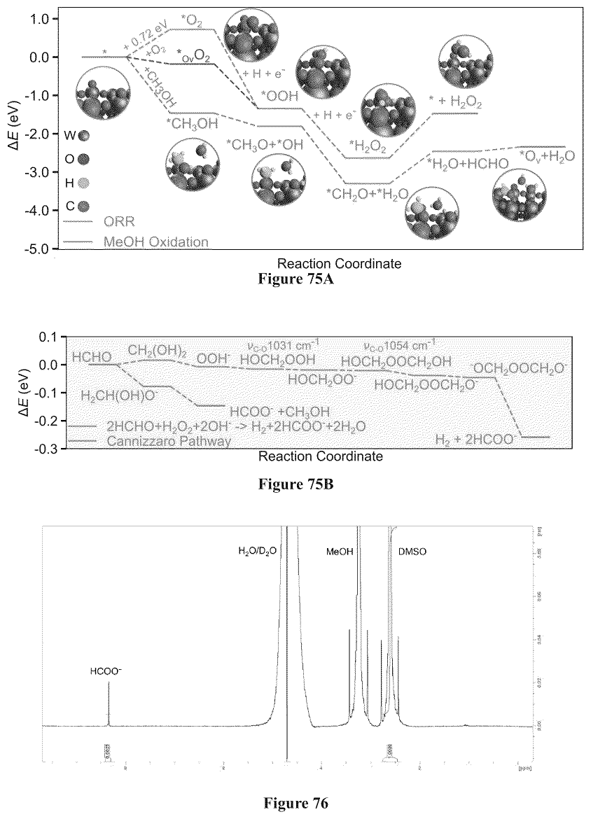

The reactions of the cascade in which H₂O₂ reacts with HCHO to produce H₂ and HCOOH are modeled without any catalyst via the mechanism proposed by Wieland and Wingler. They form HOCH₂OOH (hydroxymethylhydroperoxide), an intermediate that further reacts with HCHO to form HOCH2OOCH2OH (bis(hydroxymethyl)peroxide), which finally decomposes to molecular hydrogen and formate (FIG. 75B). Following a conformer search for the most stable HOCH2OOH and HOCH₂OOCH₂OH structures, the reaction energetics, intermediate vibrational frequencies, and a competing Cannizzaro pathway for formate and CH₃OH production are presented in FIG. 75B. The reaction energies for the formation of H₂ and HCOOH and the competing Cannizzaro pathway are exothermic and confirm their thermodynamic feasibility. The C—O vibrational frequencies of the HOCH₂OOH and HOCH₂OOCH₂OH intermediates (illustrated in FIG. 75B) are 1031 cm⁻¹ and 1054 cm⁻¹, respectively. The theoretical frequency of HOCH₂OOCH₂OH (1054 cm⁻¹) is in reasonable agreement with that experimentally observed at 1062 cm⁻¹, validating the formation of the HOCH2OOCH2OH intermediate and its role in the reaction pathway toward H₂ and HCOOH.

The methanol oxidation reaction and ORR leading to H₂O₂ and HCHO were modeled on the WO (001) surface. For methanol oxidation, the CH₃OH adsorption and the subsequent steps are exothermic in the presence of an explicit water molecule acting as the proton transfer mediator (FIG. 75A). For the ORR, O₂ adsorption on the pristine surface is endothermic (0.72 eV), but the subsequent proton-coupled electron transfer (PCET) reaction steps are exothermic (FIG. 75B). Instead, O₂ adsorption on the oxygen vacancy site formed during methanol oxidation is weakly exothermic (~0.18 eV), making ORR feasible. The surface vacancy replenishment, also feasible, competes with ORR. The WO3(001) surface construction and the computational details are outlined herein. Based on the above analysis and literature reports a possible mechanistic pathway for the photocatalytic cocatalyst free H₂O₂-mediated H₂ production is proposed in FIG. 50C.

Nash's reagent was prepared by dissolving 15 g of ammonium acetate, 300 μL of acetic acid, and 200 μL of acetylacetone in 100 mL of distilled water.22

After MeOH photooxidation experiment, 1 mL of the filtered reaction mixture was added to 1 mL of Nash's reagent and kept on a hotplate at 60° C. for 15 min. After cooling, the UV—vis absorbance spectra were recorded. Under these conditions, HCHO reacts with ammonium acetate and acetylacetone to produce 3,5-diacetyl-1,4-dihydrolutidine, which gives a characteristic absorption peak at 412 nm.

Upon visible-light illumination, photogenerated holes and electrons form in the photocatalyst. The holes oxidize each MeOH to HCHO and 2H+. The formation of HCHO was confirmed colorimetrically utilizing a Nash reagent (FIGS. 51A and 51B). Subsequently, the photogenerated electrons reduce O₂ through a two-electron reduction path to produce H₂O₂. The generated H₂O₂ immediately reacts with HCHO to form a corresponding HOCH₂OOH, which further reacts with another HCHO to produce HOCH₂OOCH₂OH. This HOCH₂OOCH₂OH rapidly converts to H₂ and two molecules of HCOOH.

As can be seen in FIG. SOA, it was suggested that the catalytic material is characterized by an having a Valence Band Maximum (VBM) and the Conduction Band Minimum (CBM) that allows the oxidization of a compound containing a hydroxy group to the respective aldehyde and in parallel the reduction of oxygen to hydrogen peroxide. It was suggested that the VBM is sufficiently positive to allow oxidization of a compound containing a hydroxy group to the respective aldehyde and the CBM is sufficiently negative to allow reduction of oxygen to hydrogen peroxide.

Upon visible-light illumination, photogenerated holes and electrons form in the WO₃. The holes oxidize MeOH to HCHO and 2 H⁺ are released. The electrons reduce 02 consuming 2 Hr in the process to produce H₂O₂ (a typical 2-electron ORR pathway). Then, H₂O₂ oxidizes HCHO in the solution to H₂ and HCOOH.

The formation of HCHO was confirmed by Nash method (FIG. 51). Subsequently, the photogenerated electrons reduce O₂ through a two-electron reduction path to produce H₂O₂. The generated H₂O₂ immediately reacts with HCHO to form a corresponding HOOCH(OH), which further reacts with another HCHO to produce (HO)CHOOCH(OH).¹¹ This (HO)CHOOCH(OH) rapidly converts to H₂ and two molecules of HCOOH.

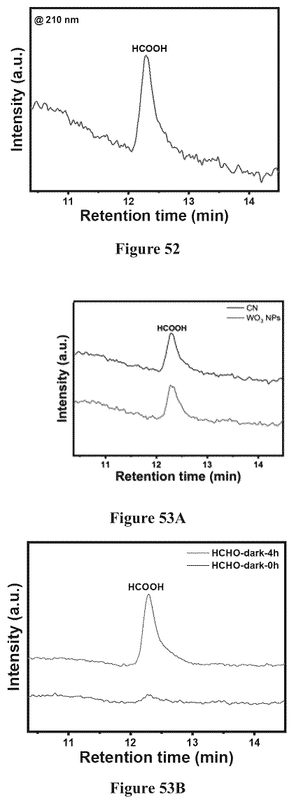

To further prove the reaction pathway for H₂ and HCOOH, the amount of HCOOH obtained after 4 h using CN photocatalyst was quantified. After 4 h, the CN produced −23 μmol of HCOOH (FIG. 52 and FIG. 53A), which is higher than theoretically expected (17 μmol). Under alkaline conditions at elevated temperatures, the formed HCHO can undergo Cannizzaro reaction (eq S3) via pathway to produce HCOOH and MeOH.

Thus, a controlled experiment was performed in dark by directly taking 1 mL of HCHO (37 wt. %) in 0.1 M NaOH in a quartz tube and magnetically stirred at 40° C. After 4 h, of MeOH photooxidation experiment using CN and WO₃ NPs as the photocatalyst or a control experiment in the dark without catalyst, 10 μL of the filtered reaction mixture was diluted to 1 mL using 0.05 M H₂SO₄ solution and injected into the HPLC instrument.

The HPLC analysis reveals the formation of ~23 μmol of HCOOH from CN photocatalytic experiment (FIG. 53A), which is somewhat higher than the expected yield (17 μmol) from the obtained H₂ yield (8.5 μmol) according to Eq. S1 and Eq. S2. The HPLC analysis of the reaction mixture obtained from dark experiments also shows the formation of HCOOH (FIG. 53B), confirming that excess formed or unreacted HCHO can undergo a Cannizzaro reaction in alkaline medium (Eq. S3) at elevated temperatures (40° C.) to produce HCOOH and MeOH. only negligible amount of H₂(0.12 μmol) produced, which is-71 times lower than that MeOH photooxidation using CN (8.5 μmol). This further supports the excess HCOOH formed during CN photocatalysis experiments.

For WO₃ NPs, we obtained ~22 μmol of HCOOH after 4 h, which is higher than the expected HCOOH yield (10.6 μmol) from the obtained H₂ yield (5.3 μmol). The excess HCOOH in the case of WO₃ NPs, might stem from the deep oxidation of MeOH due to the highly positive valence band of WO₃ or the possible presence of hydroxyl radicals.

### MeOH Photooxidation Reaction:

$$2 {CH}_{3} OH + 2 {O}_{2} \to 2 {H}_{2} {O}_{2} + 2 HCHO \qquad ( Eq . S1 )$$

$$2 {H}_{2} {O}_{2} + 2 HCHO \to {H}_{2} + 2 HCOOH + {H}_{2} {O}_{2} \qquad ( Eq . S2 )$$

### Cannizzaro Reaction:

$$2 HCHO + {HO}^{-} \to {HCOO}^{-} + {CH}_{3} OH \qquad ( Eq . S3 )$$

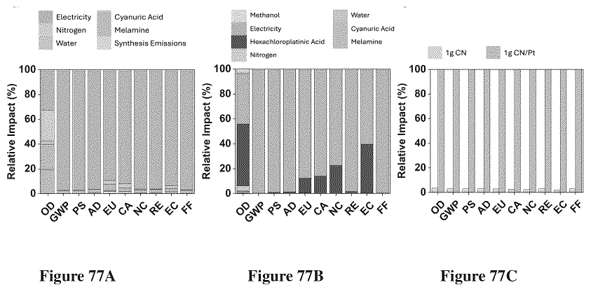

The HPLC analysis of HCHO dark reaction showed the formation of HCOOH (FIG. 53B). This strongly supports the excess HCOOH yield obtained during CN photocatalysis might be due to the side reaction of HCHO to HCOOH due to possible Cannizzaro pathway and also has no contribution in H₂ generation. Furthermore, proton nuclear magnetic resonance (111 NMR) analysis of the reaction mixture obtained after another photooxidation experiment using a CN photocatalyst also confirms the formation of HCOOH (FIG. 76). To measure 1H-NMR, first, a 4 h of photocatalytic experiment was performed where 200 μL MeOH were mixed with 5 mL of 0.1 M NaOH and continuously stirred CN powder (15 mg) served as the photocatalyst under illumination. After 4 h, the reaction tube was kept in the dark for several days to ensure complete reaction of the photocatalytically formed H₂O₂ and HCHO to produce the product of the cascade reaction, HCOOH. For the NMR analysis, 100 μL D2O, 25 μL DMSO, and 875 μL of the filtered reaction mixture were placed in an NMR tube.

In addition, some control experiments were performed with CN photocatalyst with 1 mL of commercial HCHO (37 wt. %) and HCOOH (98%) instead of MeOH in 0.1 M NaOH at 40° C. to understand the H₂ production mechanism (FIGS. 50B and FIG. 50D). In presence of HCHO (37 wt. %), the CN produced 7.3 μmol of H₂, which might be due photooxidation of 10-15% MeOH present in HCHO solution as stabilizer. After 24 h, the yield increased to 13 μmol only, which is lesser than that of with pure MeOH experiment (FIG. 54). To further verify the possibility of the direct photo-oxidation of HCHO to H₂, same experiment were performed under Ar atmosphere. After 4 h, only 1.8 pmol of H₂ was produced. This further confirms the majority of H₂ is being produced from the reaction of photo generated H₂O₂ and HCHO. Moreover, it can also be predicted that the formed HCHO during MeOH photooxidation directly converts to HCOOH—which subsequently decompose over CN photocatalyst with the aid holes or reaction with generated H₂O₂ to produce H₂. Therefore, another photocatalytic control experiment was performed by directly taking commercial HCOOH (98% purity) instead of MeOH under the same experimental conditions. After 4 h, the CN produced only 0.2 μmol of H₂, which is ~42 times lower than that the same experiment using MeOH (8.5 μmol). After 24 h, the yield reached to only 0.5 μmol (FIG. 54). This observation strongly confirms the H₂ is not produced from HCOOH decomposition. Therefore, based on these controlled experiments (FIG. 50B and FIG. 50D) and previously discussed dark experiments (FIG. 48), it is concluded that the H₂ is only generating from the reaction of in situ generated H₂O₂ and HCHO during MeOH photooxidation.

### Scalability Tests

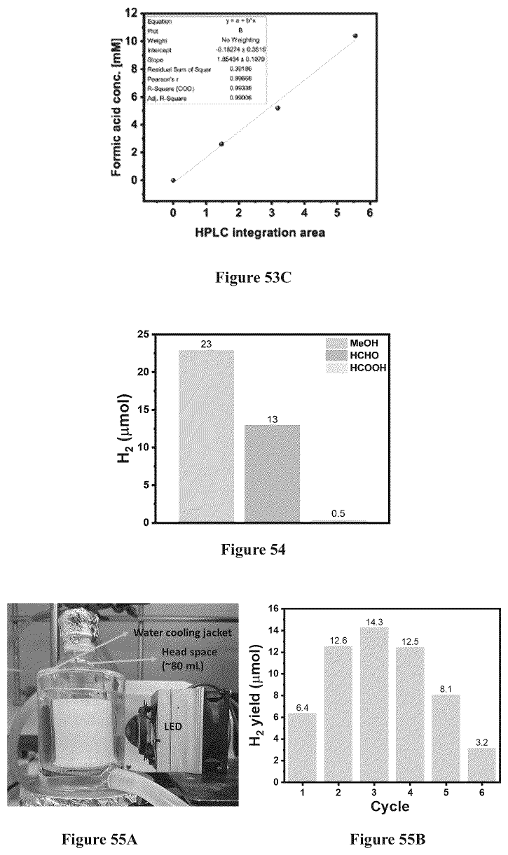

To demonstrate the scalability, batch reaction with 200 mg of CN photocatalyst was performed. The reaction yielded 18 mol of H₂ after 4 h (FIG. 55A). It should be noted that the CN produces H₂O₂ and HCHO during light irradiation and the produced H₂O₂ and HCHO reacts with each other and generates H₂ and HCOOH, which is independent of light. So, after light off, an additional 8 μmol of H₂ after 19 h in dark was also observed. Overall, the H₂ yield was 26 μmol after 4 h light and 19 h dark reaction. Further, a cycle experiments with 20 mg of CNphotocatalyst (FIG. 55B) was also done. After each cycle, the reaction mixture is degassed for 5 min under sonication and sealed again with fresh air. The reaction mixture was stirred in dark for 15 min prior to light irradiation. It was noticed a small amount of H₂ in each cycle after 15 min stirring in dark, which is might due to the reaction of left over H₂O₂ with excess of HCHO formed from previous cycle. The obtained amount H₂ was subtracted from each cycle when estimating the H₂ after 4 h in light. Overall, the 6 cycles (24 h, 4 h each) yielded 57 μmol of H₂, which is higher than the direct 24 h experiment performed earlier (23 μmol) in single cycle (the 02 is consumed during the reaction). The increased H₂ yield in the initial cycles might be due to the reaction of left over H₂O₂ and HCHO or availability of excess of HCHO obtained in the previous cycle, which might act as a better hole scavenger instead of MeOH to promote ORR. This encouraging results in cycle experiments could enable to optimize a flow reactor system with controlled air flow—can generate H₂ continuously without aid of any dedicated gas separation setup.

Additionally, we performed another cycle experiment for 6 days (24 h per cycle (FIG. 55C). The H₂ yield increased from the first to the second cycle and then decreased gradually in the next cycles. The upward and downward trends are similar to ones observed in the earlier 24 h cycle experiment.

The significant decrease in H₂ yield after the second cycle might be attributed to the decreasing concentration of MeOH; to test this hypothesis, before the fifth cycle, we added 1 mL of fresh MeOH to the solution. The H₂ yield did not improve but continued to decrease. This decrease, even after the addition of MeOH, might result from the lowering the solution pH caused by the continuous consumption of OH—over the 4 cycles. As shown earlier (FIG. 74A and FIG. 48) the reaction between H₂O₂ and HCHO to form H₂ and HCOOH occurs much more readily at high pH. Therefore, to evaluate the influence of pH, in the sixth cycle, we replaced the reaction solution with a fresh MeOH solution (20% vol MeOH in 0.08 M NaOH) and observed a dramatic increase in H₂ yield. After 5 cycles of operation (5 days), CN retained ~71% of its initial activity (FIG. 55C). This shows the promising stability of CN for prolonged usage under these experimental conditions.

To further understand the influence of pH in the reaction, we performed another set of cycle experiments in 0.20 M NaOH for 6 days (24 h per cycle), in which we measured the pH of the reaction mixture after each cycle (FIG. 50E). The reactions in 0.20 M NaOH exhibit similar trends to earlier experiments: the H₂ yield decreases with decreasing solution pH. After the fifth cycle, the solution pH reached ~7.3. In the sixth cycle, the pH of the reaction mixture was brought to ~13.4 by adding 0.5 mL of 2 M NaOH, and H₂ production increased dramatically. This shows the promising ability of CN to withstand prolonged use and maintain its performance as long as the solution pH is maintained.

Finally, we performed a 10-day recyclability experiment in 0.20 M NaOH solution, in which every 24 h, the air was replaced, and every 48 h, the solution was replaced (FIG. 50F). The CN photocatalyst showed good stability throughout five cycles; the activity was slightly reduced after the second cycle, but it then remained stable over the next 3 cycles. After the fifth cycle, the catalyst was washed and dried (~87.5% was recovered). Additionally, we have quantified the HCOOH after each 48 h cycle, showing a stable HCOOH production (FIG. 72). The recovered catalyst was analyzed by UV—vis and FTIR spectroscopy. The UV—vis and FTIR spectra of the CN after 10 days of reaction exhibit some minor changes compared to the fresh CN, which might be associated with the slight decline in activity after the second cycle (FIG. 72).

The photocatalytic method for hydrogen production presented in this research offers several advantages over conventional HER methods including, (i) the omission of a precious metal cocatalyst, (ii) the elimination of carbon dioxide coproduction, and (iii) the generation of a value-added product formic acid (compared with 02). Cocatalysts, such as platinum, have been employed with carbon nitride to enhance hydrogen production,25-27 yet such metals are associated with substantial environmental costs (i.e., environmental impacts, high resource demand) associated with their mining, extraction, and refinement processing.28,29 Furthermore, platinum is a finite resource and is categorized as a critical mineral, indicating an imbalance of its supply and demand. To further underscore the advantage of the presented cocatalyst free CN system we conducted a life cycle impact assessment (LCIA) (see Tables 4-8 for details on the inventory and uncertainty analysis, respectively).

The primary contributor to environmental impacts for the CN only and CN/Pt systems are electricity use during the synthesis. For the CN system, nitrogen used for providing inert atmosphere and cyanuric acid and melamine precursors also contribute substantially to the ozone depletion impact category (FIG. 77A). For the CN/Pt system, the H2PtCl6 precursor contributes substantially (11-49%) to several of the impact categories (FIG. 77B), ozone depletion, eutrophication potential, carcinogens, noncarcinogens, and ecotoxicity impacts), which emerges from extraction and processing of the platinum reagent. The assessment results highlight that energy demand (from electricity use) during synthesis is the predominant contributor to the environmental footprint in both material systems with >60% in all categories, except ozone depletion (OD), and as much as 99% for both CN and CN/Pt. Considerations on ways to reduce impacts from energy and N2 use, including the potential to adopt renewable energy sources and N2 recycling, are discussed below. A comparative analysis of the total synthesis impacts for the two material systems (FIG. 77C) reveals that the relative environmental impacts of the CN/Pt synthesis far exceed that of the CN system presented herein (e.g., the global warming potential, GWP, for the synthesis of CN/Pt is more than ×34 that of the synthesis of CN; 39 and 1322 kg CO2 equiv per gram for CN and CN/Pt, respectively). An additional benefit of the CN-only photocatalytic system is the elimination of CO2 generation. Quantifying the associated CO2 equivalents provides a CO2 credit to the CN only system. Yet, at the current lab scale, the magnitude is quite low, 5.06 g CO2 equiv per 1 kg CN/Pt. Incorporation of this carbon credit is prudent with future scale-up.

Based on our rough cost estimations discussed below, the overall estimated catalyst cost using the reported new approach is more than ×5 times cheaper compared to conventional HER using CN/Pt for the same hydrogen average production rate of 1 L h-1.

Moreover, a Pt cocatalyst is prone to CO poisoning or leaching from the catalyst surface, a problem which is completely ruled out in our proposed H2 production approach, facilitating scaleup for long-term application. Since recyclability is significantly easier for single-component systems, we propose that the potential lifetime of the Pt-free photocatalytic system can be enhanced by another order of magnitude, leading to a total of >15 times reduction in photocatalyst cost per L of produced H2. Additionally, this approach enables the use of other ORR active catalysts for H2 production; future studies may focus on developing low-cost photocatalysts with extended visible-light absorption to advance H2 production under natural sunlight without relying on a cocatalyst.

Furthermore, a binder-free CN panel was also prepared to demonstrate H₂ production in a batch configuration over a 1 cm² panel (specifically, CN_{MCA}). After 24 h, the CN panel produced around 1.1 μmol of H₂ with rate of 460 μmol h⁻¹ m⁻², which further demonstrates the ability to scale this ORR-mediated H₂ production approach technology using large-scale flow reactors.

### Renewable Energy Sources and N2 Recycling Offer Avenues to Reduce the Per Mass Environmental Impact

To explore the contribution of energy demand and nitrogen-gas use on the potential reduction in the impacts of the CN synthesis, we closely examined these components. For electricity, the analysis used the “Electricity country mix—Low Voltage—Electricity, at grid, US/US,” which represents a mix of multiple energy sources: biomass, coal, petroleum, geothermal, natural gas, nuclear, solar, hydroelectric, and wind.

While energy demand per unit mass of CN and CN/Pt is expected to decrease with production scale-up, energy consumption is likely to remain a dominant factor influencing material synthesis impacts. Alternative sources of energy, such as solar, have the potential to offset the impacts of synthesis energy demand. Considering the growing solar energy infrastructure in Israel (where CN synthesis was carried out, and future work on scale-up for hydrogen generation is planned) and globally, we modeled an LCIA scenario assuming solar generated electricity as the energy source. The results (Table 6) indicate a substantial reduction in environmental impacts, with the GWP per gram of CN decreasing by nearly 94% (comparing impact values in Table 7 with those in Table 6). Further investigating into the processes contributing to the nitrogen-related impacts revealed that the cryogenic air separation process used in liquid nitrogen production, along with its associated electricity consumption, accounts for most of the nitrogen's environmental impact. This insight suggests that recycling nitrogen gas during a scaled-up CN synthesis could further reduce its environmental footprint.

### CO₂—Free Hydrogen Generation via CN Photocatalysis: A Sustainable Alternative to CN/Pt

The overall reaction for hydrogen production over a CN/Pt photocatalyst (‘standard’ photocatalysis, where Pt serves as the HER co-catalyst, and MeOH as a hole scavenger) is:

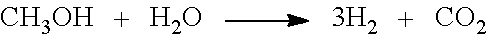

The overall reaction for hydrogen production over a CN photocatalyst (via the reported cascade approach) is:

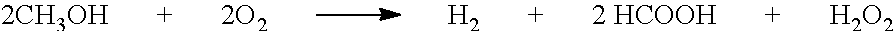

TABLE 8
Cost calculation for H2 production using ‘standard’ Pt co-catalyst-assisted
photocatalysis vs. the reported co-catalyst-free cascade approach.

| | [symbol] H2 | Estimated H₂ | | | | | |
|---|---|---|---|---|---|---|---|
| | evolution | production | Amount of | | | | |
| | rate | rate using 1 | Pt needed | | Catalyst | Overall | [symbol] ost/L |
| | (μmol | kg catalyst | for 1 kg of | Pt cost | cost | cost | of H₂ h⁻¹ |
| | h⁻¹ g⁻¹) | (L h⁻¹) | catalyst | (USD) | (USD) | (USD) | (USD) |
| 3% Pt@CN [‘standard’ | [symbol] 45 | 7.7 | 30 g | ^{b} 7020 | ^{c}413 | 7020 | 9 [symbol] 65 |
| photocatalysis] | | | (3% wt.) | | | | |
| CN [reported | [symbol] 07 | 2.4 | — | — | ^{c}413 | 413 | 1 [symbol] 72 |
| photocatalytic cascade | | | | | | | |
| reaction] | | | | | | | |

^{a}The average H₂ production rate that was experimentally measured for a 4 h reaction is used as a constant rate.
^{b} The cost was estimated from the required 8% wt. chloroplatinic acid (H₂PtCl₆) solution to deposit 30 g of Pt on 1 kg of CN.
^{c}The costs associated with CN catalyst synthesis. [symbol]
indicates data missing or illegible when filed

### CN Catalyst Cost Estimation:

The cost of 1 kg of melamine is ~47.05 USD (price taken from the Sigma-Aldrich website, accessed on 22/04/2025, list price of product no. M2659).

The cost of 1 kg of cyanuric acid is ~101 USD (price taken from the Sigma-Aldrich website, accessed on 22/04/2025, list price of product no. 8203581000).

The calculated mass-based yield (%) for CN from MCA is ~18%.

To produce 1 kg of CN,-5.6 kg of MCA precursor is needed.

The cost for 1 kg of CN would be ~413 USD.

### Pt

### Pt Cost Estimation:

For 30 g Pt (~0.154 mol), ~63.02 g of H2PtCl6 is required.

For 63.02 g of chloroplatinic acid,-788 g or 750 mL of 8% wt. chloroplatinic acid (H2PtCl6) solution is required.

The cost of 250 mL of 8% wt. chloroplatinic acid (H2PtCl6) solution is ~2340 USD (price taken from the Sigma-Aldrich website, accessed on 22/04/2025, list price of product no. 262587).

### Relative Cost of Operation:

Normalizing the photocatalyst synthesis cost to relevant H2 production rate (assumed constant; in units of L h-1) shows that the proposed co-catalyst-free photocatalytic cascade approach using CN is ~5.6 times cheaper than the traditional Pt-decorated CN photocatalysis (172 vs. 965 USD h LH2-1).

### CONCLUSIONS

We demonstrate a new photocatalytic route to produce H2 without the restrictions associated with the common photocatalytic path. Our approach enables H2 production by semiconductors inactive in HER (e.g., WO₃), without the need for any cocatalyst, using only oxygen from air and MeOH. Under illumination, a cascade reaction occurs, whereby photogenerated H2O2 and HCHO further react, leading to H2 and formic acid formation. The reaction mechanism was confirmed by experimental and theoretical studies, verifying the reaction path and intermediates. Notably, the absence of cocatalysts (Pt) and the formation of a single valuable chemical in the aqueous phase (formic acid) significantly reduce the overall costs not just the price tag but also the ecological footprint of the catalytic system. This strategic cascade system paves the way toward application of photocatalytic systems that offer bandgap flexibility, reduce total energy consumption, and avoid the energy intensive liquid product separation. Furthermore, our approach increases photocatalyst stability and eliminates oxidative degradation.

We envision that the described route would excite development of novel, thus far disregarded, “HER inactive” photocatalysts for H2 production.

### Example 8: Preparation and Characterization of Plastic-Based Photocatalytic Panels

### Materials and Methods

### Chemicals

Deionized (DI) water was purified using a Millipore Direct-Q system (18.2MΩ cm resistivity). All other chemicals were purchased from the indicated commercial vendors and used as received: hydrochloric acid (HCl, 32 wt %, AR) and ethanol (EtOH, absolute 99.9%) from Bio-Lab, Israel; high-density polyethylene (HDPE) melt index 2.2 g/10 min (190° C./2.16 kg), titanium (IV) oxide, anatase, nanopowder, <25 nm particle size, 99.7% trace metal basis, tungsten (VI) oxide, nanopowder, <100 nm particle size (TEM), zinc oxide, nanopowder, <100 nm particle size, bismuth (III) oxide nanopowder, 90-120 nm particle size, 99.8% trace metals basis, melamine (M, 99%), and chloroplatinic acid solution (8 wt % H₂PtCl6 in H₂O) from Sigma Aldrich.

### Synthesis

Melem and the CN photocatalysts were synthesized as follows:

### Melem

Melem was synthesized via thermal condensation of melamine under a nitrogen atmosphere at 425° C. for 12 h; the target temperature of 425° C. was reached at a heating rate of 5° C. min⁻¹ and finally washed several times with hot water to get rid of smaller condensates (i.e., unreacted melamine or partially reacted species).

### 2-Cl-Mlm Precursor

The precursors for the CN synthesis were supramolecular assemblies based on the melem-halogen (mlm-Cl) interaction; 2 stands for the molar Cl:melem ratio in the starting mixture: first, 0.50±0.01 g of the synthesized melem was dispersed in 25 mL of an aqueous solution containing 2.0 vol % of concentrated HCl 32 wt. %. To achieve dispersion, the mixture was subjected to a 3 min sonication followed by shaking for 24 h. The dispersion was then poured into large borosilicate-glass Petri dish and left to dry and crystallize at room temperature for three days (this is the precursor).

### CN-2-Cl-mlm

The addition of the prefix “CN—” denotes the precursor has gone through thermal condensation process to give the CN photocatalyst. 0.67 f 0.01 g of the precursor was calcined in an alumina crucible (total capacity 20 mL), with a lid in a muffle furnace (under air, heating rate of 5° C. min⁻¹ to the target temperature of 550° C.) for 4 h to obtain the CN material as the product.

### Photocatalyst/HDPE Panel

HDPE was melted in an alumina template with dimensions of 6.7×6.7 cm², and while the HDPE was in a molten state, a photocatalyst powder (Bi₂O₃, ZnO, WO₃, TiO₂, or polymeric carbon nitride (CN)) was spread on top and lightly pressed into the molten HDPE panel. Then cooled down back to room temperature and solidified around the photocatalyst powder, physically holding a thin layer of the photocatalyst—these are the photocatalytic panels.

### Results

FIG. 56 shows schematic representation of the panel preparation process. As can be seen, an HDPE source (here, in the form of beads) is melted at 220° C. in an alumina template (demonstrated, size of 6.7×6.7 cm²), then the photocatalyst powder (as a representative example, CN) is spread and lightly pressed into the molten HDPE, and left to cool down to room temperature under ambient conditions. The inset shows scanning electron microscopy (SEM) image of the CN/HDPE panel (CN highlighted with a light-yellow hue).

FIGS. 57A-57B show digital photos of FIG. 57A HDPE plastic waste as the source material, FIG. 57B dispersed CN powder in the reaction vessel; bottom: plastic waste melted, with CN powder spread on it using the demonstrated method. photocatalytic HER batch configuration, top: powder; bottom: CN/HDPE panel.

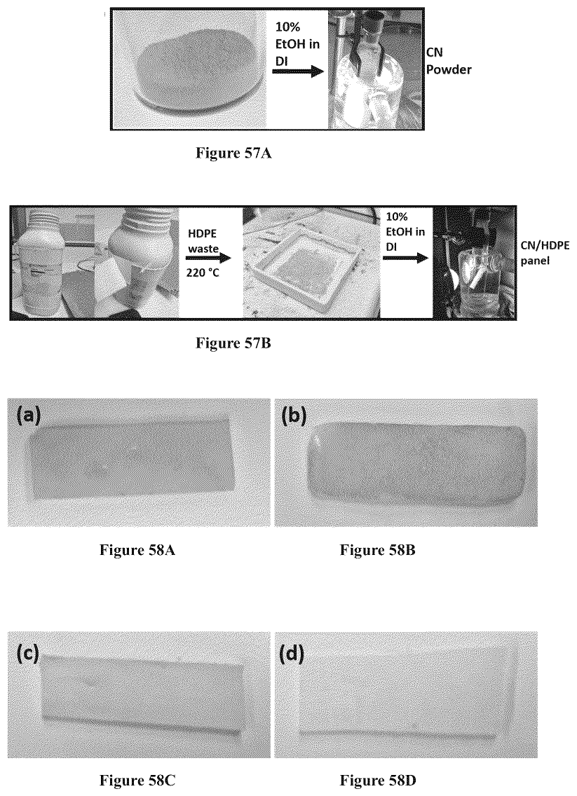

FIG. 58A-58D are digital photographs of different photocatalytic HDPE panels. As can be seen, the variety of HDPE-based panel such as Bi₂O₃/HDPE (FIG. 58A), WO₃/HDPE (FIG. 58B), TiO₂/IDPE (FIG. 58C), and ZnO/HDPE (FIG. 58D) can be prepared.

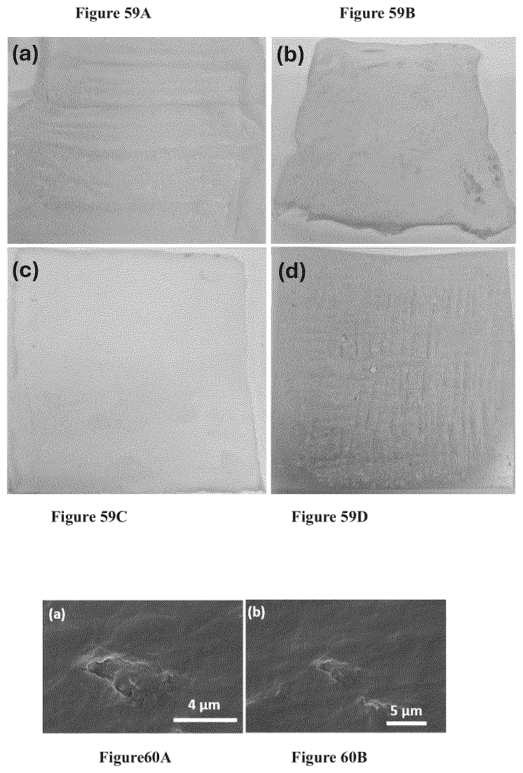

FIGS. 59A-59D illustrates the generality in picking the plastic support, as it is possible to choose any thermoplastic material with a lower melting temperature than the degradation temperature of the deposited photocatalyst.

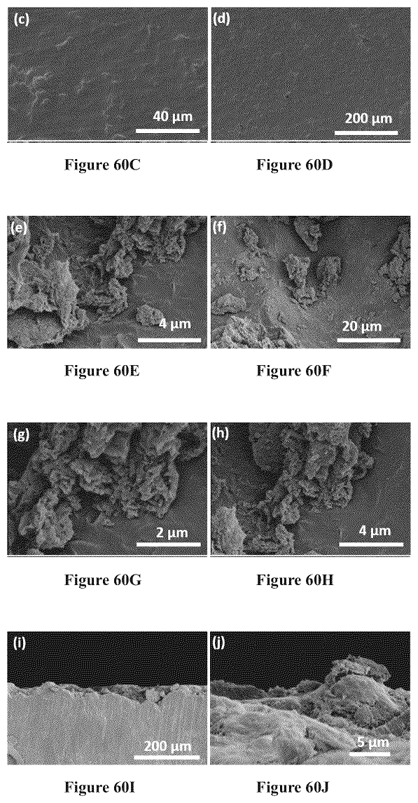

FIG. 60A-60J show SEM images of a pristine HDPE surface and CN-2-Cl-mlm/HDPE panel (surface and cross-section). It is clear that the pristine HDPE has a very smooth surface while the CN deposited on its surface exhibits surface roughness as a result of the deposition of CN particles, partially immersed in the HDPE substrate acting as support. From the cross-section it is evident that the CN layer is very thin in the order of several μm.

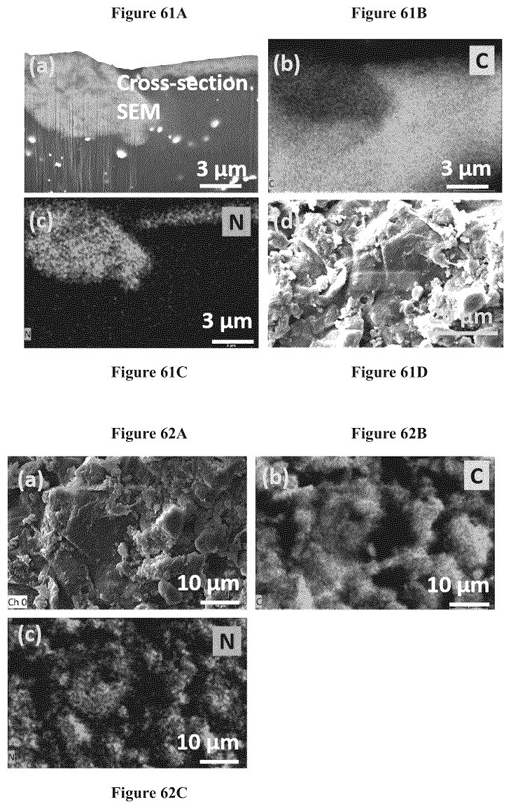

FIGS. 61 and 62 show the distribution of CN on the panel in the form of clusters. FIB cross-section SEM EDS mapping illustrates a grain of CN (both C and N elements) in the HDPE platform (only carbon). This configuration stems from the solidification of the molten plastic around CN grains, physically holding them in place.

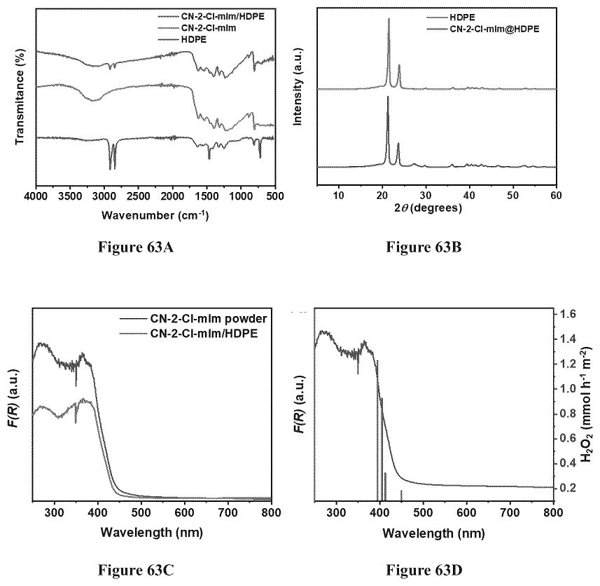

As shown in FIG. 63, the FTIR, XRD, and UN-vis absorption spectra of CN-2-Cl-mlm/HDPE panel show either a combination of the HDPE and CN-2-Cl-mlm powder patterns, or properties similar to the CN powder, with no additional contribution from the combination. It suggests insignificant chemical interaction between the CN powder and the HDPE surface. FIG. 63D shows the action spectrum of CN-2-Cl-mlm/HDPE panel, where a correlation between the optical absorption of the CN semiconductor and the photocatalytic activity at specific wavelength irradiation is established.

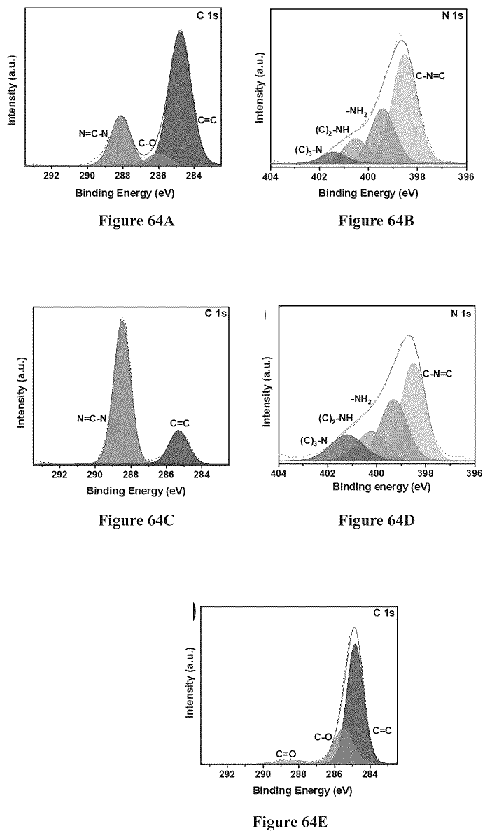

FIGS. 64A-64E show the XPS data of the pristine HDPE panel, the CN powder (CN-2-Cl-mlm), and the CN/HDPE panel. The C is spectra show that the CN/HDPE panel exhibits a combination of the CN powder and pristine HDPE features.

This is direct evidence that both surfaces are exposed, which should allow access to reactant molecules to the photocatalyst during a photocatalytic reaction on the one hand, and protection from surface agglomeration since HDPE signal indicates the CN is partially embedded within the HDPE. There is no evidence of covalent chemical bonds since no binding energy shifts are measured for neither CN nor HDPE. The N is spectra similarly suggest no chemical modification of the CN-2-Cl-mlm powder when it is held on the HDPE panel.

### Examide 9: H₂O₂ Production Using HDPE-Based Photocatalytic Panels

### Materials and Methods

### ORR

ORR experiments were performed in a flow reactor configuration. Typically, a 5×5 cm² panel was placed inside a flow reactor of 25 cm² volume with 80 f 0.5 mL reservoir of 10 vol % EOH in DI. The reaction mixture was circulated between the reactor and reservoir with a peristaltic pump with a flow rate of −1 mL min⁻¹. Oxygen was continuously bubbled through the solution in the solvent reservoir. The temperature of the solvent reservoir was kept constant (25° C.) during the reaction using a circulating water jacket coupled to a chiller. The produced H₂O₂ was quantified by iodometry.

### Results

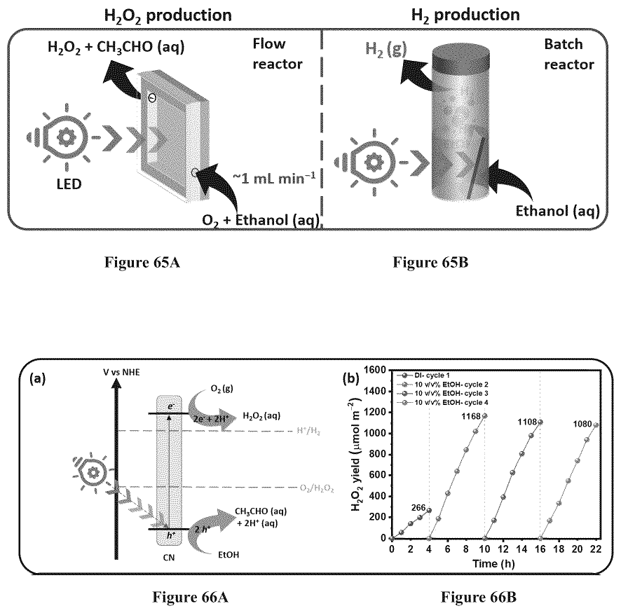

FIGS. 65A-65B show schematic representation of flow and batch photocatalytic processes. As can be seen in FIG. 65A, the oxygen reduction reaction (ORR) occurs in the flow reactor configuration, 25 cm² panel with a 100 mL reservoir of O₂ saturated 10% EtOH in DI, at a flow rate of 1 mL min⁻¹.

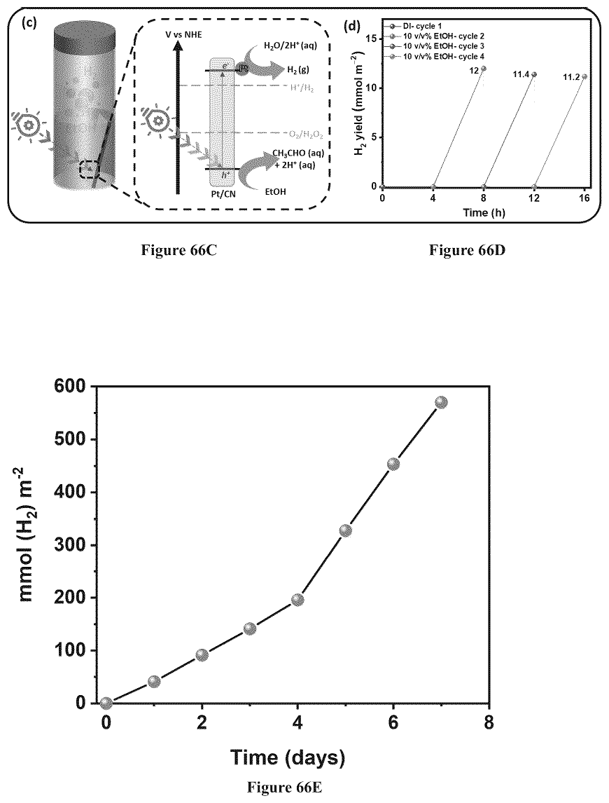

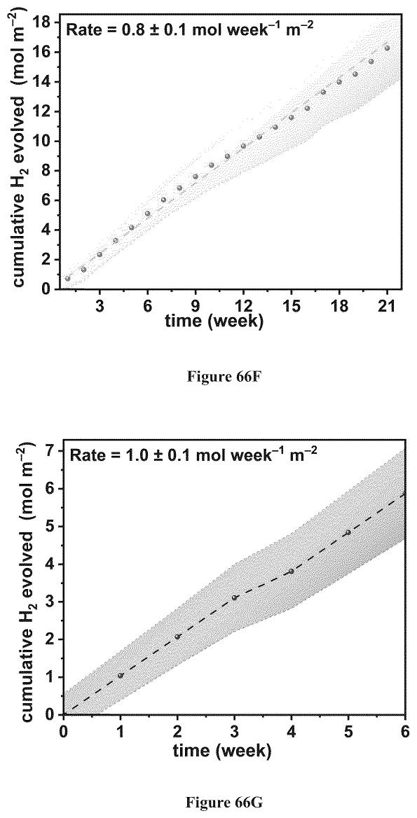

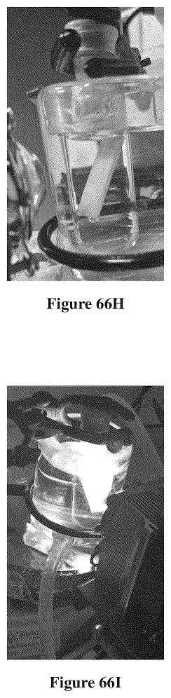

FIG. 66 shows the stability cycles of the CN-2-Cl-mlm/HDPE panel used for both in photocatalytic HER (using a Pt cocatalyst) and photocatalytic metal-free ORR. Demonstrating highly stable performance in both cases. For HER, retaining 93.3% activity after 12 hours, which is significantly more stable than the powder reaction, retaining only 80% after 10 hours. The ORR performance shows high stability retaining 92% of its initial photocatalytic reaction rate after 18 hours of reaction, while for powder reactions this reaction rarely passes 3 hours of stable photocatalytic performance. These photocatalytic experiments are performed under 100 W white LED illumination. Changing the light source to a solar simulator (100 W Xe lamp source with AM 1.5G and water filters, 100 W cm⁻²) results in an activity of 442 μmol (H₂O₂) h⁻¹ m⁻² for 3 hours. The long-term operation for a week in FIG. 66E demonstrates the stability of this photocatalytic panel towards the hydrogen evolution reaction.

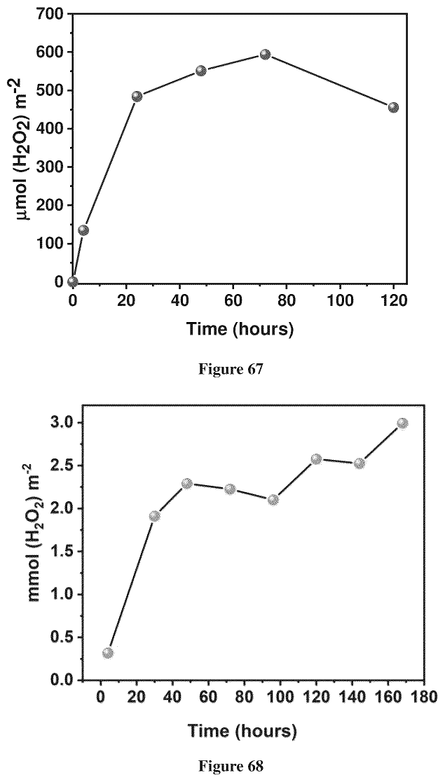

FIG. 67 shows long-term H₂O₂ production (ORR) using a 5×5 cm² CN-2-Cl-mlm/HDPE panel, in a flow reactor configuration with a 100 mL of 1 M D-Glucose in DI reservoir, and a 25 cm² cell, under 100 W white LED illumination and oxygen atmosphere.

FIG. 68 shows H₂O₂ production (ORR) using a 5×5 cm² CN-2-Cl-mlm/HDPE panel, in a flow reactor configuration with a 100 mL of 0.36 M of 4-methoxy benzyl alcohol in DI reservoir, and a 25 cm² cell, under 100 W white LED illumination and oxygen atmosphere.

As can be seen in these figures, long-term stability under operational conditions is demonstrated using the CN/HDPE panel for continuous-three week operation: first, for two weeks, H₂O₂-assisted glucose oxidation was performed (FIG. 67), and subsequently, the same panel was used for another week to perform 4-methoxy benzyl alcohol oxidation (FIG. 68).

FIG. 68 shows H₂O₂ production with a 5×5 cm² CN-2-Cl-mlm/HDPE panel, in a flow reactor configuration with a 100 mL of 1 M, D-Glucose in DI reservoir, and a 25 cm² cell, under 100 W white LED illumination and oxygen atmosphere. As can be seen from FIG. 68, the amount of H₂O₂ increases over 72 h reaction time. FIG. 68 shows the ORR activity towards peroxide production, and 4-methoxy benzyl alcohol oxidation, in a flow cell on the same panel where the glucose oxidation took place, back to back experiments, resulted in a ~78% conversion of 4-methoxy benzyl alcohol after one week (168 h) of the photocatalytic process. This result signifies a conversion rate of ~6.67 mmol h⁻¹ m⁻² over a full week, showing that the panel is still active for different reactions where the cell was only washed with DI in between.

Additional experiments were performed to evaluate the stability and reusability of a CN|HDPE catalytic panel in sequential photocatalytic reactions under oxygen reduction reaction (ORR) conditions.

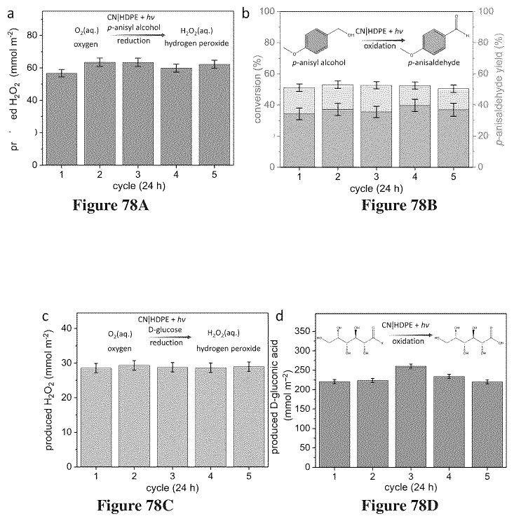

As shown in FIG. 78A, photocatalytic ORR in the presence of p-anisyl alcohol (0.010 M) was carried out over five consecutive cycles of 24 hours each. Between cycles, the panel was washed with water without replacement of the catalytic material. The CN|HDPE panel retained substantially constant hydrogen peroxide (H₂O₂) production rates over the five cycles, with an average rate of about 2.38 mmol h⁻¹ m⁻².

As shown in FIG. 78B, the corresponding oxidation of p-anisyl alcohol to p-anisaldehyde proceeded with consistent conversion and yield over the five cycles. The reaction exhibited an average selectivity of approximately 72.6% toward p-anisaldehyde, indicating stable catalytic performance over a cumulative operation time of about 120 hours.

Following completion of the p-anisyl alcohol experiments, the same CN|HDPE panel was washed with deionized water and reused for additional photocatalytic reactions.

As shown in FIG. 78C, photocatalytic ORR was performed in the presence of D-glucose (0.100 M) over five additional cycles of 24 hours each. The panel maintained stable H₂O₂ production, with an average rate of about 1.20 mmol h⁻¹ m⁻² over the additional operation period.

As shown in FIG. 78D, concurrent oxidation of glucose resulted in the formation of D-gluconic acid, with an average production rate of about 7.32 mmol h-¹ m⁻², indicating sustained oxidation activity.

The cumulative operation time of the same catalytic panel across the sequential experiments exceeded approximately 500 hours. No substantial degradation of the catalytic material or leaching from the polymeric substrate was observed.

These results demonstrate that the CN|HDPE catalytic panel can be reused for multiple sequential photocatalytic reactions involving different substrates while maintaining photocatalytic activity under ORR conditions.

### Example 10: H₂ Production Using HDPE-Based Photocatalytic Panels

### Materials and Methods

### Photocatalytic Performance Evaluations.

### Hydrogen Evolution Reaction (HER)

Photocatalytic HER reactions were carried out in a batch configuration, which means measured in a cylindrical quartz reactor with the dimensions of 1.5 cm inner diameter and height of 6.0 cm (in the cylindrical area), total volume of 29.50±0.25 cm³. First, a Pt cocatalyst was photodeposited on the CN-2-Cl-mlm/HDPE panel via photodeposition technique: 10±0.1 mL of 10 vol % EtOH in DI, 10 μL of chloroplatinic acid and either a photocatalytic panel with the dimensions of 1×4 cm² or 15 mg powder were added to the reactor, which was then sealed with a rubber septum and washed with high purity Ar(g). Then the reactor was irradiated with a 100 W white LED for 30 minutes. Then the Pt deposited panel or powder (over a Whatman #1 filter paper and a Büchner funnel) were taken out and washed with DI to get rid of residual EtOH. Then the panel or 5.0 f 0.1 mg powder were reinserted to a clean quartz reactor and 10 f 0.1 mL of 10% EtOH in DI were added, the reactors headspace was washed with high purity Ar(g) and sealed with a rubber septum, and the reactor was irradiated with the white LED for the photocatalytic reaction duration.

### Results

The hydrogen evolution reaction (HER) was performed in a batch configuration (FIG. 65B), 4.0 cm² panel with Pt nanoparticles photodeposited prior to reaction) with 10 mL of 10% EtOH in DI and 18.5 mL headspace washed with 99.999% argon gas.

FIG. 66C schematic representation of energy diagram of photocatalytic HER in a batch reaction over a Pt@CN-2-Cl-mlm/HDPE panel; (the first 4 h cycle is performed in pure DI, followed by three subsequent 4 h cycles in the presence of 10% v/v EtOH (in DI), serving as the hole scavenger), and the corresponding energy diagram, FIG. 66D stability test for HER with 3 cycles of 4 hours each—a total 12 hours of photocatalytic reaction. FIG. 66E shows the long term (7 days) photocatalytic H₂ production resulted in an activity of 569 mmol m⁻² of H₂. The long-term operation for a week in FIG. 66E demonstrates the stability of this photocatalytic panel towards the hydrogen evolution reaction. In addition, as shown in FIG. 66F this reaction is extended up to 21 weeks, and maintains stable activity In summary, a binder-free methodology was developed to deposit various photocatalysts into different plastic materials. As a case study a polymeric carbon nitride was studied as the photocatalyst and HDPE (recycled or fresh) as an example thermoset plastic serving as the support. In this configuration the CN/HDPE (photocatalyst/support) exhibited stability towards hydrogen peroxide production under visible light illumination.

It was also demonstrated photocatalytic hydrogen production at a high rate of ~3 mmol h⁻¹ m⁻² for at least 12 hours using the same panel within situ photo-deposited Pt cocatalyst. The long term H₂ production using the same panel produced 569 mmol m⁻² of H₂ after 7 days.

Further stability tests for photocatalytic hydrogen evolution (HER) were conducted using CN|HDPE panels in the presence of a Pt cocatalyst. As shown in FIG. 66F, the CN|HDPE panel exhibited sustained photocatalytic HER activity over an extended period of approximately 21 weeks. The hydrogen evolution rate remained substantially stable during the measurement period, with an average rate of about 4.67 mmol h⁻¹ m⁻². The experiment was discontinued due to time limitations rather than degradation of the catalytic panel. Further, as shown in FIG. 66G, a CN|HDPE waste panel prepared from recycled HDPE also exhibited stable photocatalytic HER activity. The recycled panel maintained hydrogen evolution for approximately 6 weeks with an average rate of about 5.83 mmol h⁻¹ m⁻², demonstrating that recycled polymer substrates can also support stable photocatalytic performance.

FIG. 66H shows an image of the photocatalytic reactor setup used for the experiments and FIG. 66I shows the photocatalytic reactor under illumination during operation.

These results demonstrate that CN|HDPE catalytic panels exhibit prolonged operational stability under photocatalytic HER conditions and that similar stability can be achieved when recycled HDPE substrates are used. Example 11: Larue-scale CN panels for H₂ production via ORR.

### Results

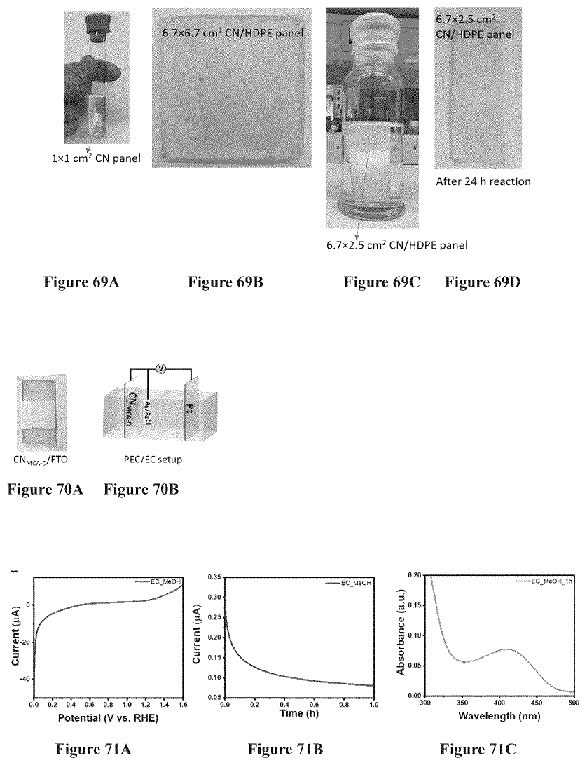

A binder-free CN panel was prepared and tested it for H₂ production in a batch reaction (FIG. 69A). After 24 h, the CN panel produced around 1.1 μmol of H₂ with rate of 460 μmol h⁻¹ m⁻², which further demonstrates the ability to scale such CN/glass panels for H₂O₂-mediated H₂ production approach technology using large-scale photoreactors.

Furthermore, an analog system over plastic instead of glass: a CN/HDPE (6.7×6.7 cm²) panel was also prepared (FIG. 69B). A portion of this CN/HDPE panel (6.7×2.5 cm²) was tested for H₂ production under the identical experimental conditions (20 vol. % MeOH in 100 mL of 0.1 M NaOH, T=40° C.) to that of CN/glass panel experiment (FIG. 69C).

The CN/HDPE panel produced around 6.5 μmol of H₂ with rate of 158 μmol h⁻¹ m⁻².

The digital image of CN/HDPE panel after 24 h use further demonstrates strong interaction of CN over HDPE substrate under these experimental conditions for longer experiments, which promises to scale this H₂O₂-mediated H₂ production approach technology using large-scale photoreactors equipped with CN/HDPE panels.

### Example 12: CN/FTO Panels for Electro/Photoelectro-Catalysts

Using the sandwich method schematically shown in FIG. 1A, CN panels on a transparent conductive oxide were prepared, specifically, fluorine-doped tin oxide coated glass substrate (FTO) (FIG. 70A) and used for electrochemical (EC) and photoelectrochemical (PEC) methanol oxidation to formaldehyde (FIG. 70B) as a representative oxidation model half-reaction with concurrent HER as the half-reaction on the cathode.

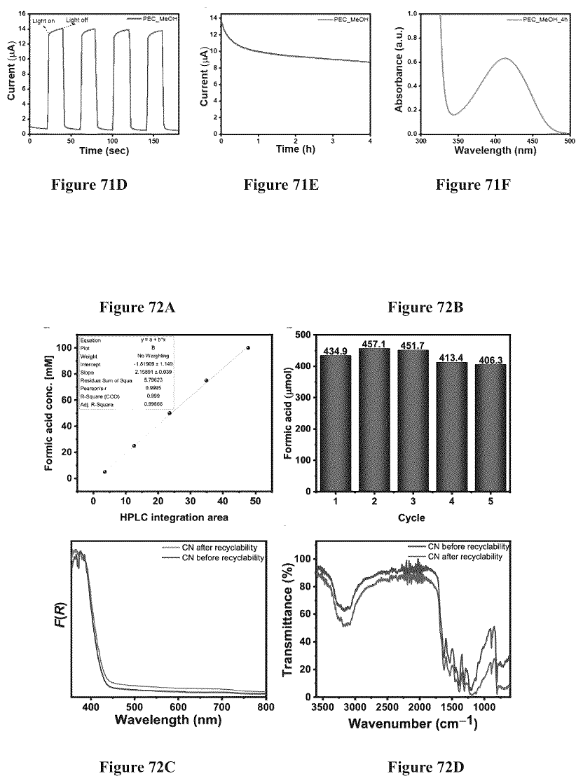

The CN panel electrode was used for MeOH electrochemical oxidation to HCHO (FIGS. 71A and 71B).

Under constant potential at 1.23 V vs. RHE for 1 h, the CN panel electrode produced HCHO, which is confirmed by the UV—vis absorption spectra of HCHO detected using a Nash reagent (FIG. 71C). The peak at around 412 nm confirms the formation of HCHO. Furthermore, the CN panel was also used for photoelectrochemical (PEC) MeOH oxidation to HCHO (FIGS. 71D and 71E). Under a constant potential at 1.23 V vs. RHE for 4 h, the electrode was irradiated using simulated sunlight (1 sun AM 1.5G illuminating the electrode, serving as the photoanode, from the back).

This CN panel produced HCHO, confirmed by the UV—vis absorption spectra of the produce HCHO, detected colorimetrically using a Nash reagent (FIG. 71F).

1. A catalytic panel comprising at least one catalytic material and at least one substrate, wherein said at least one catalytic material is directly associated with said substrate by being either disposed on at least a portion of the substrate or embedded within the substrate.

2. The catalytic panel according to claim 1, being essentially free of a binder.

3. The catalytic panel according to claim 1, wherein said catalytic material has a thickness of between about 0.3 μm and about 500 μm.

4. The catalytic panel according to claim 1, wherein said catalytic material is characterized by a E_{g} of between about 0.8 eV and about 5 eV.

5. The catalytic panel according to claim 1, wherein said catalytic material is one or more of a carbon-based material, a metal oxide, a covalent organic framework material (COFs), a metal-organic framework material (MOFs), a polyoxometalate material (POMs), a nanoparticle or any combination thereof.

6. The catalytic panel according to claim 5, wherein said carbon-based material is one or more of a polymeric carbon nitride (CN), a modified CN, graphene, graphene oxide, reduced graphene oxide, graphite, carbon nanotube, inorganic nanotube, a carbon dot, a nitrogen-doped carbon or any combination thereof.

7. The catalytic panel according to claim 5, wherein said metal oxide is at least one of bismuth oxide (Bi₂O₃), zinc oxide (ZnO), tungsten trioxide (WO₃), titanium dioxide (TiO₂), cadmium oxide (CdO), cadmium zinc oxide (CdZnO), bismuth vanadate (BiVO₄), copper bismuth vanadate (CuBiVO₄), barium titanate (BaTiO₃), cerium oxide (CeO₂), iridium oxide (IrO₂), ruthenium oxide (RuO₂), iron oxides (FaₓO_{y}), zinc iron oxide (ZnFe₂O₄₋ₓ), tantalum oxide (TaOₓ), tantalum oxynitride (TaOₓN_{y}), indium oxide (In₂O₃), tin oxide (SnO₂), fluorine-doped tin oxide (FTO), aluminum-doped zinc oxide (AZO), tin-doped indium oxide (ITO) or any combinations thereof.

8. The catalytic panel according to claim 1, wherein said substrate is or comprises at least one of glass material, metal, metal oxide, doped-metal oxide ceramics, a polymer or any combination thereof.

9. The catalytic panel according to claim 8, wherein said substrate is or comprises a glass material, a doped glass material, a thermoplastic polymer or any combination thereof.

10. The catalytic panel according to claim 9, wherein said thermoplastic polymer is or comprises at least one of polyethylene (PE), polypropylene (PP), polystyrene (PS), polyvinyl Chloride (PVC), polyethylene terephthalate (PET), polyethylene terephthalate glycol (PETG), poly (methyl methacrylate) (PMMA), acrylonitrile butadiene styrene (ABS), polyvinyl alcohol (PVA), polylactic acid (PLA), polycarbonate (PC), poly ether ester ketone (PEEK),polyetherimide (ULTEM), polyether sulfone (PES), thermoplastic elastomers (TPE), or any combination thereof.

11. An electrode comprising a catalytic panel according to claim 1, wherein said substrate is a conductive substrate.

12. A method comprising exposing a panel to a light source, wherein the panel comprises at least one catalytic material and at least one substrate, and wherein the catalytic material is directly associated with the substrate by being (i) disposed on at least a portion of the substrate or (ii) at least partially embedded within the substrate.

13. The method according to claim 12, wherein said substrate is glass or a thermoplastic polymer.

14. The method according to claim 12 wherein said catalytic material is polymeric CN or a modified CN or WOs.

15. The method according to claim 12, comprising contacting said panel with oxygen or with at least one hydroxyl-group containing compound.

16. The method according to claim 12, wherein the method is for oxidizing at least one biomass-derived product.

17. The method according to claim 16, wherein said biomass-derived compound is derived from cellulose, hemi-cellulose, lignocelluloses or HMF.

18. The method according to claim 12, wherein the method is for producing hydrogen, said method comprises contacting said panel with a cocatalyst deposited on said catalytic material, wherein said cocatalyst is a hydrogen evolution reaction (HER) cocatalyst.

19. The method according to claim 12, wherein the method is for producing hydrogen peroxide (H₂O₂).

20. The method according to claim 12, wherein the method is for degrading an organic contaminant in water.
